(19) United States
(12) Patent Application Publication
(10) Pub. No.: US 2024/0291100 A1
(43) Pub. Date: Aug. 29, 2024

(54) MATERIALS, COMPONENTS, AND DESIGNS FOR HIGH POWER BATTERIES

(71) Applicant: The Regents of the University of California, Oakland, CA (US)

(72) Inventors: Brett Helms, Oakland, CA (US); Junhua Song, Oakland, CA (US); Michael Baird, Oakland, CA (US); Youngmin Ko, Oakland, CA (US)

(21) Appl. No.: 18/289,541

(22) PCT Filed: May 5, 2022
(86) PCT No.: PCT/US2022/027867

§ 371 Date: Nov. 3, 2023

Related U.S. Application Data
(60) Provisional application No. 63/184,759, filed on May 5, 2021.

(51) Int. Cl. H01M 50/414; H01M 4/02; H01M 4/38; H01M 4/505; H01M 4/525; H01M 4/583; H01M 4/66; H01M 10/0567; H01M 10/0568; H01M 10/0569; H01M 50/491

(52) U.S. Cl. CPC H01M 50/414; H01M 4/382; H01M 4/505; H01M 4/525; H01M 4/583; H01M 4/662; H01M 10/0567; H01M 10/0568; H01M 10/0569; H01M 50/491; H01M 2004/027; H01M 2004/028; H01M 2300/0028

(57) ABSTRACT

Microporous polymers, materials for making microporous polymers, and electrochemical cells, including anode-free electrochemical cells containing locally concentrated electrolytes, are described. Further provided is an electrochemical cell comprising an anode or a current collector, a first electrolyte, a polymer membrane separator, a second electrolyte, and a cathode, wherein: the polymer membrane separator is positioned between the anode and the cathode: the first electrolyte is in contact with the anode and a first face of the polymer membrane separator; the second electrolyte is in contact with the cathode and a second face of polymer membrane the separator.

### CROSS-REFERENCES TO RELATED APPLICATIONS

The present application claims priority to U.S. Provisional Pat. Appl. No. 63/184,759, filed on May 5, 2021, which application is incorporated herein by reference in its entirety.

### STATEMENT AS TO RIGHTS TO INVENTIONS MADE UNDER FEDERALLY SPONSORED RESEARCH AND DEVELOPMENT

This invention was made with government support under Contract No. DE-AC02-05CH11231 awarded by the U.S. Department of Energy and under Advanced Research Projects Agency-Energy (ARPA-E) Award No. DE-AR0000774. The government has certain rights in the invention.

### BACKGROUND OF THE INVENTION

Drivers of battery electric vehicles (BEVs) are pressing automakers to re-design their powertrains to enable recharge to 80% state-of-charge (SOC) in 15 min (fast-charge)—and more preferably in 5 min (ultra-fast-charge). In doing so, recharging BEVs would be competitive with the refueling of vehicles powered by internal combustion engines. This remains a significant challenge in that further engineering the battery pack, while useful for thermal management, does not address the underlying problems of ion transport and interfacial charge-transfer resistance responsible for high overpotentials encountered while charging cells at high current densities.

Ion-transport bottlenecks have their origins in solvation, speciation, and electrode-electrolyte interactions, where maximizing ion flux in the cell requires electrolytes with concomitantly high ionic charge carrier mobility and concentration. Dilute electrolytes (DEs) are often limited by low ionic charge carrier concentration, despite high ionic charge carrier mobility. Super-concentrated electrolytes (SCEs), on the other hand, grant access to electrolytes with higher charge carrier concentration, yet suffer from low carrier mobility due to their higher viscosity. Additional considerations arise at electrified interfaces, where ion flux is influenced by additional factors—e.g., the energetics of ion solvation and desolvation—and where interphases that form from electrolyte decomposition at anode and cathode play important roles.

### BRIEF SUMMARY OF THE INVENTION

Provided herein are electrochemical cell comprising (i) an anode or a current collector, (ii) a first electrolyte, (iii) a polymer membrane separator (including separators comprising microporous polymers), (iv) a second electrolyte, and (v) a cathode, wherein:
the polymer membrane separator is positioned between the anode (or the current collector) and the cathode;
the first electrolyte is in contact with the anode (or the current collector) and a first face of the polymer membrane separator;
the second electrolyte is in contact with the cathode and a second face of polymer membrane the separator.

In some embodiments, at least one electrolyte comprises a locally concentrated electrolyte comprising one or more alkali metal salts (e.g., lithium bis(fluorosulfonyl)imide), a solvent (e.g., 1,2-dimethoxyethane), and a diluent (e.g., tetrafluoroethyl-2,2,2,3-tetrafluoropropyl ether). In some embodiments, the electrolyte contains one or more additional alkali metal salts such as lithium difluoro(oxalate)borate, lithium perchlorate, lithium tetrafluoroborate, lithium trifluoromethanesulfonate, lithium hexafluorophosphate, or lithium bis(trifluoromethanesulfonyl)imide.

Also provided herein are microporous polymer according to the formula:

-[A-AB-B]ₙ-,
wherein:
n is an integer ranging from 10 to 10,000;
each monomer segment A-A is independently a monomer segment according to Formula A, B, C, D, E, F, G, H, I or J:

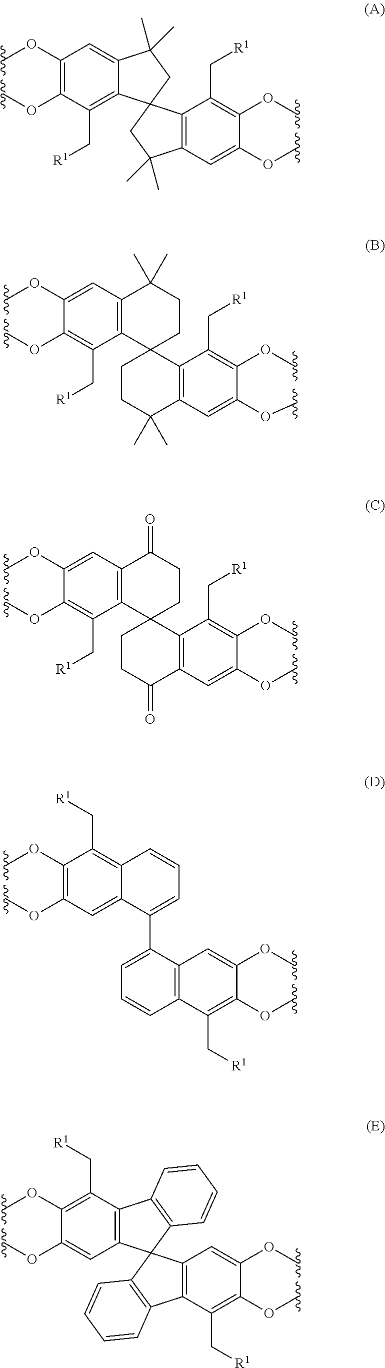

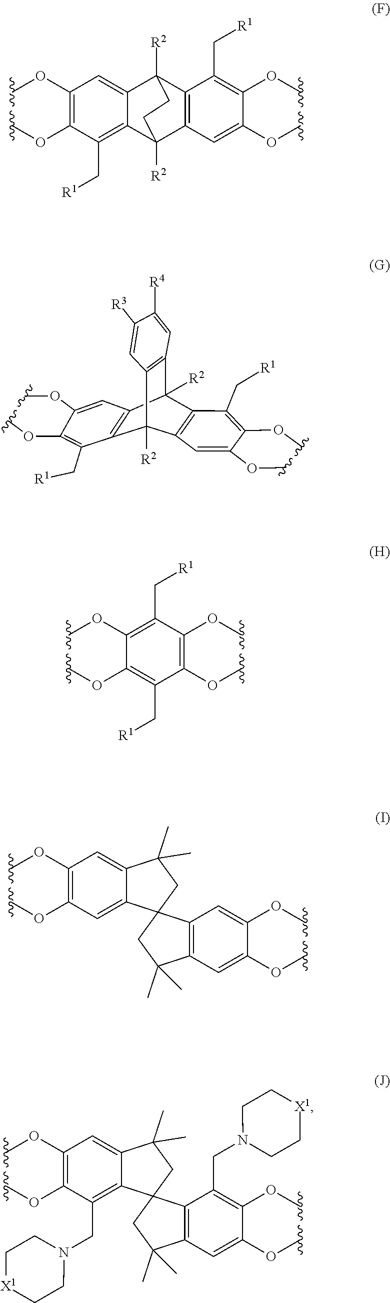

provided that at least one monomer segment A-A is independently a monomer segment according to Formula A, B, C, D, E, F, G, or H;
each monomer segment B-B is independently a monomer segment according to Formula a, b, or c:

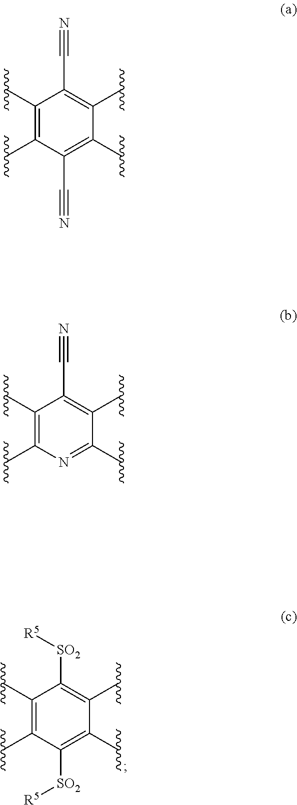

R¹ is selected from the group consisting of:

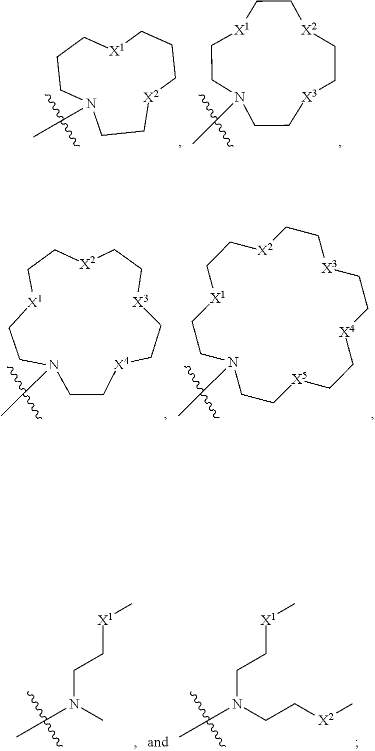

X¹, X², X³, X⁴, and X⁵ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₁₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl.

Also provided berein are electrochemical cells comprising microporous polymers as set forth above, as well as methods for charging and recharging electrochemical cells under fast- and ultrafast-charging conditions.

### BRIEF DESCRIPTION OF THE DRAWINGS

FIG. 1 shows that the ionic conductivities of locally concentrated electrolyte compositions A, B, C, D and E at 20° C. exceed 3 mS cm⁻¹. Composition A contains lithium bis(fluorosulfonyl)imide, 1,2-dimethoxyethane, and 1,1,2,2-tetrafluoroethyl 2,2,3,3-tetrafluoropropyl ether in a 1.0:1.6:2.8 molar ratio. Composition B contains the same components in a 1.0:1.6:2.4 molar ratio. Composition C contains the same components in a 1.0:1.6:2.0 molar ratio. Composition D contains the same components in a 1.0:2.0:2.8 molar ratio. Composition E contains the same components in a 1.0:2.4:2.0 molar ratio.

FIG. 2 shows that the dynamic viscosities of locally concentrated electrolyte compositions A, B, C, D and E at 20° C. are below 20 mPa·s.

FIG. 3 shows that the voltage stabilities of locally concentrated electrolyte compositions A, B, C, D and E at 20° C. by linear sweep voltammetry exceed 3.7 V vs. Li/Li⁺.

FIG. 4 shows that the voltage stability of a 2032 coin cell (containing a microporous polymer separator, lithium counter electrode, a polyolefin separator, a stainless steel electrode, and electrolyte D) exceeds 3.7 V vs. Li/Li⁺ at 25° C., as assessed by linear sweep voltammetry.

FIG. 5 shows a Nyquist plot for a Li|Li 2032 coin electrochemical cell with a microporous polymer separator and locally concentrated electrolyte D.

FIG. 6 shows that the area-specific impedance of a microporous polymer separator, calculated from the Nyquist plot in FIG. 5, at 20° C. is less than 20 Ohm·cm².

FIG. 7 shows a schematic of the Li|NMC622 electrochemical cell used for generation of the data in FIGS. 8-10.

FIG. 8 shows that the accessible areal capacity of a Li|NMC622 electrochemical cell

employing locally concentrated electrolyte A and a microporous polymer separator is greater than or equal to 1 mAh cm⁻² and less than or equal to 15 mAh cm⁻². A 1.0 mA cm⁻² charge/discharge protocol was used.

FIG. 9 shows that the cycle life of a Li|NMC622 electrochemical cell employing locally concentrated electrolyte A and a microporous polymer separator is greater than or equal to 50 cycles, and is 20 larger than the cycle life of an otherwise equivalent electrochemical cell with a conventional polyolefin separator and conventional liquid carbonate electrolyte (1 M LiPF₆ in a 1:1 (v/v) mixture of ethylene carbonate and dimethyl carbonate), wherein the cycle life is defined as the number of cycles before only 50% of the initial capacity is accessed during discharge. A 1.0 mA cm⁻² charge/discharge protocol was used. The discharge capacities for electrolyte A were obtained from the same cell used in FIG. 8.

FIG. 10 shows that a Li|NMC622 electrochemical cell employing locally concentrated electrolyte A exceeds a power density of 500 W kg⁻¹, which represents greater than a twofold increase in power density compared to an equivalent electrochemical cell employing a conventional carbonate electrolyte. The power densities were calculated from the same cells used in FIG. 8 and FIG. 9.

FIG. 11 shows a schematic of the Cu|NMC622 electrochemical cell used in FIGS. 12-14.

FIG. 12 shows that the accessible areal capacity of an anode-less Cu|NMC622 electrochemical cell employing locally concentrated electrolyte A and a microporous polymer separator is greater than or equal to 1 mAh cm⁻² and less than or equal to 15 mAh cm⁻². A 0.5 mA cm⁻² charge/1.0 mA cm⁻² discharge protocol was used.

FIG. 13 shows that the cycle life of an anode-less Cu|NMC622 electrochemical cell employing locally concentrated electrolyte A is greater than or equal to 50 cycles, and is 20 larger than the cycle life of an otherwise equivalent electrochemical cell with a conventional polyolefin separator and conventional liquid carbonate electrolyte (1 M LiPF₆ in a 1:1 (v/v) mixture of ethylene carbonate and dimethyl carbonate), wherein the cycle life is defined as the number of cycles before only 50% of the initial capacity is accessed during discharge. A 0.5 mA cm⁻² charge/1.0 mA cm⁻² discharge protocol was used. The discharge capacities for electrolyte A were obtained from the same cell used in FIG. 12.

FIG. 14 shows that an anode-less Cu|NMC622 electrochemical cell employing electrolyte D exceeds the power density of 350 W kg⁻¹, which represents greater than a twofold increase in power density compared to an equivalent electrochemical cell employing a conventional carbonate electrolyte. The power densities were calculated from the same cells used in FIG. 12 and FIG. 13.

FIG. 15 shows Nyquist plots (dots) and corresponding fits to equivalent circuits (solid lines) for Li|Li electrochemical cells with microporous polymer separators bearing aza-crown-ether pendants and locally concentrated electrolyte.

FIG. 16 shows that the area-specific impedances of some microporous polymer separators bearing aza-crown-ether pendants, calculated from the corresponding Nyquist plots in FIG. 15, at 25° C. are less than 20 Ohm cm⁻².

FIG. 17 shows that the cycle life of Li|NMC811 electrochemical cells employing a locally concentrated electrolyte and microporous polymer separators bearing aza-crown-ether pendants is greater than or equal to 50 cycles.

FIG. 18 shows that Cu|NMC811 electrochemical cells employing microporous polymer separators bearing aza-crown-ether pendants can reversibly cycle.

FIG. 19 shows electrolyte formulation strategy, electrolyte viscosity, and electrolyte ionic conductivity.

FIG. 20 shows fast-charge rate performance of electrolytes in Li|NMC622 coin cells.

FIG. 21 shows fast-charge rate performance of electrolytes in Li|NMC622 coin cells.

FIG. 22 shows fast-charge cycling performance of electrolytes in Li|NMC622 cells.

FIG. 23 shows cycling overpotentials of electrolytes in Li|NMC622 coin cells.

FIG. 24 shows cycling performance of electrolytes in Li|NMC622 coin cells.

FIG. 25 shows lithium consumption rate (LCR) determination for electrolytes Li|Cu coin cells.

FIG. 26 shows scanning electron microscopy images of Li anodes before and after electrodeposition.

FIG. 27 shows that the cycle life of Li|NMC811 electrochemical cells employing a locally concentrated electrolytes containing one or two salts is greater than or equal to 50 cycles when charge/discharge current densities are a 1.0 mA cm⁻²/3.0 mA cm⁻² and the upper/lower cutoff voltages are 4.2 V/3.0 V.

FIG. 28 shows that the cycle life of Li|NMC811 electrochemical cells employing a locally concentrated electrolytes containing one or two salts is greater than or equal to 50 cycles when charge/discharge current densities are a 1.0 mA cm⁻²/3.0 mA cm⁻² and the upper/lower cutoff voltages are 4.2 V/3.0 V.

FIG. 29 shows that the cycle life of Li|NMC811 electrochemical cells employing a locally concentrated electrolytes containing one or two salts is greater than or equal to 50 cycles when charge/discharge current densities are a 1.0 mA cm⁻²/6.0 mA cm² and the upper/lower cutoff voltages are 4.2 V/3.0 V.

FIG. 30 shows that the cycle life of Li|NMC811 electrochemical cells employing a locally concentrated electrolytes containing one or two salts is greater than or equal to 50 cycles when charge/discharge current densities are a 1.0 mA cm⁻²/6.0 mA cm⁻² and the upper/lower cutoff voltages are 4.2 V/3.0 V.

FIG. 31 shows that the cycle life of Li|NMC811 electrochemical cells employing a locally concentrated electrolytes containing one or two salts is greater than or equal to 50 cycles when charge/discharge current densities are a 1.0 mA cm⁻²/3.0 mA cm⁻² and the upper/lower cutoff voltages are 4.35 V/3.0 V.

FIG. 32 shows that the cycle life of Li|NMC811 electrochemical cells employing a locally concentrated electrolytes containing one or two salts is greater than or equal to 50 cycles when charge/discharge current densities are a 1.0 mA cm⁻²/3.0 mA cm⁻² and the upper/lower cutoff voltages are 4.35 V/3.0 V.

FIG. 33 shows that the cycle life of Li|NMC811 electrochemical cells employing a locally concentrated electrolytes containing one or two salts is greater than or equal to 50 cycles when charge/discharge current densities are a 1.0 mA cm⁻²/6.0 mA cm⁻² and the upper/lower cutoff voltages are 4.35 V/3.0 V.

FIG. 34 shows that the cycle life of Li|NMC811 electrochemical cells employing a locally concentrated electrolytes containing one or two salts is greater than or equal to 50 cycles when charge/discharge current densities are a 1.0 mA cm⁻²/6.0 mA cm⁻² and the upper/lower cutoff voltages are 4.35 V/3.0 V.

### DETAILED DESCRIPTION OF THE INVENTION

High power batteries require embodied materials that minimize charge transfer resistance at electrode-electrolyte interfaces and avoid excessive polarization, which depends both on the cell and electrode architectures as well as the ionic charge transport properties of the electrolyte. The present disclosure addresses each of these challenges directly with advanced electrolytes and interlayers in high energy density lithium metal batteries.

The need for low charge transfer resistance at the anode-electrolyte interface is addressed by using a microporous polymer film which becomes in-filled with specific components of a multicomponent electrolyte through selective partitioning, which is controlled both by the chemical structure of the polymer as well as the selection of components in the electrolyte. Judicious pairing of polymers and electrolytes provides synergistic effects—the selective partitioning afforded by the polymer provides for formation of a hybrid interphase which could not be formed without both polymer and electrolyte present.

The need for low charge transfer resistance at the cathode-electrolyte interface is addressed through the choice of cathode materials as well as the components in the electrolyte. Finally, the need for high conductivity electrolytes and low overall cell resistance is addressed through the choice of specific electrolyte components as well as the cell architecture. In doing so, the power rating of lithium metal cells can be increased by at least a factor of 4, with specific combinations accessing greater than 850 W/kg. In contrast, conventional cells would access ˜200 W/kg. The cycle life of these high power high energy density cells is long, due to the passivation of the lithium anode, which slows down considerably the rate of lithium consumption due to parasitic side reactions with other cell components. Determinations of lithium half cell and full cell Coulombic efficiencies under high rate cycling show 99.5%, consistent with a low capacity fade rate where 80% capacity is retained across hundreds of cycles.

Battery assemblies provided herein are useful in electric vehicles, seacraft, aircraft, and drones, the like. Advantages of the assemblies include, but are not limited to, power delivered as well as the cycle life of the high energy density cells. High power is desirable, e.g., for vertical takeoff and landing (eVTOL) in electric aircraft as well as in medium and long-baul trucking when bringing to speed large payloads. Rechargeable lithium metal batteries according to the present disclosure, delivering high power with long cycle life, can be used in applications where conventional lithium-ion batteries cannot.

### I. DEFINITIONS

As used herein, the term “locally concentrated electrolyte” refers to an electrolyte comprising one or more solvents, one or more diluents, and/or one or more alkali metal salts. The total molar concentration of the alkali metal salt(s) in the electrolytes typically ranges from about 0.5 M to about 7.5 M.

As used herein in the context of electrochemical cells, the term “solvent” refers to an electrolyte component which dissolves alkali metal salts in an electrolyte. Examples of solvents include, but are not limited to, ethers, orthoesters, carbonates, lactones, sulfoxides, sulfones, sultones, sulfonamides, amides, carbamates, and combinations thereof.

As used herein, the term “diluent” refers to an electrolyte component comprising a fluorinated ether, a fluorinated orthoester, a fluorinated carbonate, a fluorinated lactone, a fluorinated sulfoxide, a fluorinated sulfone, a fluorinated sultone, a fluorinated sulfonamide, a fluorinated amide, a fluorinated carbamate, a fluorinated urea, or any combination thereof.

As used herein, the term “alkali metal salt” refers to an electrolyte component

comprising at least one alkali metal cation and a counter anion. Examples of alkali metal salts contain anions such as chlorate, perchlorate, nitrate, phosphate, hexafluorophosphate, borate, tetrafluoroborate, difluoro(oxalate)borate, bis(oxalate)borate, bis(fluorosulfonyl)imide, bis(trifluoromethane)sulfonimide, closo-dodecaborates, halogenated closo-dodecaborates. closo-carboranes, halogenated closo-carboranes, and combinations thereof. In some embodiments, the alkali metal salt is a sodium salt. In some embodiments, the alkali metal salt is a lithium salt.

As used herein, the term “polymer” refers to a molecule composed of repeating structural units, referred to herein as monomers or repeat units, connected by covalent chemical bonds. Polymers are generally characterized by a high molecular weight, such as a molecular weight greater than 100 atomic mass units (amu), greater than 500 amu, greater than 1000 amu, greater than 10000 amu or greater than 100000 amu. In some embodiments, a polymer may be characterized by a molecular weight provided in g/mol or kg/mol, such as a molecular weight of about 200 kg/mol or about 80 kg/mol. The term polymer includes homopolymers, or polymers consisting essentially of a single repeating monomer subunit.

The term polymer also includes copolymers, which are formed when two or more different types of monomers are linked in the same polymer. Copolymers may comprise two or more monomer subunits, and may include random, block, alternating, segmented, grafted, tapered and other copolymers. Useful polymers include organic polymers that may be in amorphous, semi-amorphous, crystalline or partially crystalline states.

As used herein, the term “repeat unit” refers to a part of a polymer that represents a repetitive structure of the polymer chain, the repetition of which would make up the complete polymer chain with the exception of end groups corresponding to terminal ends of the polymer chain. A repeat unit may also be referred to herein as a monomer. Repeat units may be identified in a polymer structure by brackets or parentheses and include a subscript n, which represents the degree of polymerization. In some embodiments, values for subscript n include integers selected from, for example, 10 to 1000, 50 to 900, 100 to 800, or 200 to 500. In some embodiments, subscript n is an integer more than 1000. It will be appreciated that a value for subscript n in a polymer may not be explicitly provided, consistent with use by skilled artisans in the field of polymer chemistry.

As used herein, the term “microporosity” refers to a characteristic of a material describing the inclusion of voids, channels, openings, recessed regions, etc., also referred to herein as micropores, in the body of material. In some embodiments, the micropores have a cross sectional dimension of about 2 nm or less. Micropores may have, for example, a cross sectional dimension of about 1.7 nm or less, 1.5 nm or less, 1.2 nm or less, 1 nm or less. or 0.8 nm or less. Optionally, micropores may have cross sectional dimensions selected from the range of 0.5 nm to 2 nm, selected from the range of 0.5 nm to 1.2 nm, or selected from the range of 1.2 nm to 1.7 nm. The inclusion of micropores in a material may allow for other materials, such as gases, liquids, ions, etc., to pass through the micropores.

As used herein, the term “intrinsic microporosity” refers to a continuous network of interconnected voids in a material formed as a direct consequence of the shape and rigidity of the components of the material. Intrinsic microporosity is achieved in some polymers by the polymers possessing individual structural units that are rigid and that may be oriented relative to one another in such a way that the structural units align to form an opening or pore. Additionally or alternatively, a polymer possessing intrinsic microporosity may have a structure that exhibits frustrated packing. Frustrated packing of a polymer may occur when a polymer molecule contacts itself or other like polymer molecules and the rigidity of the molecule(s) causes the molecule(s) to lie in a configuration where spaces between the molecule(s) are created. Such spaces may correspond to micropores in a film or membrane made of the polymer molecules, for example.

As used herein, the terms “polymer of intrinsic microporosity” and “microporous polymer” are used as synonyms to refer to a polymer that exhibits microporosity due to the shape and rigidity of the molecular structure of the repeat units within the polymer, where the repeat units may align relative to one another such that spaces or openings are generated along the polymer chain. Additionally or alternatively, the repeat units may align in an aggregate of the polymer in a way that frustrates packing of the polymer molecules in the aggregate such that spaces or openings are generated between different polymer molecules and/or between segments of the same polymer molecule. These spaces within the aggregated polymer may, at least in part, provide the microporosity to such a polymer. Due to the inclusion of the micropores, some polymers of intrinsic microporosity may exhibit high surface areas, such as a surface area selected from the range of 300 m² g⁻¹ to 1500 m² g⁻¹. Example polymers of intrinsic microporosity include, but are not limited to, those described in US 2017/0346104, U.S. Pat. Nos. 10,710,065, 7,690,514, 8,056,732, WO 2005/012397, and WO 2005/113121, each of which is incorporated herein by reference, as well as those described by Mckeown (ISRN Materials Science, Volume 2012, Article ID 513986), which is incorporated herein by reference.

As used herein, the term “electrochemical cell” refers to a device that produces electrical energy through chemical reactions. Example electrochemical cells include batteries and fuel cells. Batteries may include solid-state batteries, semi-solid batteries, wet cell batteries, dry cell batteries, flow batteries, solar flow batteries, primary batteries, secondary batteries, etc. A battery may refer to an assembly of a plurality of individual electrochemical cells, such as arranged in a series configuration. Example electrochemical cells include an anode, a cathode, a separator between the anode and the cathode, and an electrolyte. Electrochemical cells may further include a current collector in electrical contact with an electrode and/or an electrolyte and may be used, in part, to provide a conductive path between the electrode and a load.

As used herein, the term “anode” refers to an electrode in an electrochemical cell where oxidation occurs during discharge of the electrochemical cell. In some embodiments, an anode is identified in an electrochemical cell as the negative electrode, where electrons are emitted during discharge for use by a load. In some embodiments, an anode oxidizes material and releases positive ions to an electrolyte during discharge.

As used herein, the term “cathode” refers to an electrode in an electrochemical cell where reduction occurs during discharge of the electrochemical cell. In some embodiments, a cathode is identified in an electrochemical cell as the positive electrode, where electrons are received during discharge after use by a load. In some embodiments, a cathode reduces positive ions received from an electrolyte during discharge.

As used herein, the term “current collector” refers to any conductive substrate which is capable of carrying a current to and from the electroactive species in an electrochemical cell. In the context of anode-free electrochemical cells, ions extracted from a cathode (e.g., lithium ions) are electrodeposited at the current collector. The plated metal is then re-dissolved and deposited at the cathode during discharging of the cell. Examples of current collectors include metallized plastic films, metal foils, metal grids, expanded metal grids, metal mesh, metal wool, woven carbon fabric, woven carbon mesh, non-woven carbon mesh, and carbon felt.

As used herein, the term “separator” refers to an ion conductive barrier used to separate an anode (or current collector) and a cathode in an electrochemical cell. In some embodiments, a separator is a porous or semi-permeable membrane that restricts the passage of certain materials across the membrane. In some embodiments, a separator provides a physical spacing between the anode and the cathode in an electrochemical cell. In some embodiments, a separator is not electrically conductive and provides a gap in electrical conductivity between the anode and the cathode in an electrochemical cell.

As used herein, the term “electrolyte” refers to an ionically conductive substance or composition and may include solvents, ionic liquids, metal salts, ions such as metal ions or inorganic ions, polymers, ceramics, and other components.

As used herein, the term “anode electrolyte” refers to an electrolyte in an electrochemical cell in contact with an anode (or current collector). An anode electrolyte may further be in contact with a separator in an electrochemical cell.

As used herein, the term “cathode electrolyte” refers to an electrolyte in an electrochemical cell in contact with a cathode. A cathode electrolyte may further be in contact with a separator in an electrochemical cell.

As used herein, the term “membrane” refers to a web of material that extends in lateral dimensions, which may be orthogonal to a thickness dimension of the membrane. In some embodiments, the term “membrane” may be used interchangeably herein with the term “film” or “interlayer.” Optionally, a membrane separates two regions in space by the physical materials that make up the membrane. A membrane may be used as a support or template for other materials in order to provide structure and/or stability to the other material, for example. The other material may be attached to one side of the membrane, and or may encapsulate all or portions of the membrane.

As used herein, the term “support membrane” refers to a structural film that may provide mechanical stability to another material coated onto or otherwise attached to the film. In some embodiments, a support membrane may be porous or otherwise allow materials, such as ions, gases, or liquids, to pass through the support membrane, though any coated or otherwise supported material may restrict, at least in part, the passage of the ions, gases, or liquids.

As used herein, the term “alkyl,” by itself or as part of another substituent, refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, scc-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted. For example, “substituted alkyl” groups can be substituted with one or more groups selected from halo, hydroxy, amino, alkylamino, amido, acyl, nitro, cyano, and alkoxy.

As used herein, the term “alkenyl” refers to an alkyl group, as defined herein, having one or more carbon-carbon double bonds.

As used herein, the term “alkynyl” refers to an alkyl group, as defined herein, having one or more carbon-carbon triple bonds.

As used herein, the term “heteroalkyl” refers to an alkyl group, as defined herein, containing one or more heteroatoms selected from N, O, S, B, Al, Si, and P. Typically, heteroatoms in a heteroalkyl group are non-adjacent heteroatoms.

As used herein, the term “cycloalkyl,” by itself or as part of another substituent, refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norbornane, [2.2.2] bicyclooctane, decahydronaphthalene and adamantane. Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene. cyclooctadiene (1,3-, 1,4- and 1,5-isomers), norbornene, and norbomadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted. For example, “substituted cycloalkyl” groups can be substituted with one or more groups selected from halo, hydroxy, amino, alkylamino, amido, acyl, nitro, cyano, and alkoxy.

As used herein, the term “chalcogenide” refers to an atom selected from oxygen, sulfur, selenium, tellurium, and polonium. In certain embodiments, monomers and polymers of the present disclosure contain chalcogenides selected from oxygen and sulfur.

As used herein, the term “pnictide” refers to an atom selected from nitrogen, phosphorus, arsenic, antimony, and bismuth. In certain embodiments, monomers and polymers of the present disclosure contain pnictides selected from nitrogen and phosphorus.

As used herein, the terms “halo” and “halogen,” by themselves or as part of another substituent, refer to a fluorine, chlorine, bromine, or iodine atom.

As used herein, the term “aryl,” by itself or as part of another substituent, refers to an aromatic ring system having any suitable number of carbon ring atoms and any suitable number of rings. Aryl groups can include any suitable number of carbon ring atoms, such as C₆, C₇, C₈, C₉, C₁₀, C₁₁, ₁₂, C₁₃, C₁₄, C₁₅ or C₁₆, as well as C₆₋₁₀, C₆₋₁₂, or C₆₋₁₄. Aryl groups can be monocyclic, fused to form bicyclic (e.g., benzocyclohexyl) or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted. For example, “substituted aryl” groups can be substituted with one or more groups selected from halo, hydroxy, amino, alkylamino, amido, acyl, nitro, cyano, and alkoxy.

As used herein, the term “heteroaryl,” by itself or as part of another substituent, refers to a monocyclic or fused bicyclic or tricyclic aromatic ring assembly containing 5 to 16 ring atoms, where from 1 to 5 of the ring atoms are a heteroatom such as N, O or S. Additional heteroatoms can also be useful, including, but not limited to, B, Al, Si and P. The heteroatoms can be oxidized to form moieties such as, but not limited to, —S(O)— and —S(O)₂—. Heteroaryl groups can include any number of ring atoms, such as C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of heteroatoms can be included in the heteroaryl groups, such as 1, 2, 3, 4; or 5, or 1 to 2, 1 to 3, 1 to 4, 1 to 5, 2 to 3, 2 to 4, 2 to 5, 3 to 4, or 3 to 5. For example, heteroaryl groups can be C₅₋₈ heteroaryl, wherein 1 to 4 carbon ring atoms arc replaced with heteroatoms: or C₅₋₆ heteroaryl, wherein 1 to 3 carbon ring atoms are replaced with heteroatoms: or C₅₋₆ heteroaryl, wherein 1 to 4 carbon ring atoms are replaced with heteroatoms; or C₅₋₆ heteroaryl, wherein 1 to 3 carbon ring atoms are replaced with heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted. For example, “substituted heteroaryl” groups can be substituted with one or more groups selected from halo, hydroxy, amino, alkylamino, amido, acyl, nitro, cyano, and alkoxy.

The heteroaryl groups can be linked via any position on the ring. For example, pyrrole includes 1-, 2- and 3-pyrrole, pyridine includes 2 -, 3- and 4-pyridine, imidazole includes 1-, 2 -, 4- and 5-imidazole, pyrazole includes 1-, 3 -, 4- and 5-pyrazole, triazole includes 1-, 4- and 5-triazole, tetrazole includes 1- and 5-tetrazole, pyrimidine includes 2-, 4-, 5- and 6- pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and S-thiazole, isothiazole includes 3 -, 4- and 5-isothiazole, oxazole includes 2-, 4- and 5-oxazole, isoxazole includes 3 -, 4- and 5-isoxazole, indole includes 1 -, 2- and 3-indole, isoindole includes 1- and 2-isoindole, quinoline includes 2-, 3- and 4-quinoline, isoquinoline includes 1 -, 3- and 4-isoquinoline, quinazoline includes 2- and 4-quinazoline, cinnoline includes 3- and 4-cinnoline, benzothiophene includes 2- and 3-benzothiophene, and benzofuran includes 2- and 3-benzofuran.

As used herein, the term “heterocyclyl,” by itself or as part of another substituent, refers to a saturated ring system having from 3 to 12 ring members and from 1 to 4 heteroatoms of N, O and S. Additional heteroatoms can also be useful, including, but not limited to, B, Al, Si and P. The heteroatoms can be oxidized to form moieties such as, but not limited to, —S(O)— and —S(O)₂—. Heterocyclyl groups can include any number of ring atoms, such as, C₃₋₆, C₄₋₆, C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of carbon ring atoms can be replaced with heteroatoms in the heterocyclyl groups, such as 1, 2, 3, or 4, or 1 to 2, 1 to 3, 1 to 4, 2 to 3, 2 to 4, or 3 to 4. The heterocyclyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxctane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocyclyl groups can also be fused to aromatic or non-aromatic ring systems to form members including, but not limited to, indoline. Heterocyclyl groups can be unsubstituted or substituted. For example, “substituted heterocyclyl” groups can be substituted with one or more groups selected from halo, hydroxy, amino, oxo, alkylamino, amido, acyl, nitro, cyano, and alkoxy.

The heterocyclyl groups can be linked via any position on the ring. For example, aziridine can be 1- or 2-aziridine, azetidine can be 1- or 2- azetidine, pyrrolidine can be 1-, 2- or 3-pyrrolidine, piperidine can be 1-, 2-, 3- or 4-piperidine, pyrazolidine can be 1-, 2-, 3 -, or 4-pyrazolidine, imidazolidine can be 1-, 2-, 3- or 4-imidazolidine, piperazine can be 1-, 2-, 3- or 4-piperazine, tetrahydrofuran can be 1- or 2-tetrahydrofuran, oxazolidine can be 2-, 3-, 4- or 5-oxazolidine, isoxazolidine can be 2 -, 3-, 4- or 5-isoxazolidine, thiazolidine can be 2-, 3- 4- or 5-thiazolidine, isothiazolidine can be 2-, 3-, 4- or 5- isothiazolidine, and morpholine can be 2-, 3- or 4-morpholine.

As used herein, the term “amino” refers to a moiety —NR₂, wherein each R group is H or alkyl. An amino moiety can be ionized to form the corresponding ammonium cation. “Dialkylamino” refers to an amino moiety wherein cach R group is alkyl.

As used herein, the term “sulfonyl” refers to a moiety —SO₂R, wherein the R group is alkyl, baloalkyl, or aryl. An amino moiety can be ionized to form the corresponding ammonium cation.

As used herein, the term “haloalkyl,” by itself or as part of another substituent, refers to an alkyl group where some or all of the hydrogen atoms are replaced with halogen atoms. As for alkyl groups, haloalkyl groups can have any suitable number of carbon atoms, such as C₁₋₆. For example, haloalkyl includes trifluoromethyl, fluoromethyl, etc. In some instances, the term “perfluoro” can be used to define a compound or radical where all the hydrogens are replaced with fluorine. For example, perfluoromethyl refers to 1,1,1-trifluoromethyl.

As used herein, the term “hydroxy” refers to the moiety —OH.

As used herein, the term “cyano” refers to a carbon atom triple-bonded to a nitrogen atom (i.e., the moiety —C≡N).

As used herein, the term “carboxy” refers to the moiety —C(O)OH. A carboxy moiety can be ionized to form the corresponding carboxylate anion.

As used herein, the term “amido” refers to a moicty —NRC(O)R or —C(O)NR₃, wherein each R group is H or alkyl.

As used herein, the term “acyl” refers to a moiety —C(O)R, wherein R is alkyl.

As used herein, the term “nitro” refers to the moiety —NO₂.

As used herein, the term “oxo” refers to an oxygen atom that is double-bonded to a compound (i.e., O═).

The term “salt,” in reference to a monomer or polymer as described herein, refers to an acid salt or base salt of the monomer or polymer. A monomer or polymer may have one or more salt moieties. Illustrative examples of salts are mineral acid salts (e.g., salts formed with hydrochloric acid, hydrobromic acid, phosphoric acid, or the like), organic acid salts (e.g., salts formed with acetic acid, propionic acid, glutamic acid, citric acid and the like), quaternary ammonium salts (e.g., salts formed with methyl iodide, ethyl iodide, or the like). Salts of basic monomers and/or polymers, e.g., those having amine groups, can be formed with acids such as of mineral acids, organic carboxylic acids, and organic sulfonic acids, e.g., hydrochloric acid, methanesulfonic acid, maleic acid, and the like. Salts of acidic monomers and/or polymers can be formed with bases including cationic salts such as alkali and alkaline earth metal salts, such as sodium, lithium, potassium, calcium, magnesium salts, as well as ammonium salts, such as ammonium, trimethyl-ammonium, diethylammonium, and tris-(hydroxymethyl)-methyl-ammonium salts. The neutral form of a monomer or polymer can be regenerated by contacting the salt with a base or acid and optionally isolating the parent compound. Counterions (e.g., anions in a polycationic polymer) may be exchanged as described herein.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a value is close to a targeted value, where close can mean, for example, the value is within 80% of the targeted value, within 85% of the targeted value, within 90% of the targeted value, within 95% of the targeted value, or within 99% of the targeted value.

### II. CHELATOR-FUNCTIONALIZED MONOMER COMPOUNDS

Provided herein are monomer compounds according to Formula I, II, III, IV, V, VI, VII, or VIII:

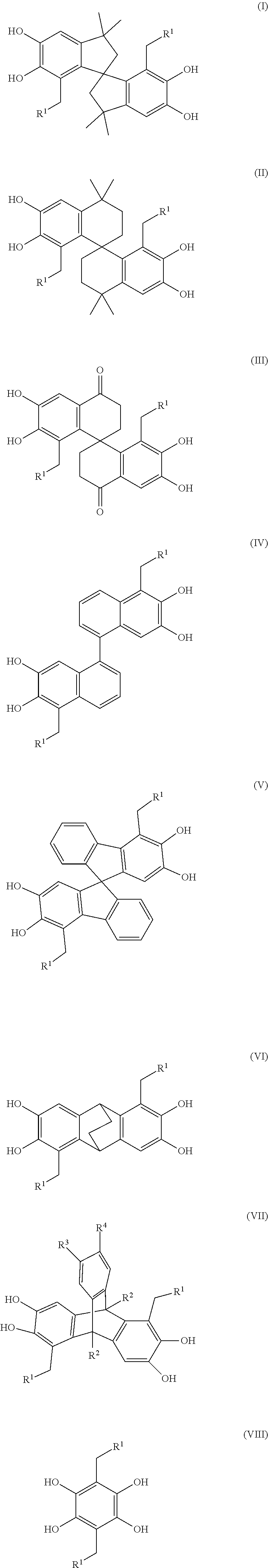

wherein:
R¹ is selected from the group consisting of:

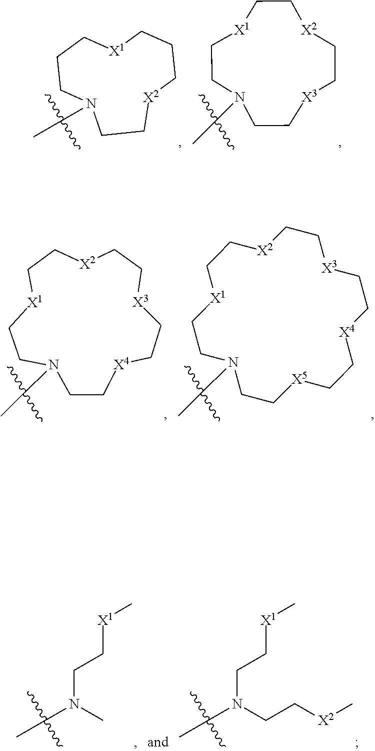

X¹, X², X³, X⁴, and X³ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; and
R³ and R⁴ are independently selected from the group consisting of (C₁₋₂₀)alkyl, (C₂₋₂₀)alkenyl, (C₂₋₂₀)alkynyl, (C₆₋₁₉)aryl, (C₃₋₈)cycloalkyl, (C₆₋₁₉)aryl(C₁₋₂₀)alkyl, (C₃₋₈s)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R⁴ and R⁵ are taken together to form (C₄₋₈)cycloalkyl, (C₆₋₁₀)aryl, 4- to 8-membered heterocyclyl, or 5- to 8-membered heteroaryl.

Compounds according to Formula I, II, III, IV, V, VI, VII, and VIII can be used as monomers for the synthesis of microporous polymers as described herein.

In some embodiments, each R¹ in compounds according to Formula I, II, III, IV, V, VI, VII, and VIII is independently selected from the group consisting of:

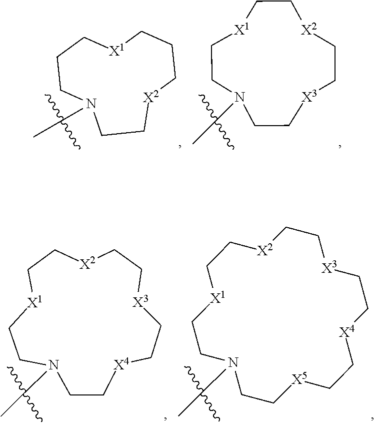

wherein X¹, X², X³, X⁴, and X³ are independently selected from O, S, Se, NR, and PR, wherein R is (C₁₋₂₀)alkyl or (C₆₋₁₀)aryl. In some embodiments, X¹, X², X³, X⁴, and X⁵ are independently selected from O, S, and Se. In some embodiments, X¹, X², X³, X⁴, and X⁵ are O.

In some embodiments, each R¹ in compounds according to Formula I, II, III, IV, V, VI, VII, and VIII is independently selected from the group consisting of:

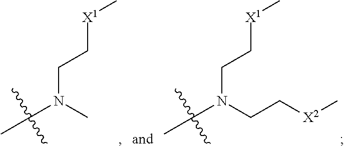

wherein X¹ and X² are independently selected from O, S, Se, NR, and PR, wherein R is (C₁₋₂₀)alkyl or (C₆₋₁₀)aryl. In some embodiments, X¹ and X² are independently selected from O, S, and Se. In some embodiments, X¹ and X² are O.

In some embodiments, R⁴ and R⁵ can also be bonded together to form a 4, 5, 6, 7, or 8 membered cycloalkyl, heterocyclyl, aryl, or heteroaryl. In some embodiments, R⁴ and R⁵ can also be bonded together with a linker X² to form a 6, 7, or 8 membered cycloalkyl, aryl, or heterocyclyl.

The amine-containing R¹ moieties may be introduced according to the methods provided herein, employing a formaldehyde source and an appropriate amine. Numerous suitable amines are commercially available or can be prepared according to known methods, including those described in Fiesers' Reagents for Organic Synthesis Volumes 1-28 (John Wiley & Sons, 2016), by March (Advanced Organic Chemistry 6^{th} Ed. John Wiley & Sons, 2007), and by Larock (Comprehensive Organic Transformations 3^{rd} Ed. John Wiley & Sons, 2018).

Also provided herein are methods for preparing compounds according to Formula I, II, III, IV, V, VI, VII, and VIII. The methods include:
forming a mixture comprising
(i) an amine selected from the group consisting of:

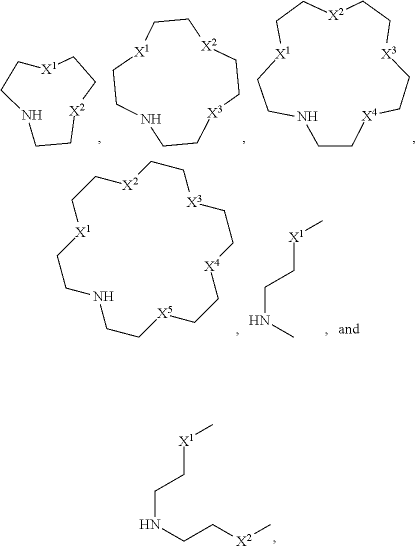

(ii) formaldehyde or a formaldehyde-generating compound; and
(iii) a compound according to Formula Ia, IIa, IIIa, IVa, Va, VIa, VIIa, or VIIIa:

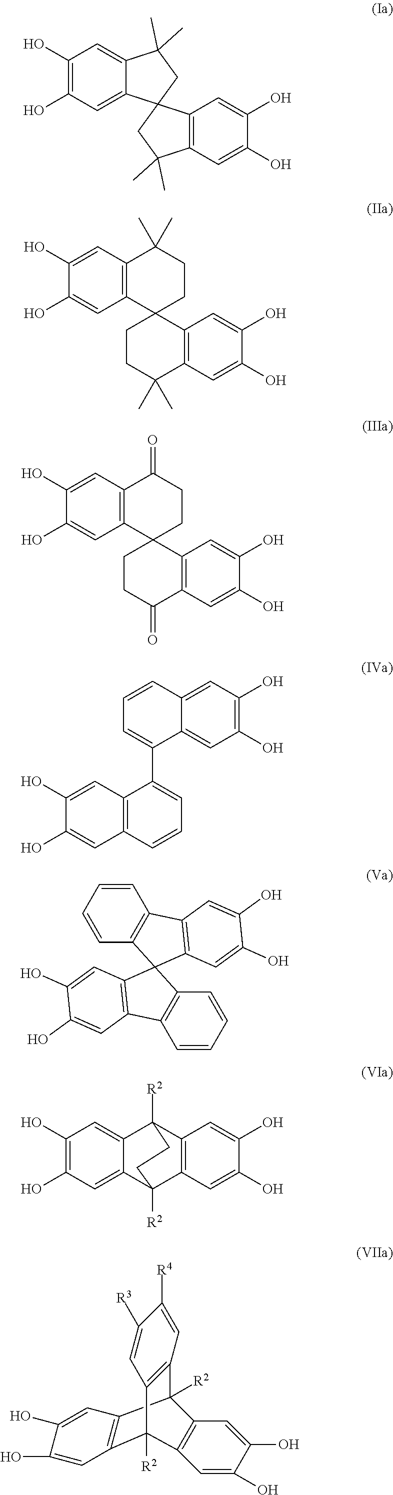

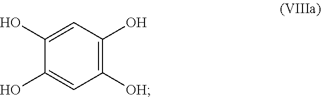

and maintaining the mixture under conditions sufficient to form the compound of Formula I, II, III, IV, V, VI, VII, or VIII.

Starting materials according to Formula (Ia), (IIa), (IIIa), (IVa), (Va), (VIa), (VIIa), or (VIIIa) may be obtained from commercial sources or synthesized according to the methods described herein or according to other known methods. See, e.g., Chemical Reviews 2018, 118(12), 5871-5911; Advanced Materials 2018, 30, 1704953; Science China: Chemistry 2017, 60(8), 1023-1032; Progress in Polymer Science 2015, 43, 1-32; Encyclopedia of Membrane Science and Technology 2013, 2, 781-797; Polymer 2013, 54(18), 4729-4761; Macromolecules 2010, 43(12), 5163-5176; Polymer Chemistry 2010, 1(1), 63-68; Chemical Society Reviews 2006, 35(8), 675-683; Chemistry—A European Journal 2005, 11(9), 2610-2620; and references cited therein. Amine precursors used for installation of RI moieties in the methods may have any combination X¹-X⁵ set forth above. Formaldehyde, as well as formaldehyde-generating compounds such as paraformaldehyde or 1,3,5-trioxane, may be employed. Typically, the amine precursor and the formaldehyde/formaldehyde-generating compound will be used in excess with respect to the starting material. For example, 2-250 molar equivalents of the amine precursor and the formaldehyde/formaldehyde-generating compound with respect to the starting material may be used. In some embodiments, 25-75 molar equivalents of an amine precursor and a formaldehyde-generating compound (e.g., paraformaldehyde) with respect to the starting material (e.g., a compound of Formula (Ia) or a compound of Formula (VIa)) are used to form the monomer product. Reactions are typically conducted at temperatures ranging from around −10° C. to about 150° C.for a period of time sufficient to form the monomer product (e.g., from about 1 hour to about 18 hours), depending on factors such as the particular starting material or amine precursor used in the reaction. In some embodiments, the reaction is conducted at ambient temperature (e.g., about 20° C., or about 25° C.). Elevated temperatures may be achieved through conventional heating or through microwave-assisted heating. Reaction mixtures may contain a solvent or mixture of solvents including, but not limited to, further comprises a solvent or mixture of solvents. The solvent may be, but it not limited to, methanol, ethanol, benzene, p-cresol, toluene, xylene, diethyl ether, glycol, diethyl ether, petroleum ether, hexane, cyclohexane, pentane, methylene chloride, chloroform, carbon tetrachloride, dioxanc, tetrahydrofuran (THF), dimethyl sulfoxide, dimethylformamide, hexamethyl-phosphoric triamide, ethyl acetate, pyridine, triethylamine, picoline, and the like, or a mixture thereof. Ethers, orthoesters, carbonates, lactones, sulfoxides, sulfones, sultones, sulfonamides, amides, carbamates, may also be used as solvents for synthesis of monomer compounds.

### III. MICROPOROUS POLYMERS

Microporous polymers of the present disclosure can include chelator-functionalized microporous polymers. In some embodiments, the present disclosure provides a microporous polymer according to the formula:

-[A-AB-B]ₙ-,
wherein no specification of the chain ends is assumed, and wherein:
n is an integer ranging from 10 to 10,000;
each monomer segment A-A is independently a monomer segment according to Formula A, B, C, D, E, F, G, H, I or J:

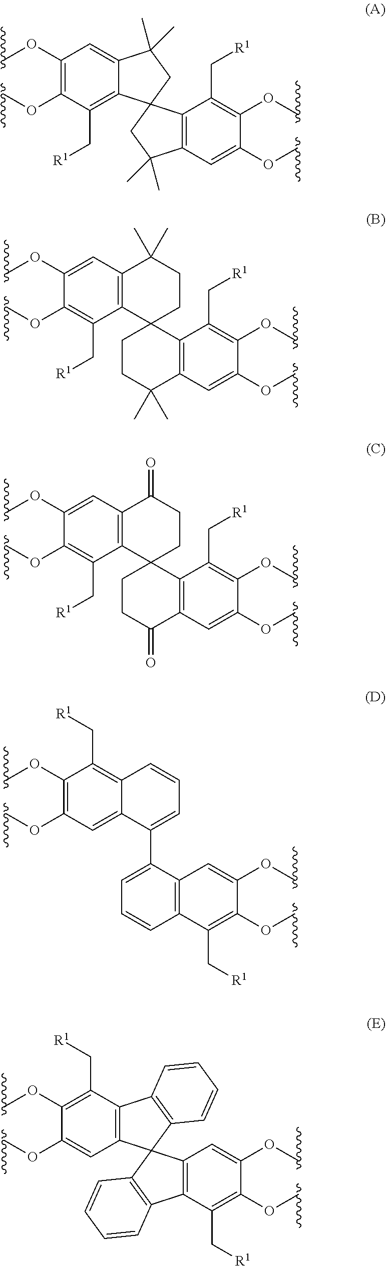

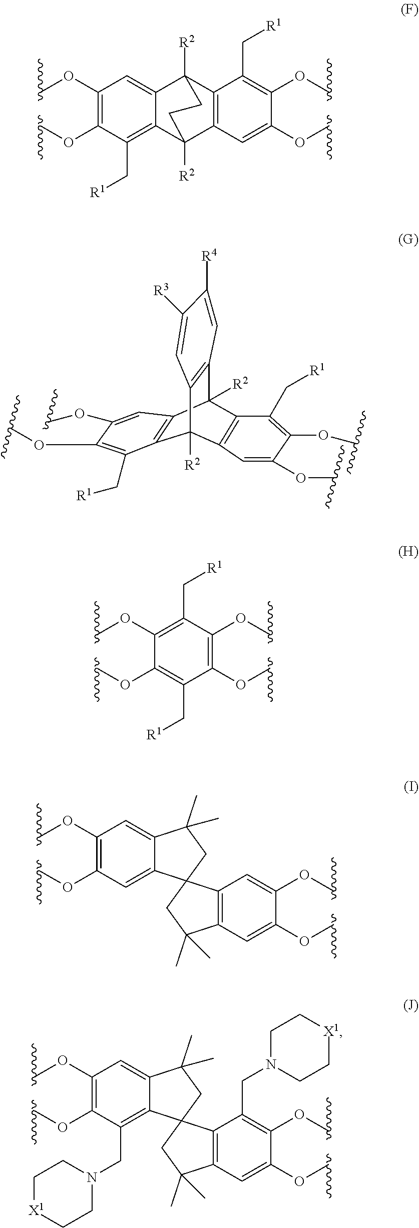

provided that at least one monomer segment A-A is independently a monomer segment according to Formula A, B, C, D, E, F, G, or H;
each monomer segment B-B is independently a monomer segment according to Formula a, b, or c:

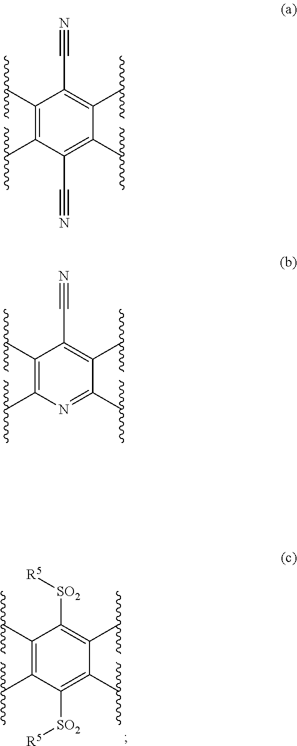

R¹ is selected from the group consisting of:

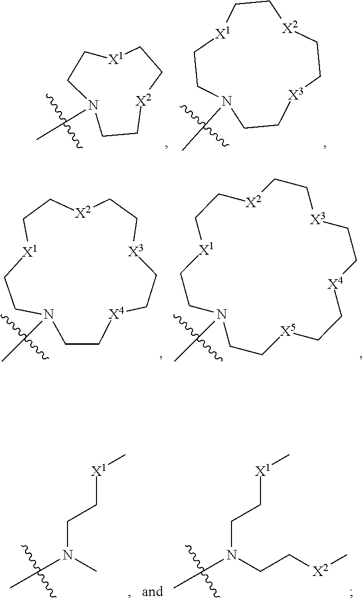

X¹, X², X³, X⁴, and X³ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl.

In general, no specification of the chain ends is assumed for polymers of the formula -[A-AB-B]ₙ-. That is, either chain end can contain a monomer segment A-A or a monomer segment B-B, independent of the other chain end. At the chain ends, however, moieties represented as

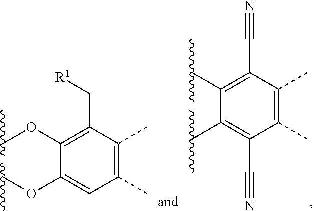

for example, in any of the monomer segments depicted herein will be present as catechols:

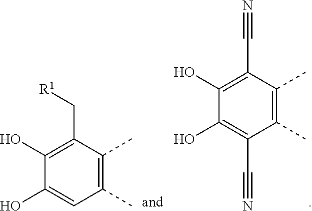

In the structures above, the dashed bonds represent the connection to the remainder of the polymer chain, and R¹ can include any of the moieties and combinations thereof as set forth herein.

In some embodiments, each monomer segment A-A is independently a monomer segment according to Formula A, B, C, D, E, F, G, or H. Such segments may contain any combination of R¹, R², R³, R⁴, X¹, X², X³, X⁴, X⁵ groups set forth above for monomer compounds according to Formula I-VIII.

In some embodiments, polymers of intrinsic microporosity may be characterized by a surface area. In some embodiments, polymers of intrinsic microporosity may be characterized by gas adsorption/desorption amount and rates, such as for N₂ adsorption/desorption, which may allow for determination of their surface area, for example. Adsorption isotherms may be determined to allow for determination of a Brunauer, Emmett, and Teller (BET) surface area. BET surface areas may allow for comparison of microporosity characters, for example, between different polymers of intrinsic microporosity. For example, a first polymer of intrinsic microporosity that exhibits a smaller BET surface area than a second polymer of intrinsic microporosity may be characterized as having less microporosity than the second polymer of intrinsic microporosity. Useful unmodified and modified polymers of intrinsic microporosity include, but are not limited to, those exhibiting a surface area of at least 50 m²/g, such as a surface area of 50 m² g⁻¹ to 2000 m² g⁻¹, or 200 m²/g to 1000 m²/g, or 250 m²/g to 800 m²/g. In some embodiments, the microporous polymer has a surface area ranging from about 50 m² g⁻1 to about 2000 m² g⁻¹.

Microporosity and pore sizes of polymers of intrinsic microporosity may be characterized by determining the effective rate of diffusion of one or more gases across a film of the polymer having a known thickness. Microporosity and pore size characteristics of polymers of intrinsic microporosity may also be probed using positron annihilation lifetime spectroscopy.

In some embodiments, polymers of intrinsic microporosity may be characterized by their solubility in organic solvents, such as tetrahydrofuran or chloroform. In some embodiments, polymers of intrinsic microporosity may exhibit high solubility in organic solvents, while other polymers may exhibit low or no solubility in organic solvents.

In some embodiments, polymers of intrinsic microporosity may be characterized by their molecular weights. Optionally, size exclusion chromatography may be useful for determining molecular weights of polymers of intrinsic microporosity. Optionally, gel permeation chromatography may be useful for determining molecular weights of polymers of intrinsic microporosity. Molecular weight determination may, in turn, allow for determination of a degree of polymerization of a polymer of intrinsic microporosity. Example polymers of intrinsic microporosity include, but are not limited to, those exhibiting molecular weights of at least 50 kg/mol, at least 100 kg/mol, at least 200 kg/mol, or at least 300 kg/mol. In some embodiments, polymers of intrinsic microporosity exhibit molecular weights selected from the range of about 50 kg/mol to about 250 kg/mol, or from the range of about 80 kg/mol to about 200 kg/mol. Example polymers of intrinsic microporosity include, but are not limited to, those exhibiting degrees of polymerization selected from the range of 100 to 1000, from the range of 200 to 900, from the range of 300 to 800, from the range of 400 to 700, or from the range of 500 to 600.

Chemical structure characterization of polymers of intrinsic microporosity may be accomplished using a variety of techniques. Such characterizations may also allow for determination of modifications and degrees of modifications to polymers of intrinsic microporosity. For example, ¹H and ¹³C nuclear magnetic resonance (NMR) spectroscopy may be useful. In some embodiments, infrared spectroscopy may also be useful. Additionally or alternatively, ionization mass spectrometry, such as electrospray ionization mass spectrometry, may also be useful for identifying structural moieties within a polymer of intrinsic microporosity. Other characterization techniques known to the skilled artisan may be useful for characterizing unmodified polymers of intrinsic microporosity and modified polymers of intrinsic microporosity. For example, in some embodiments, polymers of intrinsic microporosity may be characterized by their ultraviolet and/or visible absorption spectra.

In some embodiments, the microporous polymers have any one or more of the following properties: a surface area of ranging from about 50 m² g⁻¹ to about 2000 m² g⁻¹; pore sizes ranging from about 0.4 nm to about 2 nm; and a porosity ranging from about 5% to about 40%. Percent porosity φ may be defined as φ=V_{V}/V_{T}×100%, wherein V_{V} is the void volume and V_{T} is the total volume. The void volume of a particular material can be determined based on pore size characterization as described herein. In some embodiments, the microporous polymer has pore sizes ranging from about 0.4 nm to about 2 nm. In some embodiments, the microporous polymer has a porosity ranging from about 5% to about 40%.

Microporous polymers according to the present disclosure may have varying proportions of spirocyclic biscatechol monomer segments (e.g., A-A monomer segments according to Formula (A), Formula (B), Formula (C), and/or Formula (E)) and bridged bicyclic monomer segments (e.g., A-A monomer segments according to Formula (F) and/or Formula (G)). In some embodiments, for example, a polymer may contain spirocyclic biscatechol monomer segments A-A (A-A-1), bridged bicyclic monomer segments A-A (A-A-2), and monomer segments B-B, wherein the molar ratio [A-A-1]:[A-A-2]:[B-B] is in the range of [1-10]:[0-10]:[1-10]. In some embodiments, the molar ratio [A-A-1]:[A-A-2]:[B-B] is in the range of [0-10]:[1-10]:[1-10]. In some embodiments, the molar ratio [A-A-1]:[A-A-2]:[B-B] is in the range of [1-5]:[0-5]:[1-3]. In some embodiments, the molar ratio [A-A-1]:[A-A-2]:[B-B] is in the range of [0-5]:[1-5]:[1-3]. In some embodiments, the molar ratio [A-A-1]:[A-A-2]:[B-B] is in the range of [1-3]:[0-1]:[2]. In any of these embodiments, the ratio {[A-A-1]+[A-A-2]}:[B-B] may be approximately 1:1. In any of these embodiments, the microporous polymer may have the structure:

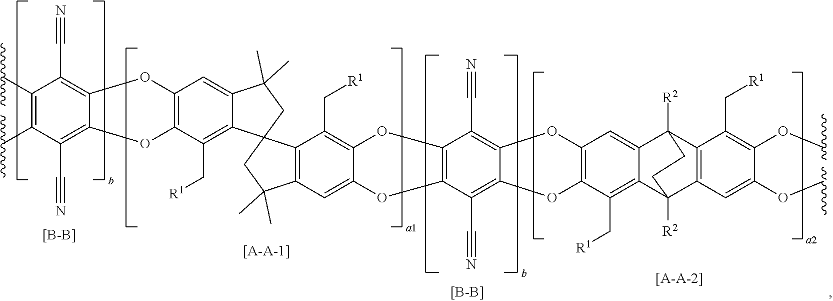

wherein the sum of subscripts a1, a2, and b ranges from 10-10,000. In some embodiments, the sum of subscripts a1, a2, and b ranges from 10-10,000, and the sum {a1+a2} is equal to the sum {b+b}. Such polymers may contain any combination of the R¹ and R² groups set forth herein.

Also provided herein are methods for preparing microporous polymers. The methods include:
forming a polymerization mixture comprising
   (1) a plurality of A-A monomers, wherein each A-A monomer is independently a compound according to I, II, III, IV, V, VI, VII, or VIII or a compound according to Formula IX or X:

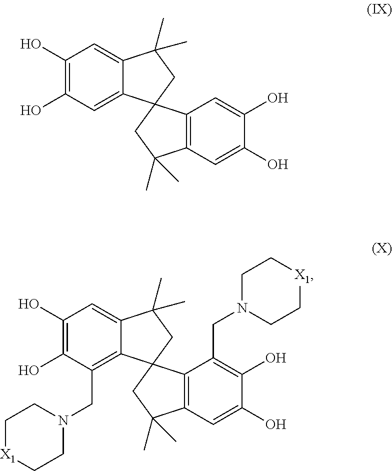

(2) a plurality of B-B monomers, wherein cach B-B monomer is independently a compound according to Formula i, ii, or iii:

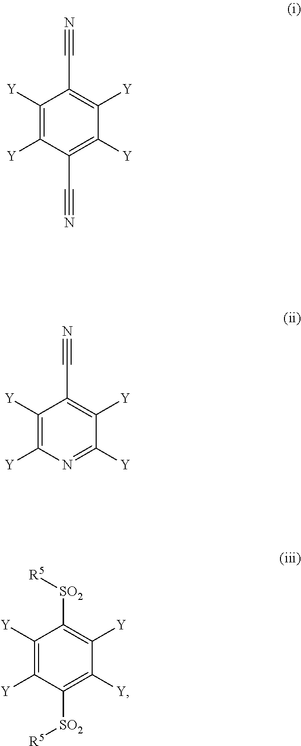

wherein Y is a halide, and
(3) a base; and
heating the polymerization mixture, thereby forming the microporous polymer.

Any suitable organic base or an inorganic base may be utilized. Examples of

suitable bases include potassium carbonate, sodium carbonate, sodium acetate, Huenig's base (i.e., N,N-diisopropylethylamine), lutidines including 2,6-lutidine (i.e., 2,6-dimethylpyridine), triethylamine, tributylamine, pyridine, 2,6-di-tert-butylpyridine, 1,8-diazabicycloundec-7-ene (DBU), quinuclidine, and the collidines. Combinations of two or more bases can be used. In some embodiments, the polymerization mixture further comprises solid grinding media, liquid grinding media, or a combination thereof. In some embodiments, the methods further include shaking or rotating the polymerization mixture, e.g., in a shaking or rotating container, also called a ball mill.

### IV. MICROPOROUS POLYMER MEMBRANES

Microporous polymers according to the present disclosure may be used for preparation of membranes, e.g., for use as separators in electrochemical cells. Typically, thickness of the membranes will range from about 0.1 micrometers (μm) to about 5000 μm. Membrane thickness may range, for example, from about 0.1 μm to about 1000 μm, or from about 25 μm to about 500 μm, or from about 50 μm to about 150 μm. In some embodiments, the membranes have a thickness ranging from 0.1 micrometer to 1000 micrometers.

In some embodiments, the membrane is in contact with a support material. The support material may contain one or more components including, but not limited to, a poly(arylether), a poly(arylether) copolymer, a poly(arylether sulfone) copolymer, a poly(arylether ketone), a poly(arylether ketone) copolymer, polyethylene, a polyethylene copolymer, polypropylene, a polypropylene copolymer, a polycycloolefin, a cycloolefin copolymer, polyacrylonitrile, a polyacrylonitrile copolymer, poly(vinylidene fluoride), a poly(vinylidene fluoride) copolymer, poly(tetrafluoroethylene), a poly(tetrafluoroethylene) copolymer, poly(hexafluoropropylene), a poly(hexafluoropropylene) copolymer, poly(vinyl chloride), a poly(vinyl chloride) copolymer, a polyamide, a polyamide copolymer, polyaramide, a polyaramide copolymer, polyurethane, a polyurethane copolymer, a polyurea, a polyurea copolymer, a porous metal, a porous alloyed metal, a porous metal oxide, and a porous metal sulfide.

Membranes may be prepared by suitable method. In some embodiments, the method of preparing the membrane includes casting at least one microporous polymer as described above from a solution or a dispersion of the polymer in a solvent or mixture of solvents. which are then substantially removed by evaporation to produce the membrane. In some embodiments, the method further includes the evaporation of solvent from the microporous polymer on a support to yield a supported membrane.

In some embodiments, the polymer membrane separator comprises one or more microporous polymers. In some embodiments, the polymer membrane includes one or more chelator-functionalized or amine-functionalized microporous polymers. In some embodiments, the polymer membrane includes an amine-functionalized microporous polymer. In some embodiments, the polymer membrane separator comprises one or more microporous polymers according to the formula:

-[A-AB-B]ₙ-,
or a salt thereof,
wherein:
n is an integer ranging from 10 to 10,000;
each monomer segment A-A is independently a monomer segment according to Formula K, L, M, N, O, P, Q or R:

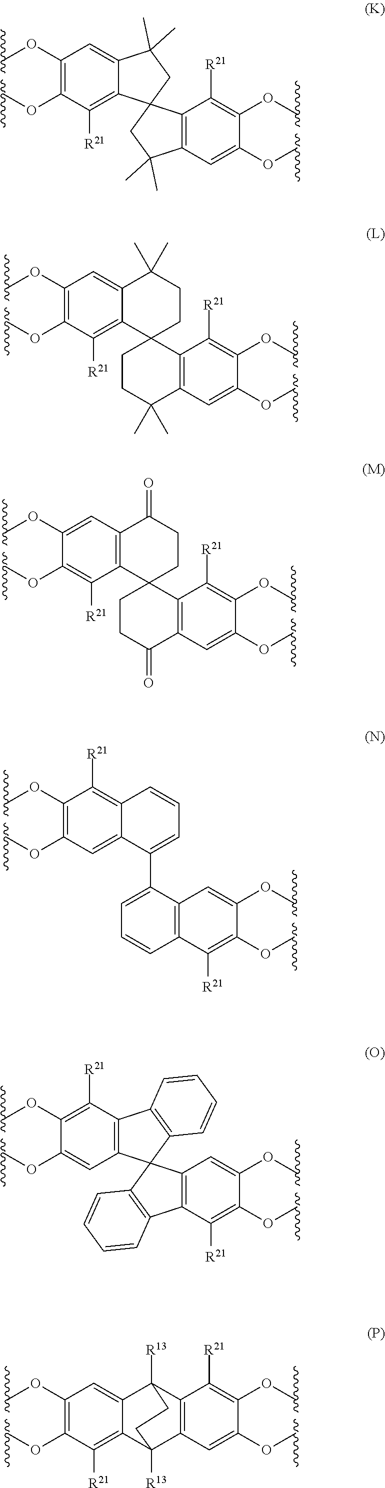

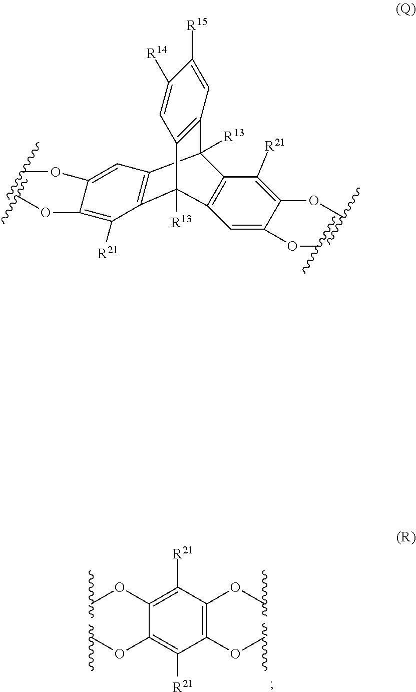

each monomer segment B-B is independently a monomer segment according to Formula k, l, m, n, o, or p:

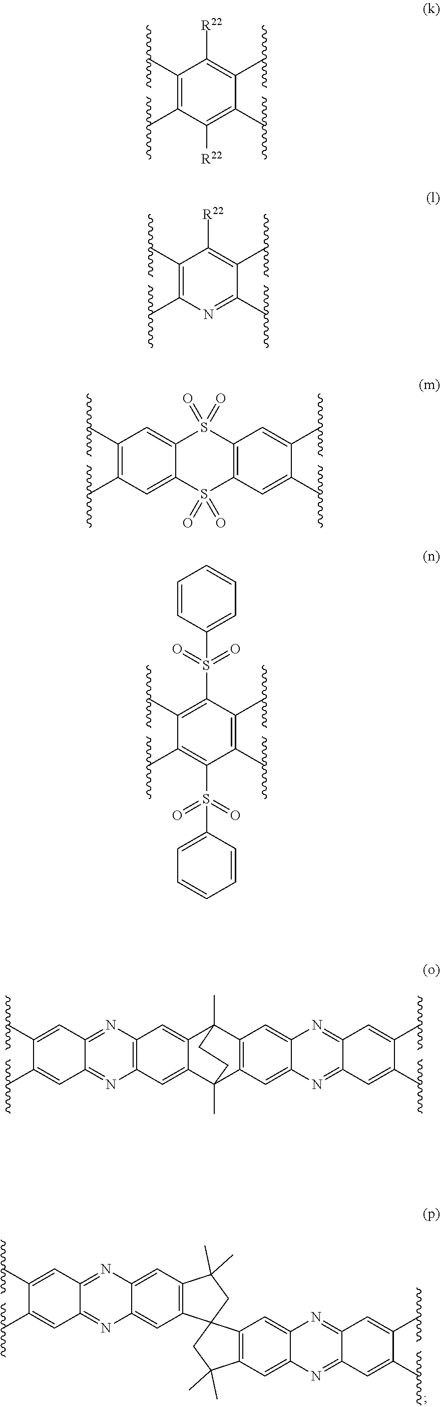

each R²¹ is independently selected from the group consisting of —CH₂NR¹¹R¹² and H;
each R²² is independently selected from the group consisting of —C(NOR²³)N(R²⁴)₂ and —CN;
at least one R²¹ in at least one monomer segment A-A is —CH₂NR¹¹R¹², or at least one R²² in at least one monomer segment B-B is —C(NOR²³)N(R²⁴)₂;
each R¹¹ and R¹² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, heteroaryl(C₁₋₂₀)alkyl,
wherein each R¹¹ and R¹² is optionally and independently substituted with one or more Z¹¹,
wherein each alkyl, alkenyl, and alkynyl in R¹¹ and R¹² optionally and independently comprises one or more heteroatoms independently selected from silicon, a chalcogenide, and a pnictide, and
wherein one or more atoms in R¹¹ and R¹² are optionally and independently present in oxidized form as C═O, C═S, N═O, N═S, S═O or S(O)₂; or
alternatively, each R¹¹ is optionally and independently taken together with R¹², and the nitrogen atom to which both are attached, to form 3- to 8-membered heterocyclyl or 5- to 8-membered heteroaryl, each of which is optionally substituted with one or more Z¹²;
each Z¹¹ and Z¹² is independently selected from the group consisting of halogen, —OH, —NO₂, —CN, (C₁₋₂₀)alkyl, (C₂₋₂₀)alkenyl, (C₂₋₂₀)alkynyl, (C₆₋₁₀)aryl, (C₃₋₈) cycloalkyl, (C₆₋₁₀)aryl(C₁₋₂₀)alkyl, hetero(C₁₋₂₀)alkyl, 3- to 8-membered heterocyclyl. 5- to 8-membered heteroaryl, (C₃₋₈)cycloalkyl-(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl, halo(C₁₋₂₀)alkyloxy, —OR¹⁶, —SR¹⁶, —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶;
each R¹³, R¹⁴, R¹⁵, R¹⁶, R¹⁷, and R¹⁸ is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, 5- to 8-membered heteroaryl-(C₁₋₂₀)alkyl; or
alternatively, R¹⁴ and R¹⁵ are taken together to form (C₄₋₈)cycloalkyl, (C₆₋₁₀)aryl, 4- to 8-membered heterocyclyl, or 5- to 8-membered heteroaryl; or
alternatively, R¹⁶ and R¹⁷ are taken together to form 4- to 8-membered heterocyclyl or 5- to 8-membered heteroaryl; or
alternatively, R¹⁷ and R¹⁸ are taken together to form 4- to 8-membered heterocyclyl or 5- to 8-membered heteroaryl;
each R²³ is selected from the group consisting of H, (C₁₋₂₀)alkyl, and (C₃₋₈)cycloalkyl, wherein alkyl and cycloalkyl are optionally and independently substituted with one or more Z³,
provided that R²³ is (C₁₋₂₀)alkyl or (C₃₋₈)cycloalkyl, cach of which is optionally and independently substituted with one or more Z¹³, when all R²¹ groups in monomer segments according to formula (A) are H;
each R²⁴ is independently selected from the group consisting of H, (C₁₋₂₀)alkyl, and (C₃₋₈)cycloalkyl; and
each Z¹³ is independently selected from the group consisting of halogen, —NO₂, —CN, —OH, —SO₃H, —NH₂, (C₁₋₂₀)alkyl, (C₂₋₂₀)alkenyl, (C₂₋₂₀)alkynyl, (C₆₋₁₀)aryl, (C₃₋₈) cycloalkyl, (C₆₋₁₀)aryl(C₁₋₂₀)alkyl, hetero(C₁₋₂₀)alkyl, 3- to 8-membered heterocyclyl, 5- to 8-membered heteroaryl, (C₃₋₈)cycloalkyl-(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl, halo(C₁₋₂₀)alkyloxy, —OR¹⁶, —SR¹⁶,
   —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶. Various embodiments of such amine-containing microporous polymers are described in WO 2020/037246, which is incorporated herein by reference in its entirety.

In some embodiments, the microporous polymer has the structure:

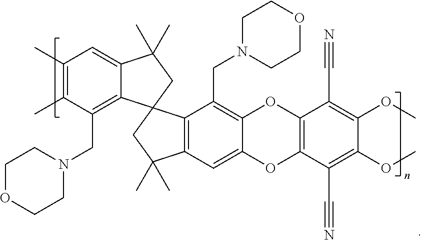

### V. ELECTROCHEMICAL CELLS

### A. Anode-Containing Cells

Also provided herein are electrochemical cells, including rechargeable electrochemical cells comprising a separator containing a membrane as described above. Examples of electrochemical cells in which microporous polymers according to the present disclosure can be employed include, but are not limited to, those described in U.S. Pat. Nos. 11,318,455; 10,727,488; and 10,710,065. Microporous polymers according to the presence disclosure can be applied in conjunction with aqueous cell chemistries currently under investigation for redox-flow batteries, hybrid redox-flow batteries, redox-targeting batteries, and solar flow batteries, including metal coordination complexes, organometallics, polyoxometalates, redox-active organic molecules, and redoxmers. The separator containing the microporous polymers allows the working ion(s) of the electrochemical cell to be passed through it, shuttling the ions between the anode and the cathode while preventing the transfer of electrons. The separator may optionally contain one or more support materials as described herein. In some embodiments, the area-specific impedance of the separator is less than or equal to 20 Ohm*cm². In some embodiments, the separator is stable up to an operating potential of at least 3.7 V vs. Li/Li⁺.

In some embodiments, the electrochemical cell comprises a polymer membrane separator containing a microporous polymer as described above. The electrochemical cell further comprises an anode, an anode electrolyte, a cathode electrolyte, and a cathode, wherein:
the polymer membrane separator is positioned between the anode and the cathode;
the anode electrolyte is in contact with the anode and a first face of the polymer membrane separator; and
the cathode electrolyte is in contact with the cathode and a second face of polymer membrane the separator. In some embodiments, the electrolytes are locally concentrated electrolytes comprising one or more alkali metal salts, a solvent, and a diluent.

In some embodiments, an electrochemical cell comprises (i) an anode, (ii) a first electrolyte, (iii) a polymer membrane separator, (iv) a second electrolyte, and (v) a cathode, wherein:
the polymer membrane separator is positioned between the anode and the cathode;
the first electrolyte is in contact with the anode and a first face of the polymer membrane separator;
the second electrolyte is in contact with the cathode and a second face of polymer membrane the separator;
the electrolytes comprise one or more alkali metal salts, a solvent, and a diluent;
the molar ratio of the alkali metal salts to the solvent ranges from about 1:1.75 to about 1:2.5; and
the molar ratio of the alkali metal salts to the diluent ranges from about 1:0.25 to about 1:1.5.

In some embodiments, the electrochemical cell comprises a polymer membrane separator containing one or more microporous polymers, e.g., as described in WO 2020/037246. The electrochemical cell further comprises an anode, an anode electrolyte, a cathode electrolyte, and a cathode, wherein:
the polymer membrane separator is positioned between the anode and the cathode;
the anode electrolyte is in contact with the anode and a first face of the polymer membrane separator; and
the cathode electrolyte is in contact with the cathode and a second face of polymer membrane the separator; and
the electrolytes are locally concentrated electrolytes comprising one or more alkali metal salts, a solvent, and a diluent.

In some embodiments, an electrochemical cell comprises (i) an anode, (ii) a first electrolyte, (iii) a polymer membrane separator comprising a microporous polymer, (iv) a second electrolyte, and (v) a cathode, wherein:
the polymer membrane separator is positioned between the anode and the cathode;
the first electrolyte is in contact with the anode and a first face of the polymer membrane separator;
the second electrolyte is in contact with the cathode and a second face of polymer membrane the separator; and
the electrolytes comprise one or more alkali metal salts, a solvent, and a diluent.

In some embodiments, the electrochemical cell comprises an anode. The anode in the electrochemical cells can contain any suitable material. The anode, for example, may include or consist of zinc or lithium. In some embodiments, the anode comprises graphite. In some embodiments, the anode comprises lithium metal, sodium metal, or potassium metal. In some embodiments, the anode comprises one or more of magnesium, calcium, aluminum, and/or zinc metal. In some embodiments, the anode comprises one or more of boron, silicon, germanium, arsenic, antimony, tellurium, and/or polonium semimetal. In some embodiments, the anode comprises a composite of metals, semimetals, and/or alloys thereof with a binder and/or one or more conductive additives such as C₆₀, carbon black, acetylene black, SuperP, KetjenBlack, graphene, multi-layer graphene, single-wall carbon nanotubes, multi-wall carbon nanotubes, carbon nanofibers, carbon fiber, MXenes, metal oxides, and/or black phosphorous.

The cathode in the electrochemical cells can contain any suitable material. The cathode, for example, may contain an active material such as sodium (2,2,6,6-tetramethylpiperidin-1-yl)oxyl-4-sulfate, a metal or metal oxide (e.g., a layered transition metal oxide such as LiNiₓMn_{y}Co₂O₂, referred to as NMC), and/or an electrolyte. In some embodiments, the cathode comprises a metal oxide, a polyanion oxide, a cation-disordered rocksalt, a metal sulfide, a metal fluoride, CFx, sulfur, oxygen, or combinations thereof. In some embodiments, the metal oxide is LiNiₓMn_{y}Co_{z}O₂.

### B. Anode-Free Cells

Also provided herein are rechargeable anode-free electrochemical cells containing microporous polymers, locally concentrated electrolytes, or a combination thereof. In some embodiments, the anode-free electrochemical cells contain a current collector, a current collector electrolyte, a polymer membrane separator, a cathode, and a cathode electrolyte, wherein:
the polymer membrane separator comprises one or more microporous polymers;
the polymer membrane separator is positioned between the current collector and the cathode;
the current collector electrolyte is in contact with the current collector and a first face of the polymer membrane separator; and
the cathode electrolyte is in contact with the cathode and a second face of the polymer membrane separator.

Also provided herein are electrochemical cells comprising a current collector, a current collector electrolyte, a polymer membrane separator, a cathode, and a cathode electrolyte, wherein:
the polymer membrane separator is positioned between the current collector and the cathode;
the current collector electrolyte is in contact with the current collector and a first face of the polymer membrane separator;
the cathode electrolyte is in contact with the cathode and a second face of the polymer membrane separator; and
the electrolytes are locally concentrated electrolytes comprising one or more alkali metal salts, a solvent, and a diluent.

In some embodiments, an electrochemical cell comprises (i) a current collector, (ii) a first electrolyte, (iii) a polymer membrane separator, (iv) a second electrolyte, and (v) a cathode, wherein:
the polymer membrane separator is positioned between the current collector and the cathode;
the first electrolyte is in contact with the current collector and a first face of the polymer membrane separator;
the second electrolyte is in contact with the cathode and a second face of polymer membrane the separator; and
the electrolytes comprise one or more alkali metal salts, a solvent, and a diluent.

In some embodiments, an electrochemical cell comprises (i) a current collector, (ii) a first electrolyte, (iii) a polymer membrane separator comprising a microporous polymer, (iv) a second electrolyte, and (v) a cathode, wherein:
the polymer membrane separator is positioned between the anode or the current collector and the cathode;
the first electrolyte is in contact with the current collector and a first face of the polymer membrane separator; and
the second electrolyte is in contact with the cathode and a second face of polymer membrane the separator.

In some embodiments, the electrochemical cell comprises the current collector. In some embodiments, the current collector comprises copper metal. In some embodiments, the current collector comprises a lithium alloy, a sodium alloy, or a potassium alloy. In some embodiments, the lithium alloy is selected from the group consisting of Li—Zn, Li—Al, Li—B, Li—Cd, Li—Ag, Li—Si, Li—Pb, Li—Sn, and Li—Mg.

In some embodiments, the first electrolyte and the second electrolyte are the same. In some embodiments, the first electrolyte and the second electrolyte are different.

### C. Locally Concentrated Electrolytes

The electrolytes provided herein were developed, in part, to address problematic bulk and interfacial behaviors associated with dilute electrolytes (DEs) and super-concentrated electrolytes (SCEs). Without being bound to any particular theory, it was hypothesized that the use of locally super-concentrated electrolytes (LSCEs), which employ a non-coordinating diluent, may reduce the viscosity of SCEs and provide concomitantly high carrier mobility and concentration. As described in detail below, it has now been discovered that LSCEs can stabilize electrochemical cells under conditions of ultra-fast-charge where decomposition of dilute electrolytes is observed.

Locally concentrated electrolytes used in the electrochemical cells of the present disclosure generally include one or more solvents, one or more diluents, and/or one or more alkali metal salts. In some embodiments, the electrolytes comprise one or more alkali metal salts, a solvent, and a diluent. The total molar concentration of the alkali metal salt(s) in the electrolytes typically ranges from about 0.5 M to about 7.5 M (e.g., 0.5-6 M, or 1-5 M, or 1-1.5 M, or 2-3M, or 3.5-4 M). In some embodiments, the electrolyte comprises 0.1 to 10 molar equivalents of the alkali metal salts with respect to the solvents. In some embodiments, the electrolyte comprises 0.1 to 10 molar equivalents of the alkali metal salts with respect to the solvents and 0.1 to 10 molar equivalents of the alkali metal salts with respect to the diluent.

In some embodiments, the solvent is a non-fluorinated solvent. In some embodiments, the solvent is an ether, an orthoester, a carbonate, a lactone, a sulfoxide, a sulfone, a sultone, a sulfonamide, an amide, a carbamate, or any combination thereof. Examples of such solvents include, but are not limited to, 1,2-dimethoxyethane (DME), 1,3-dioxolane (DOL), 1,4-dioxane, tetrahydrofuran (THF), allyl ether, diethylene glycol dimethyl ether (or “diglyme”), triethylene glycol dimethyl ether (or “triglyme”), tetraethylene glycol dimethyl ether (or “tetraglyme”), butyl diglyme, dimethyl ether, diethyl ether, polyethylene glycol. acetonitrile, dimethyl sulfoxide, sulfolane, trimethyl phosphate (TMPa), tricthyl phosphate (TEPa), dimethyl methylphosphonate (DMMP), hexamethyldisiloxane, hexamethylcyclotrisiloxane, silanes, methanol, ethanol, benzene, p-cresol, toluene, xylene, hexane, cyclohexane, pentane, methylene chloride, chloroform, carbon tetrachloride, dimethylformamide, hexamethyl-phosphoric triamide, ethyl acetate, pyridine, tricethylamine, picoline, and the like, and mixtures thereof. In some embodiments, each solvent is independently selected from the group consisting of 1,2-dimethoxyethane (DME), 1,3-dioxolane, 1,4-dioxane, tetrahydrofuran, allyl ether, diethylene glycol dimethyl ether, triethylene glycol dimethyl ether, tetraethylene glycol dimethyl ether, butyl diglyme, dimethyl ether, diethyl ether, polyethylene glycol, and combinations thereof. In some embodiments, the solvent comprises 1,2-dimethoxyethane (DME).

In some embodiments, the diluent is a fluorinated diluent. In some embodiments, the diluent is a fluorinated ether, a fluorinated orthoester, a fluorinated carbonate, a fluorinated lactone, a fluorinated sulfoxide, a fluorinated sulfone, a fluorinated sultone, a fluorinated sulfonamide, a fluorinated amide, a fluorinated carbamate, a fluorinated urea, or any combination thereof. Examples of such diluents include, but are not limited to, 1,1,2,2-tetrafluoroethyl-2,2,2,3-tetrafluoropropyl ether (TTE), bis(2,2,2-trifluoroethyl) ether (BTFE), 1,1,2,2,-tetrafluorocthyl-2,2,2-trifluoroethyl ether (TFTFE), methoxynonafluorobutane (MOFB), ethoxynonafluorobutane (EOFB), methyl 2,2,2-trifluoroethyl carbonate (MTFEC), di(2,2,2-trifluoroethyl) carbonate (DTFEC), tris(2,2,2-trifluorethyl)orthoformate, tris(hexafluoro-isopropyl)orthoformate, tris(2,2,2-difluoroethyl)orthoformate, bis(2,2,2-trifluoroethyl) methyl orthoformate, tris(2,2,3,3,3-pentafluoropropyl)orthoformate, and tris(2,2,3,3-tetrafluoropropyl)orthoformate. In some embodiments, each diluent is independently selected from the group consisting of 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), tris(2,2,2-trifluoroethyl)orthoformate (TFEO), methoxynonafluorobutane (MOFB), ethoxynonafluorobutane (EOFB), di(2,2,2-trifluoroethyl) carbonate (DTFEC), and combinations thereof. In some embodiments, the diluent comprises 1,1,2,2-tetrafluoroethyl-2,2,2,3-tetrafluoropropyl ether (TTE).

The alkali metal salts typically contain anions such as chlorate, perchlorate, nitrate, phosphate, hexafluorophosphate, borate, tetrafluoroborate, difluoro(oxalate)borate, bis(oxalate)borate, bis(fluorosulfonyl)imide, bis(trifluoromethane)sulfonimide, closo-dodecaborates, halogenated closo-dodecaborates. closo-carboranes, halogenated closo-carboranes, and combinations thereof. In some embodiments, the alkali metal salt is a sodium salt. In some embodiments, the alkali metal salt is a lithium salt. In some embodiments, the electrolyte contains two or more lithium salts. In some embodiments, each alkali metal salt is independently selected from the group consisting of sodium bis(fluorosulfonyl)imide (NaFSI), sodium bis(trifluoromethylsulfonyl)imide (NaTFSI), sodium bis(oxalato)borate (NaBOB), sodium difluoro oxalato borate anion (NaDFOB), NaPF₆, NaAsF₆, NaBFa, NaCF₃SO₃, NaClO₄, NaI, NaBr, NaCl, NaSCN, NaNO₃, and Na₂SO₄. In some embodiments, each alkali metal salt is independently selected from the group consisting of lithium bis(fluorosulfonyl)imide (LiFSI), lithium bis(pentafluoroethanesulfonyl)imide (LiBETI), lithium bis(trifluoromethane-sulfonyl)imide (LiTFSI), lithium bis(oxalato)borate (LiBOB), lithium difluoro oxalato borate anion (LiDFOB), LiPF₆, LiAsF₆, LIBF₄, LiCF₃SO₃, LiClO₄, LiI, LiBr, LiCl, LiF, LiSCN, LiNO₃, and Li₂SO₄. In some embodiments, the alkali metal salt comprises lithium bis(fluorosulfonyl)imide (LiFSI).

In some embodiments, the solvent is 1,2-dimethoxyethane (DME), the diluent is tetrafluoroethyl-2,2,2,3-tetrafluoropropyl ether (TTE), and wherein the electrolyte comprises a first alkali metal salt and one more additional alkali metal salts.

In some embodiments, the molar ratio of the alkali metal salts to the solvent ranges from about 1:1.75 to about 1:2.5. The molar ratio of the alkali metal salts to the solvent may range, for example, from about 1:1.8 to about 1:2.2, or from about 1:1.9 to about 1:2.1. In some embodiments, the molar ratio of alkali metal salts to the solvent is about 1:2.

In some embodiments, the molar ratio of the alkali metal salts to diluent ranges from about 1:0.25 to about 1:1.5. The molar ratio of the alkali metal salts to the diluent may range, for example, from about 1:1 to about 1:1.4, or from about 1:1.1 to about 1:1.3. In some embodiments, molar ratio of the alkali metal salts to the diluent is about 1:1.2.

In some embodiments, the molar ratio of the alkali metal salts to the solvent ranges from about 1:1.75 to about 1:2.5; and the molar ratio of the alkali metal salts to the diluent ranges from about 1:0.25 to about 1:1.5. In some embodiments, the molar ratio of the alkali metal salts to the solvent is about 1:2 and the molar ratio of the alkali metal salts to the diluent ranges from about 1:0.3 to about 1:1.3.

In some embodiments, the electrolytes comprise LiFSI, DME, and TTE in a molar ratio of about 1:x:y, wherein x ranges from about 1.9 to about 2.1 and y ranges from about 0.2 to about 3.8. In some embodiments, x is about 2 and y ranges from about 0.4 to about 1.5. In some embodiments, x is about 2 and y is about 1.2.

In some embodiments, the electrolytes contain a first alkali metal salt (e.g., LiFSI) and one more additional alkali metal salts (e.g., lithium difluoro(oxalate)borate, lithium perchlorate. lithium tetrafluoroborate, lithium trifluoromethanesulfonate, lithium hexafluorophosphate, lithium bis(trifluoromethanesulfonyl)imide, or any combination thereof). In some embodiments, the first alkali metal salt is lithium bis(fluorosulfonyl)imide, and the additional alkaline metal salts are selected from the group consisting of lithium difluoro(oxalate)borate, lithium perchlorate, lithium tetrafluoroborate, lithium trifluoromethanesulfonate, lithium hexafluorophosphate, and lithium bis(trifluoromethanesulfonyl)imide. In some embodiments, the electrolytes comprise the first alkali metal salt and a second alkali metal salt in a molar ratio ranging from about 75:25 to about 99:1. The molar ratio of the first and second alkali metal salts may range, for example, from about 80:20 to about 99:1, or from about 85:15 to about 95:5. In some embodiments, the molar ratio of the first and second alkali metal salts is about 90:10.

In some embodiments, the electrolytes comprise LiFSI, a second lithium metal salt, DME, and TTE in a molar ratio of about v:w:x:y, wherein v ranges from about 0.8 to about 0.99, w is equal to (1−v), x ranges from about 1.9 to about 2.1, and y ranges from about 0.2 to about 3.8. In some embodiments, v is about 0.9, w is about 0.1, x is about 2 and y ranges from about 0.4 to about 1.5. In some embodiments, x is about 2 and y is about 1.2.

In some embodiments, the electrochemical cell comprises:
the anode;
the first electrolyte and second electrolyte each comprise lithium bis(fluorosulfonyl)imide (LiFSI), 1,2-dimethoxyethane (DME), and 1,1,2,2-tetrafluoroethyl 2,2,3,3-tetrafluoropropyl ether (TTE) in a ratio of 1.0:2.0:2.8;
the cathode; and
the polymer membrane separator comprises the microporous polymer having the structure:

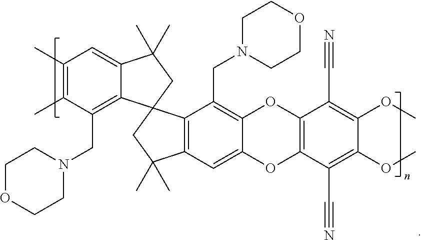

In some embodiments, the electrochemical cell comprises:
the anode;
the first electrolyte and second electrolyte each comprise lithium bis(fluorosulfonyl)imide (LiFSI), 1,2-dimethoxyethane (DME), and 1,1,2,2-tetrafluoroethyl 2,2,3,3-tetrafluoropropyl ether (TTE) in a ratio of 1.0:1.6:2.8;
the cathode; and
the polymer membrane separator comprises the microporous polymer having the structure:

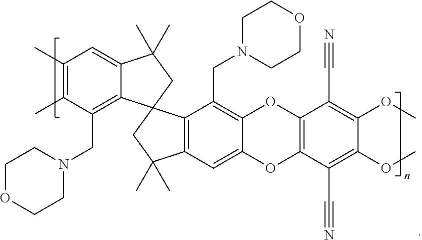

In some embodiments, the electrochemical cell comprises:
the anode;
the first electrolyte and second electrolyte each comprise lithium bis(fluorosulfonyl)imide (LiFSI), 1,2-dimethoxyethane (DME), and 1,1,2,2-tetrafluoroethyl 2,2,3,3-tetrafluoropropyl ether (TTE) in a ratio of 1.0:2.0:2.8;
the cathode; and
the polymer membrane separator comprises the microporous polymer having the structure:

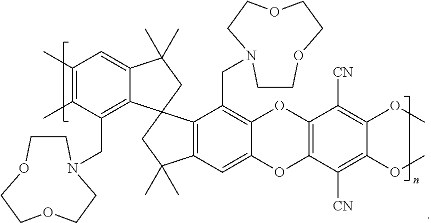

In some embodiments, the electrochemical cell comprises:
the anode;
the first electrolyte and second electrolyte each comprise lithium bis(fluorosulfonyl)imide (LiFSI), 1,2-dimethoxyethane (DME), and 1,1,2,2-tetrafluoroethyl 2,2,3,3-tetrafluoropropyl ether (TTE) in a ratio of 1.0:2.0:2.8;
the cathode; and
the polymer membrane separator comprises the microporous polymer having the structure:

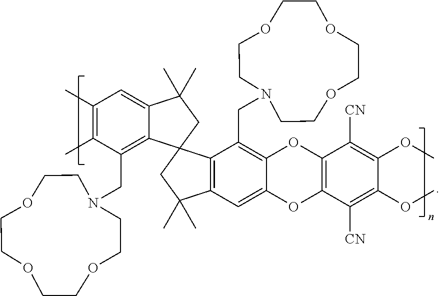

In some embodiments, the electrochemical cell comprises:
the anode;
the first electrolyte and second electrolyte each comprise lithium bis(fluorosulfonyl)imide (LIFSI), 1,2-dimethoxyethane (DME), and 1,1,2,2-tetrafluoroethyl 2,2,3,3-tetrafluoropropyl ether (TTE) in a ratio of 1.0:2.0:2.8;
the cathode; and
the polymer membrane separator comprises the microporous polymer having the structure:

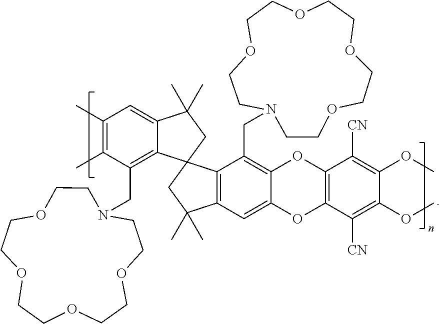

In some embodiments, the ionic conductivity of the electrolyte is greater than or equal to 3 mS cm⁻¹. In some embodiments, the viscosity of the electrolyte is less than or equal to 20 Pa*s at 20° C. The viscosity of the electrolyte may range, for example, from about 1 to 20 Pa*s at 20° C. In some embodiments, the electrolyte is stable up to an operating potential of at least 3.7 V vs. Li/Li⁺ (e.g., up to 4, 4.5, 5, 5.5, or 6 V). In some embodiments, the rechargeable electrochemical cell has an area capacity of greater than or equal to 1 mAh cm⁻² and less than or equal to 15 mAh cm⁻². In some embodiments, the rechargeable electrochemical cell has a cycle life of greater than or equal to 50 cycles (e.g., 50-10,000 cycles). In some embodiments, the cycle life is greater than or equal to 20 larger than the cycle life of an otherwise equivalent electrochemical cell with a conventional polyolefin separator and conventional liquid carbonate electrolyte. In some embodiments, the rechargeable electrochemical cell has a power rating of greater than or equal to 500 W kg⁻¹ (e.g., 500-5000 W kg⁻¹). In some embodiments, the rechargeable electrochemical cell has a power rating of greater than or equal to 2-fold higher than the power rating of an otherwise equivalent electrochemical cell with a conventional polyolefin separator and conventional liquid carbonate electrolyte.

During charge and discharge cycling of an electrochemical cell according to the present disclosure, cell voltages may be maintained (e.g., via a controller as described in U.S. Pat. No. 10,727,545) above a lower voltage limit, V_{LL}, and below a normal operation charging voltage upper voltage limit, V_{UL}. A constant charging current i_{NC} may be maintained as the cell voltage increases. As cell voltage reaches the upper voltage limit, V_{UL}, the charging current may be reduced and/or stopped after the cell voltage reaches V_{UL} or after the cell is fully charged. V_{UL} can vary according to the specific materials, performance requirements and application that the electrochemical cell is designed for. For example, V_{UL} can be in the range of 2.5V to 5.5V. Electrochemical cells according to the present disclosure are particularly useful for fast- and ultrafast-charging methods. In some embodiments, charging an electrochemical cell includes increasing the state of charge (SOC) of the cell from a first value (e.g., 1%, 5%, 10%, 30%, 50% or more) to at least 80% in a period of time ranging from about 5 minutes to about 30 minutes (e.g., 5-15 minutes). In some embodiments, the C-rate during the charging ranges from 0.05C to 2C, or 0.1C to 2C.

A plurality of electrochemical cells may be connected in series and/or in parallel via electrode terminals for various applications. In some high-power applications such as electric vehicles. cells may be configured as one or more battery modules and/or packs. A battery module may be formed by electrically connecting a certain number of electrochemical cells and arranging them in a frame in order to protect the cells from external impact, heat, vibration, or the like. The battery pack may then be installed in the electric vehicle or other system. Many existing battery packs are made by assembling various control and protection systems such as battery management systems (e.g., as described in WO 2015/023820A2) and thermal management components on one or more battery modules.

### VI. EXAMPLES

### Example 1

### Preparation and Electrochemical Characterization of Liquid Electrolytes Containing a Lithium Salt, an Ethereal Solvent, and a Non Coordinating Diluent

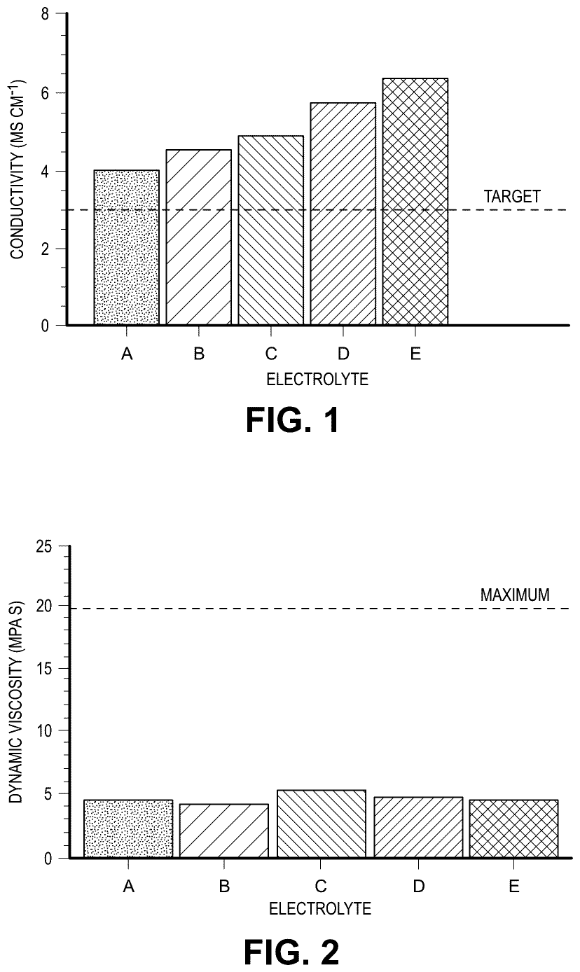

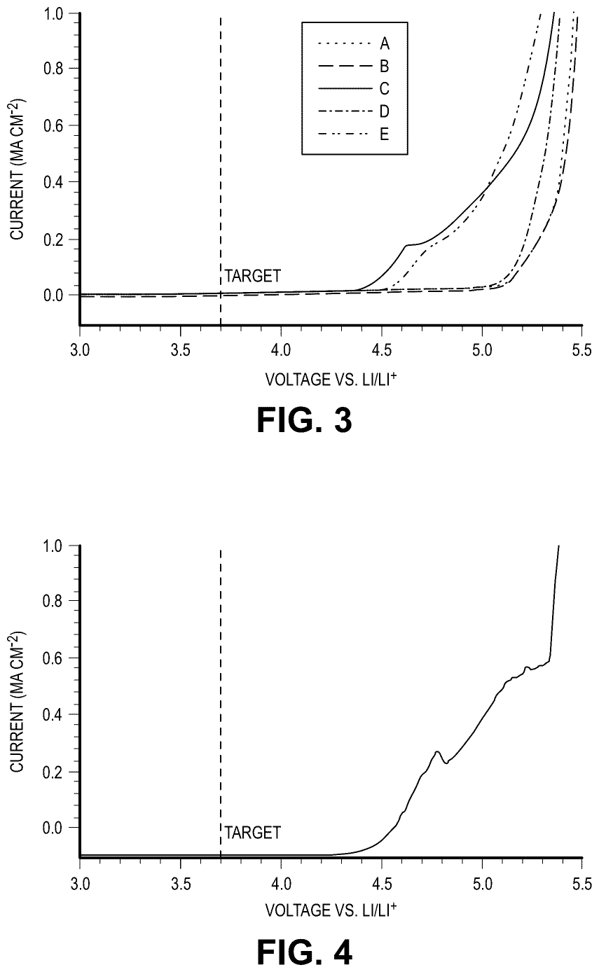

Liquid electrolytes containing lithium bis(fluorosulfonyl)imide (LiFSI), 1,2-dimethoxyethane (DME), and 1,1,2,2-tetrafluoroethyl 2,2,3,3-tetrafluoropropyl ether (TTE) in molar ratios of 1.0:1.6:2.8, 1.0:1.6:2.4, 1.0:1.6:2.0, 1.0:2.0:2.8, and 1.0:2.4:2.0 (A, B, C, D, and E, respectively) were prepared by first adding lithium bis(fluorosulfonyl)imide in 1,2-dimethoxyethane and stirring for 10 minutes, or until fully dissolved. Then, 1,1,2,2-tetrafluoroethyl 2,2,3,3-tetrafluoropropyl ether was added. The electrolyte ionic conductivity was then measured using a Mettler Toledo Seven2GoTM S3 conductivity meter at a temperature between 23° C. and 24° C.(FIG. 1). Conductivities were observed to exceed 3 mS cm⁻¹. Electrolyte viscosities were also measured using a RheoSense micro VISC viscometer and found to be below mPa·s (FIG. 2). Linear sweep voltammetry of the electrolyte was also conducted using a sweep rate of 1.0 mV s⁻¹, and voltage stabilities exceeded 3.7 V vs. Li/Li⁺ (FIG. 3).

### Example 2

### Preparation and Electrochemical Characterization of a Microporous Polymer Membrane

A 2032 coin cell was assembled with a lithium counter electrode, electrolyte, a polyolefin separator, and a stainless steel electrode with polymer coated at a thickness of 5 μm. This was done using the polymer shown below:

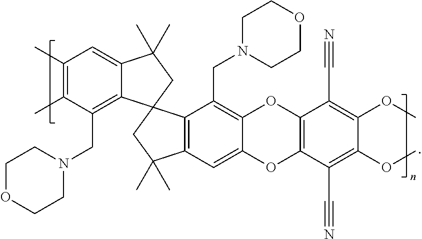

which was coated onto the stainless steel working electrode. The cell was constructed using electrolyte D from Example 1. Electrochemical impedance spectroscopy was performed using the same polymer membrane. Linear sweep voltammetry was conducted and the voltage stability of the cell exceeded 3.7 V vs. Li/Li⁺ at 25° C.

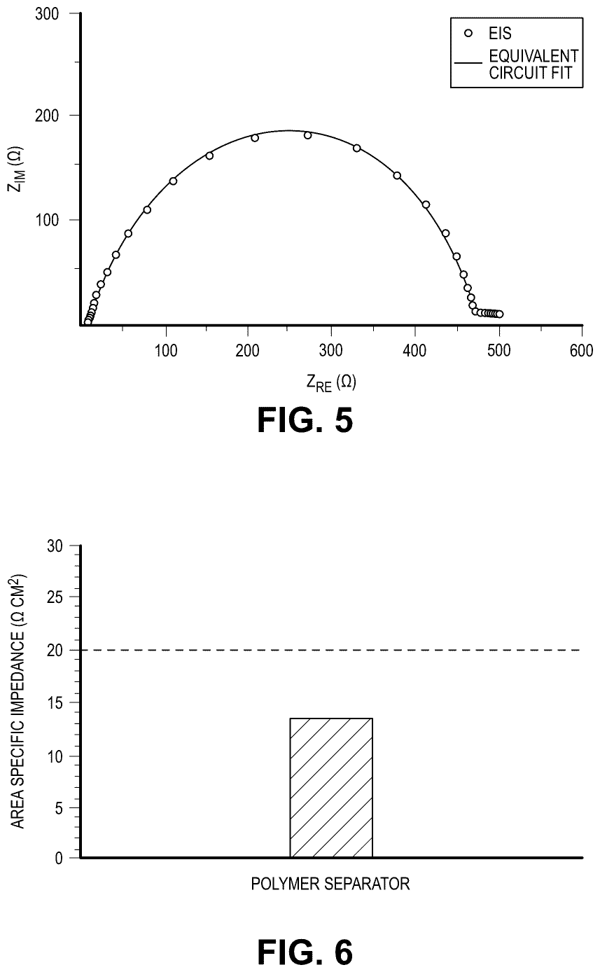

The polymer was coated onto lithium electrodes at a thickness of 5 μm and a 2032 coin cell was assembled using electrolyte D. A Nyquist plot was recorded (FIG. 5) for calculation of the area specific impedance (FIG. 6) which was less than 20 Ohm·cm⁻² at 20° C.

### Example 3

### Preparation and Cycling of Electrochemical Cells Containing a Locally Concentrated Electrolyte and Optionally Containing a Microporous Polymer Membrane

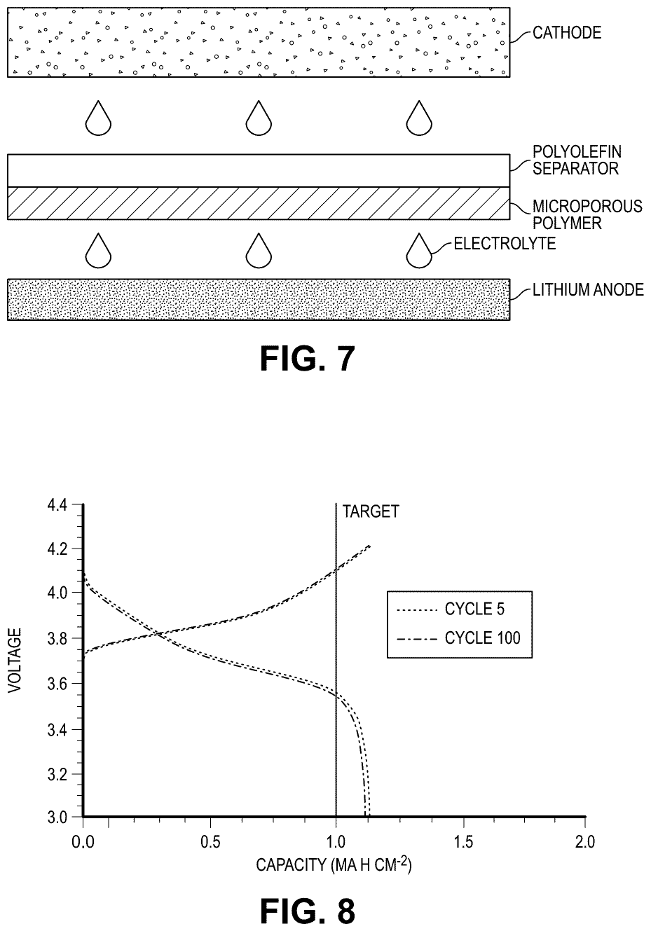

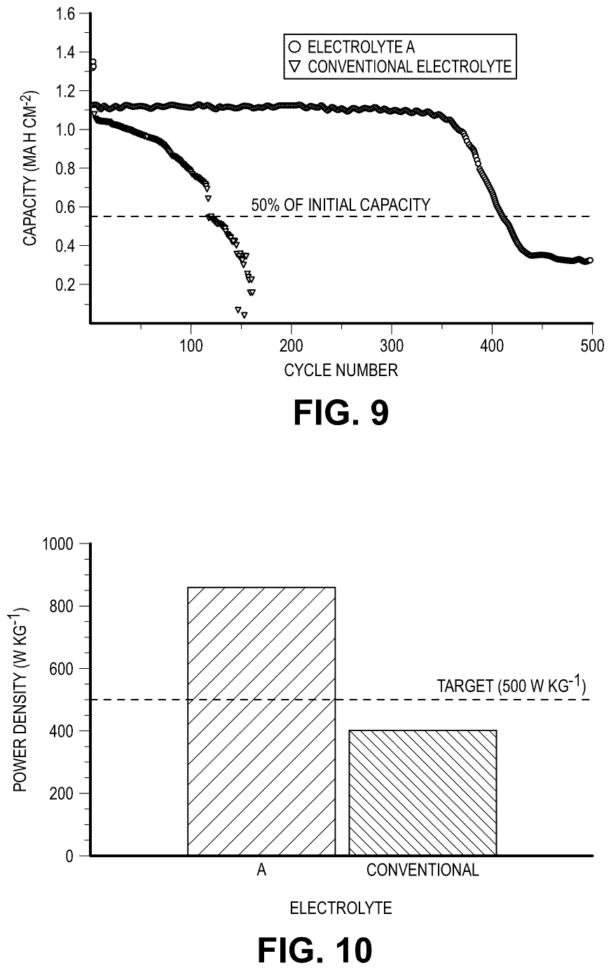

A Li|NMC622 electrochemical cell was constructed using locally concentrated electrolyte A as described in Example 1 and the microporous polymer membrane described in Example 2, which was coated onto a polyolefin separator at a thickness of 1 μm. See, FIG. 7. As a control, an otherwise equivalent electrochemical cell was constructed using a dilute electrolyte (1 M LiPF₆ in a 1:1 (v/v) mixture of ethylene carbonate and diethyl carbonate) and a polyolefin separator without a microporous polymer membrane. Cells were cycled using a 1.0 mA cm⁻² charge/discharge protocol with a 4.2 V upper cutoff voltage and 3 V lower cutoff voltage. The cell cycled an areal capacity greater than 1.0 mA h cm⁻² through 100 cycles (FIG. 8). The cycle life (defined as the number of cycles before the discharge capacity drops below 50% of the initial) of this cell was approximately 400 cycles, while the cycle life of the control cell containing a dilute electrolyte was approximately 110 cycles (FIG. 9). The power density, calculated by dividing the discharge power by the mass of electrode materials, of the Li|NMC622 electrochemical cell employing locally concentrated electrolyte exceeds 500 W kg⁻¹, which represents greater than a twofold increase in power density compared to the equivalent electrochemical cell employing a conventional carbonate electrolyte (FIG. 10).

### Example 4

### Preparation and Cycling of Anode-Less Electrochemical Cells Containing a Locally Concentrated Electrolyte and Optionally Containing a Microporous Polymer Membrane

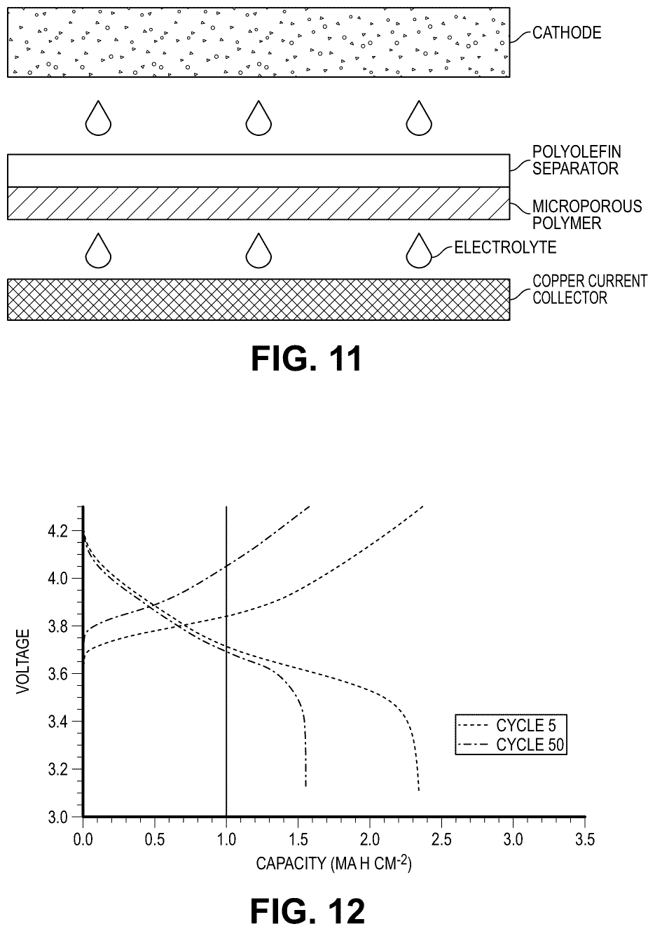

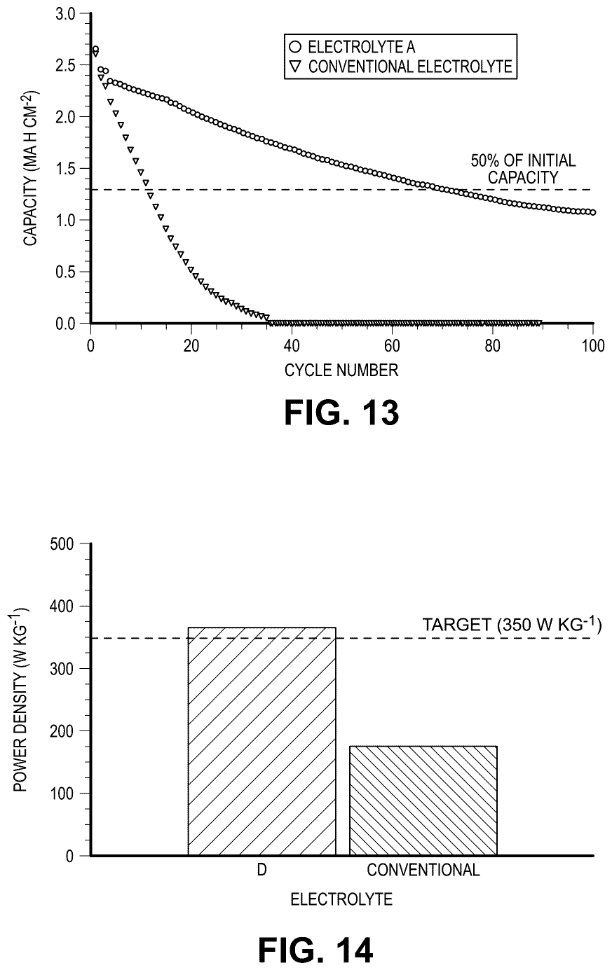

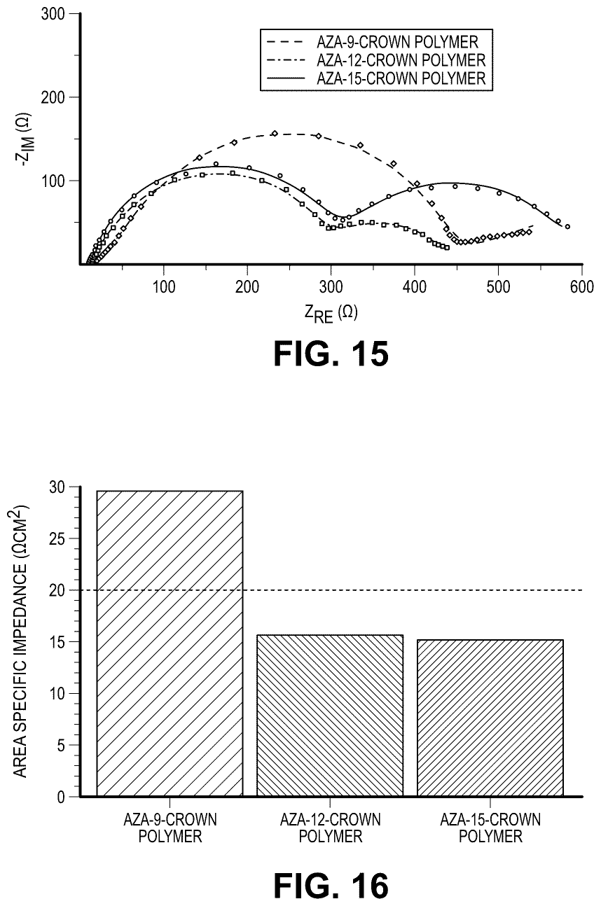

A Cu|NMC622 electrochemical cell was constructed using locally concentrated electrolyte A as described in Example 1 and the microporous polymer described in Example 2. which was coated onto a polyolefin separator at a thickness of 1 μm. See, FIG. 11. As a control, an otherwise equivalent electrochemical cell was constructed using a dilute electrolyte (1 M LiPF₆ in a 1:1 (v/v) mixture of ethylene carbonate and diethyl carbonate) and a polyolefin separator without a microporous polymer membrane. Cells were cycled using a 0.5 mA cm⁻² charge/1.0 mA cm⁻² discharge protocol with a 4.3 V upper cutoff voltage and 3 V lower cutoff voltage. The cell cycled an areal capacity greater than 1.0 mA h cm⁻² through 50 cycles (FIG. 12). The cycle life (defined as the number of cycles before the discharge capacity drops below 50% of the initial) of this cell was approximately 70 cycles. while the cycle life of the control cell containing a dilute electrolyte was 11 cycles. (FIG. 13). The power density, calculated by dividing the discharge power by the mass of electrode materials, of the Li|NMC622 electrochemical cell employing locally concentrated electrolyte exceeds 350 W kg⁻¹, which represents greater than a twofold increase in power density compared to the equivalent electrochemical cell employing a conventional carbonate electrolyte (FIG. 14).

### Example 5

### Synthesis of Monomers and Polymers

Materials. Benzylamine, triethylene glycol, 4-toluenesulfonyl chloride, lithium bromide, paraformaldehyde, 10% palladium on carbon and potassium carbonate were obtained from Sigma Aldrich. 3,3,3′,3′-tetramethyl-1,1′-spirobisindane-5,5′,6,6′-tetraol and sodium hydroxide was obtained from Alfa Acsar. 1-aza-15-crown-5 and 1-aza-12-crown-4 were obtained from TCI. Tetrafluoroterephthalonitrile was obtained from Oakwood Chemical. N,N-dimethylacetamide was obtained from Acros Organics. Sodium hydroxide pellets were obtained from Alfa Acsar. Tetrahydrofuran, methylene dichloride, chloroform, N,N-dimethylformamide, methanol, and toluene were obtained from OmniSolv. Ethanol was obtained from Macron. CDCl₃ was obtained from Cambridge Isotope Laboratories. Triethylene glycol ditosylate was synthesized in 96% yield according to the procedure of Du et al. (J. Am. Chem. Soc. 2019, 141 (17), 7163-7172).

¹H and ¹³C Nuclear Magnetic Resonance (NMR) Spectroscopy. ¹H and ¹³C NMR spectra were recorded on Bruker Avance II at 500 MHz and 125 MHz, respectively, and processed using Mestrenova 12.0.3 Software. Chemical shifts are reported in δ (ppm) relative to the residual solvent peak (CDCl₃: 7.26 for ¹H, 77.16 for ¹³C). Splitting patterns are designated as s (singlet), br s (broad singlet), d (doublet), t (triplet), q (quartet), and m (multiplet).

Electrospray lonization Mass Spectrometry (ESI-MS). Spectra were acquired on a Bruker MicroTOF spectrometer.

Size-Exclusion Chromatography (SEC). Molecular weights were determined using a Malvem Resolve/Reveal multi-detection SEC system using tetrahydrofuran as the eluent.

Column Chromatography. Column chromatography was carried out with a silica

or basic alumina stationary phase. Where noted, flash chromatography was carried out using a Biotage Isolera flash purification system, with Biotage SNAP KP-Sil columns.

Synthesis of N-benzyl 1-aza-9-crown-3:

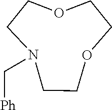 [SMILES: c1ccc(CN2CCOCCOCC2)cc1]

An adaptation to the procedure of Sakamoto et al. (J. Org. Chem. 1986, 51 (25), 4974-4979) was used. To a round bottom flask (1000 mL) equipped with a magnetic stir bar was added N,N-dimethylacetamide (500 mL), lithium bromide (52.11 g, 600 mmol), potassium carbonate (41.46 g, 300 mmol), and triethylene glycol ditosylate (45.86 g, 100 mmol). Benzylamine (10.93 mL, 100 mmol) was then added while stirring. A reflux condenser was attached and the mixture heated to 130° C. for 96 h. The solvent was then removed under reduced pressure. Aqueous sodium hydroxide (1.0 M, 1000 mL) was added to the residue and the product was extracted 5 times with DCM (200 mL). The combined organic extracts were dried over sodium sulfate before solvent was removed under reduced pressure to yield the crude product as a red oil. This was purified using flash chromatography with a silica gel stationary phase and hexanes-ethyl acetate mobile phase. The solvent was removed under reduced pressure to yield the product as a yellow oil (5.53 g, 25% yield). ¹H NMR and EI-MS spectra were in accordance with the literature procedure.

Synthesis of 1-aza-9-crown-3:

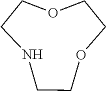

To a three-neck round bottom flask (1000 mL) equipped with a magnetic stir bar was added 10% Pd/C (0.60 g). The flask was evacuated and refilled with dinitrogen gas three times. In a separate round bottom flask, 500 mL of ethanol with 1-aza-9-crown-3 (5.30 g, 24 mmol) was sparged with dinitrogen gas to remove dissolved oxygen. The solution of the substrate in ethanol was then transferred to the evacuated reaction flask via cannula transfer. The flask was then evacuated and backfilled 3 times with dihydrogen gas. After stirring for 20 h, the reaction mixture was isolated by filtration through a Celite pad which was washed with ethanol. The solvent was then removed under reduced pressure to yield the product as a light yellow oil (2.19 g, 70% yield), then stored under dinitrogen gas at 4° C. ¹H NMR and EI-MS spectra were in accordance with the literature procedure.

### Synthesis of Monomer 1a:

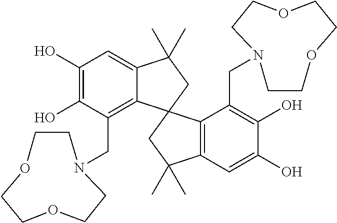 [SMILES: CC1(C)CC2(CC(C)(C)c3cc(O)c(O)c(CN4CCOCCOCC4)c32)c2c1cc(O)c(O)c2CN1CCOCCOCC1]

To a round bottom flask (250 mL) equipped with a magnetic stir bar was added toluene (80 mL), paraformaldehyde (0.24 g, 8.0 mmol), and 1-aza-9-crown-3 (1.05 g, 8.0 mmol). The reaction stirred for 10 min at reflux, at which point 3,3,3′,3′-tetramethyl-1,1′-spirobisindane-5,5′,6,6′-tetraol (1.36 g, 4.0 mmol) was added. A Dean-Stark apparatus was attached and the reaction was stirred at reflux for 96 h. The reaction was concentrated under reduced pressure, followed by purification by flash chromatography (methanol/methylene dichloride). The solvent was removed under reduced pressure to yield the product as a light orange powder (1.83 g. 68% yield). ¹H NMR (CDCl₃, 500 MHz): δ (ppm) 12.56 (br s, 2H), 6.66 (s, 2H), 5.65 (br s, 2H), 3.87-3.50 (br m, 16H), 3.45 (d, 2H, J=14.8 Hz), 3.04 (d, 2H, J=14.8 Hz), 3.00-2.46 (br m, 8H), 2.28 (d, 2H, J=13.4 Hz), 2.18 (d, 2H, J=13.4 Hz), 1.36 (s, 6H), 1.27 (s, 6H); ¹³C NMR (CDCl₃, 125 MHz): δ (ppm) 145.2, 144.6. 142.0, 138.9, 115.9, 107.3, 74.0 (br), 72.8 (br), 72.2 (br), 70.7 (br), 57.9, 56.6, 55.2, 54.3 (br), 52.8 (br), 42.9, 33.0, 29.8; HR-MS (ESI) calc. for C₃₅H₅₁N₂O₈³⁰ 627.3640; found 627.3758.

### Synthesis of Monomer 1b:

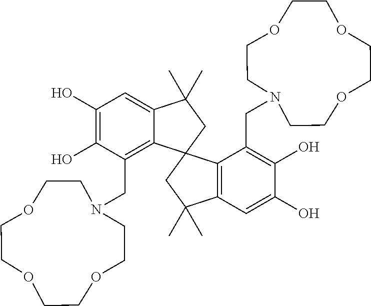 [SMILES: CC1(C)CC2(CC(C)(C)c3cc(O)c(O)c(CN4CCOCCOCCOCC4)c32)c2c1cc(O)c(O)c2CN1CCOCCOCCOCC1]

To a round bottom flask (250 mL) equipped with a magnetic stir bar was added toluene (70 mL), paraformaldehyde (0.21 g. 7.1 mmol), and 1-aza-12-crown-4 (1.24 g, 7.1 mmol). The reaction stirred for 10 min at reflux, at which point 3,3,3′,3′-tetramethyl-1,1′-spirobisindane-5,5,6,6′-tetraol (1.21 g, 3.5 mmol) was added. A Dean-Stark apparatus was attached and the reaction was stirred at reflux for 46 h. The reaction was concentrated under reduced pressure, followed by purification with silica gel chromatography (methanol-methylene dichloride). The solvent was removed under reduced pressure to yield the product as a light orange powder (0.55 g, 22% yield). ¹H NMR (CDCl₃, 500 MHz): δ (ppm) 11.83 (br s, 2H), 6.62 (s, 2H), 5.77 (br s, 2H), 3.76-3.37 (br m, 24H), 3.21-3.06 (m, 4H), 3.01-2.87 (br m, 2H), 2.68-2.56 (br m, 2H), 2.52-2.37 (br m, 2H), 2.25 (d, 2H, J=13.3 Hz), 2.16 (d, 2H, J=13.3 Hz), 2.13-2.03 (br m, 2H), 1.31 (s, 6H), 1.25 (s, 6H); ¹³C NMR (CDCl₃, 125 MHZ): δ (ppm) 145.0, 144.8, 141.8, 138.8, 116.6, 107.1, 71.3, 71.0, 70.6, 70.0, 69.7, 68.3, 57.8, 56.7, 54.4, 54.2, 53.6, 42.8, 32.9, 30.0; HR-MS (ESI) calc. for C₃₉H₅₉N₂O₁₀⁺ 715.4164; found 715.4289.

### Synthesis of Monomer 1c:

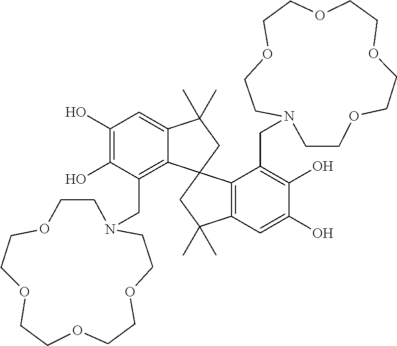 [SMILES: CC1(C)CC2(CC(C)(C)c3cc(O)c(O)c(CN4CCOCCOCCOCCOCC4)c32)c2c1cc(O)c(O)c2CN1CCOCCOCCOCCOCC1]

To a round bottom flask (250 mL) equipped with a magnetic stir bar was added toluene (75 mL), paraformaldehyde (0.22 g, 7.4 mmol), and 1-aza-15-crown-5 (1.63 g, 7.4 mmol). The reaction stirred for 10 min at reflux, at which point 3,3,3′,3′-tetramethyl-1,1′-spirobisindane-5,5′,6,6′-tetraol (1.26 g, 3.7 mmol) was added. A Dean-Stark apparatus was attached and the reaction was stirred at reflux for 40 h. The reaction was concentrated under reduced pressure, followed by purification with silica gel chromatography (methanol-methylene dichloride). The solvent was removed under reduced pressure to vield the product as a beige powder (0.84 g, 28% yield). ¹NMR (CDCl₃, 500 MHz): δ (ppm) 11.84 (br s, 2H), 6.62 (s, 2H), 5.75 (br s, 2H), 3.78-3.42 (br m, 32H), 3.23 (d, 2H, J=14.7), 3.15 (d, 2H, J=14.7), 2.85-2.31 (br m, 8H), 2.24 (d, 2H, J=13.4 Hz), 2.15 (d, 2H, J=13.4 Hz), 1.32 (s, 6H), 1.25 (s, 6H); ¹³C NMR (CDCl₃, 125 MHz): δ (ppm) 145.1, 144.7, 141.9, 138.7, 116.5, 107.0, 70.9, 70.4, 70.3, 69.0 (br s), 67.9 (br s), 57.8, 56.8, 54.1, 54.0-53.4 (br s), 42.8, 33.0, 30.0; HR-MS (ESI) calc. for C₄₃H₆₇N₂O₁₂⁺ 803.4689; found 803.4755.

### Synthesis of Polymer 2a:

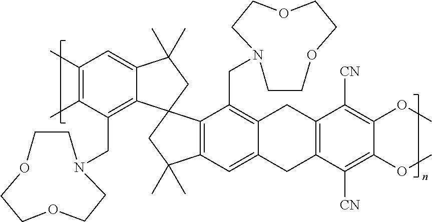

To a round bottom flask (50 mL) equipped with a magnetic stir bar was added monomer 1a (0.72 g, 1.1 mmol), tetrafluoroterephthalonitrile (0.23 g, 1.1 mmol), anhydrous N,N-dimethylformamide (11 mL). After stirring at 65° C.for 5 min to dissolve the monomers, freshly ground potassium carbonate (0.63 g, 4.6 mmol) was then slowly added. A reflux condenser was attached and the mixture stirred for 8 h at 65° C. This was then added to water (100 mL) to precipitate the crude polymer as a yellow solid, which was then isolated by filtration and washed with an additional portion of water (100 mL). The crude polymer was dissolved in tetrahydrofuran (20 mL) at 50° C. and subsequently precipitated into methanol (200 mL) and isolated by filtration. After drying under reduced pressure at 65° C., polymer 2a was isolated as a brown solid (0.58 g) in 68% yield. ¹H NMR (CDCl₃, 500 MHz): δ (ppm) 6.70-6.91 (br s, 2H), 2.66-4.21 (br m, 22H), 0.91-2.59 (br m, 22H), SEC (THF): Mₙ=71.4 kg mol⁻¹, M_{w}=119 kg mol⁻¹, D=1.67.

### Synthesis of Polymer 2b:

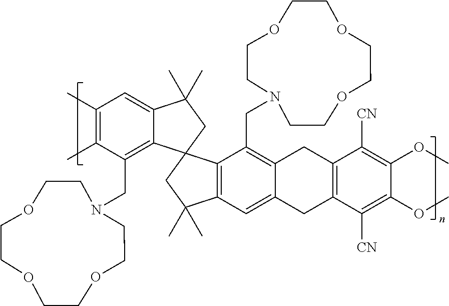

To a round bottom flask (50 mL) equipped with a magnetic stir bar was added monomer 1b (0.54 g, 0.76 mmol), tetrafluoroterephthalonitrile (0.15 g, 0.76 mmol), anhydrous N,N-dimethylformamide (15 mL). After stirring at 65° C.for 5 min to dissolve the monomers, freshly ground potassium carbonate (0.42 g, 3.0 mmol) was then slowly added. A reflux condenser was attached and the mixture stirred for 12 h at 65° C. This was then added to water (200 mL) to precipitate the crude polymer as a yellow solid, which was then isolated by filtration and washed with an additional portion of water (200 mL). The crude polymer was dissolved in tetrahydrofuran (10 mL) at 50° C. and subsequently precipitated into methanol (100 mL) and isolated by filtration. After drying under reduced pressure at 65° C., polymer 2b was isolated as a yellow solid (0.50 g) in 79% yield. ¹H NMR (CDCl₃, 500 MHz): δ (ppm) 6.57-6.96 (br s, 2H), 3.30-3.90 (br m, 24H), 1.68-3.20 (br m, 16H) 0.92-1.51 (br m, 12H), SEC (THF): Mₙ=185 kg mol⁻¹, M_{w}=273 kg mol⁻¹, D=1.48.

### Synthesis of Polymer 2c:

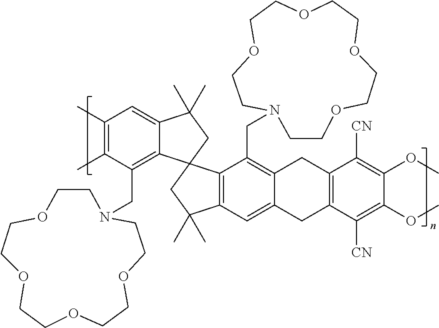

To a round bottom flask (50 mL) equipped with a magnetic stir bar was added monomer 1c (0.84 g, 1.05 mmol), tetrafluoroterephthalonitrile (0.21 g, 1.05 mmol), anhydrous N,N-dimethylformamide (11 mL). After stirring at 65° C. for 5 min to dissolve the monomers, freshly ground potassium carbonate (0.58 g, 4.2 mmol) was then slowly added. A reflux condenser was attached and the mixture stirred for 24 h at 65° C. This was then added to water (100 mL) to precipitate the crude polymer as a yellow solid, which was then isolated by filtration and washed with an additional portion of water (100 mL). The crude polymer was dissolved in tetrahydrofuran (30 mL) at 50° C. and subsequently precipitated into methanol (300 mL) and isolated by filtration. The resulting solid was dissolved in chloroform (10 mL) at 50° C. and subsequently precipitated into methanol (100 mL) and isolated by filtration. After drying under reduced pressure at ambient temperature, polymer 2c was isolated as a yellow solid (0.61 g) in 63% yield. ¹H NMR (CDCl₃, 500 MHz): δ (ppm) 6.64-6.89 (br s, 2H), 2.59-3.98 (br m, 40H), 1.67-2.49 (br m, 8H) 0.89-1.58 (br m, 12H), SEC (THF): Mₙ=333 kg mol⁻¹, M_{w}=424 kg mol⁻¹, D=1.27.

### Example 6

### Preparation and Electrochemical Characterization of Microporous Polymer Membranes with Aza-Crown-Ether Pendants

Electrochemical impedance spectroscopy was conducted on Li|Li symmetric cells prepared using polymer-coated lithium electrodes and electrolyte D as described in Example 1. The resulting Nyquist plots are shown in FIG. 15, where the dots indicates the raw data and the corresponding fit to equivalent circuits are indicated by solid lines. “Aza-9-crown polymer” denotes polymer 2a as described in Example 5. “Aza-12-crown polymer” denotes polymer 2b as described in Example 5. “Aza-15-crown polymer” denotes polymer 2e as described in Example 5. The area specific impedance was then calculated from the resulting Nyquist plot (FIG. 16).

### Example 7

### Preparation and Cycling of Electrochemical Cells Containing Microporous Polymer Membranes with Aza-Crown-Ether Pendants and a Locally Concentrated Electrolyte

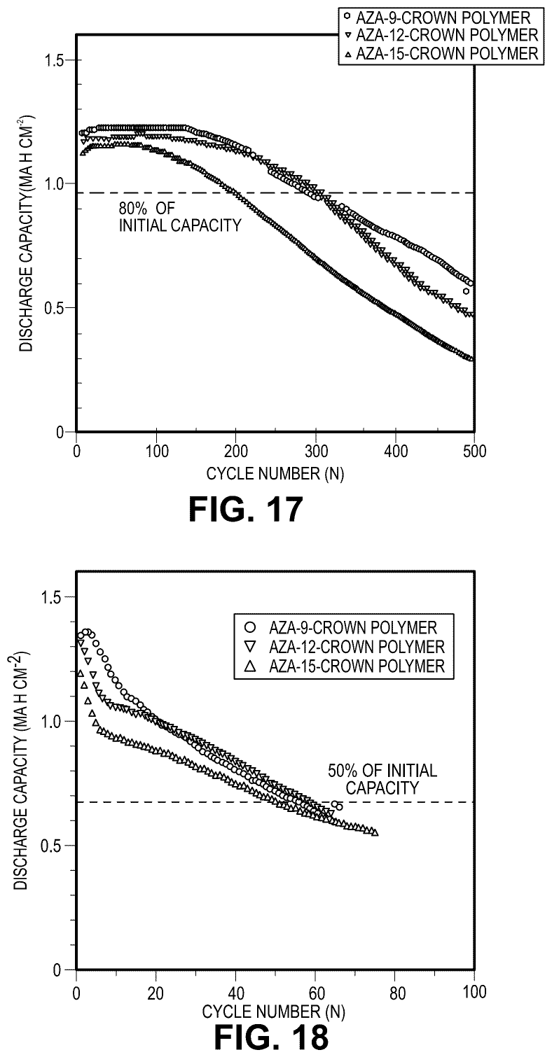

Li|NMC811 electrochemical cells were constructed using locally concentrated electrolyte D as described in Example 1 and microporous polymer membranes with aza-crown-ether pendants (“Aza-9-crown polymer” 2a: “Aza-12-crown polymer” 2b: and “Aza-15-crown polymer” 2c as described in Example 5), which were coated onto the Li metal anode. Cells were cycled using a 3.0 mA cm⁻² charge/discharge protocol with a 4.2 V upper cutoff voltage and 3 V lower cutoff voltage. All cells cycled an areal capacity greater than 1.0 mA h cm⁻2, or nearly 1.0 mA h cm⁻², through 100 cycles (FIG. 17). The cycle life of these cells (defined as the number of cycles before the discharge capacity drops below 80% of the initial) were approximately 150, 100, and 150 cycles for cells with Aza-9-crown polymer membrane, Aza-12-crown polymer membrane, and Aza-15-crown polymer membrane. respectively

### Example 8

### Preparation and Cycling of Anode-Less Electrochemical Cells Containing Microporous Polymer Membranes with Aza-Crown-Ether Pendants and a Locally Concentrated Electrolyte

Cu|NMC622 electrochemical cells was constructed using locally concentrated electrolyte D as described in Example 1 and microporous polymer membranes with aza-crown-ether pendants (“Aza-9-crown polymer” 2a; “Aza-12-crown polymer” 2b; and “Aza-15-crown polymer” 2c as described in Example 5). Cells were cycled using a 1.0 mA cm⁻² charge/3.0 mA cm⁻² discharge protocol with a 4.3 V upper cutoff voltage and 3 V lower cutoff voltage. The cells containing the aza-9-crown polymer membrane or aza-12-crown polymer membrane reversibly cycled an arcal capacity greater than 1.0 mA h cm⁻² for approximately 20 cycles (FIG. 18). The cell containing Aza-12-crown polymer membrane did not reversibly cycle 1.0 mA h cm⁻². The cycle life of these cells (defined as the number of cycles before the discharge capacity drops below 50% of the initial) were approximately 60, 50, and 600 cycles for cells with Aza-9-crown polymer membrane, Aza-12-crown polymer membrane, Aza-15-crown polymer membrane, respectively.

### Example 9

### Preparation of Locally Concentrated Electrolytes and Measurements of Viscosity and Ionic Conductivity

Locally super concentrated electrolytes (LSCEs) 1-9, which feature a 1:2:x ratio of [LiFSI]:[DME]:[TTE] were prepared as summarized in the table below. The properties of this LSCE series were compared to a super-concentrated electrolyte (SCE) containing a 1:2 ratio of [LiFSI]:[DME] as a positive control, as well as to a commercially available dilute electrolyte (DE) containing 1 M LiPF₆ in ethylene carbonate/dimethyl carbonate (1:1 by weight) as a negative control.

| | Molar ratio | | |
|---|---|---|---|
| Electrolyte | LiFSI | DME | TTE |
| LSCE 1 | 1.0 | 2.0 | 3.6 |
| LSCE 2 | 1.0 | 2.0 | 3.2 |
| LSCE 3 | 1.0 | 2.0 | 2.8 |
| LSCE 4 | 1.0 | 2.0 | 2.4 |
| LSCE 5 | 1.0 | 2.0 | 2.0 |
| LSCE 6 | 1.0 | 2.0 | 1.6 |
| LSCE 7 | 1.0 | 2.0 | 1.2 |
| LSCE 8 | 1.0 | 2.0 | 0.8 |
| LSCE 9 | 1.0 | 2.0 | 0.4 |

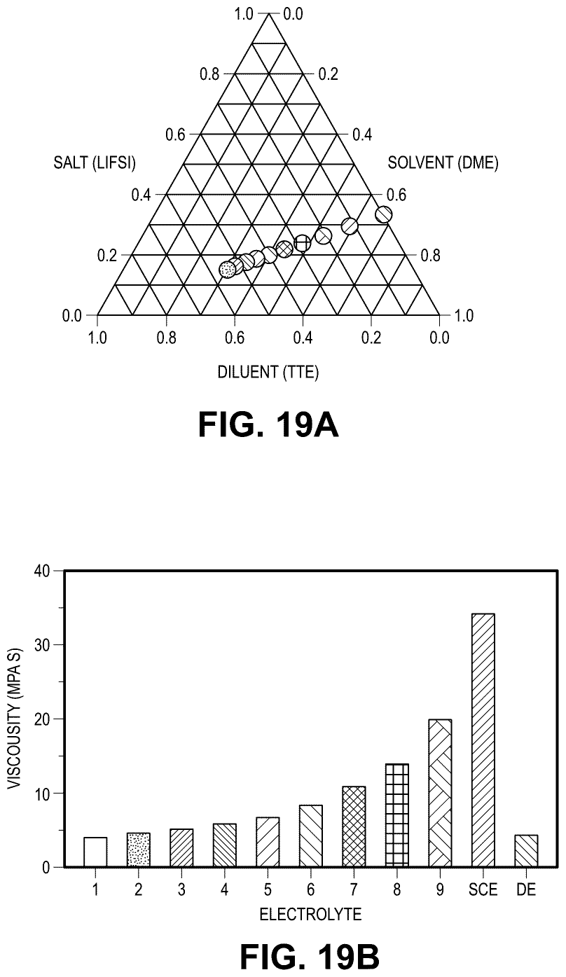

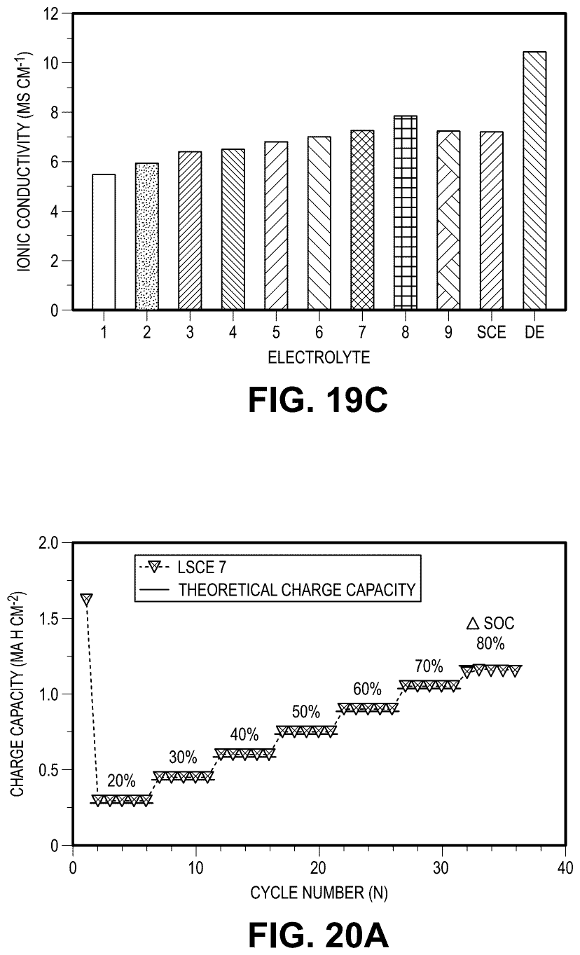

FIG. 19 shows (a) Temary diagram showing the molar ratios of LiFSI, DME and TTE investigated in this study. (b) Electrolyte viscosity measured at T=21.2-22.5° C. (c) Electrolyte ionic conductivity measured at T=24.9-25.6° C.

Dilute electrolytes rely on ion solvation with the maximum possible coordination number to facilitate ion-separation, which often ensures high mobility for ionic charge carriers. This is more challenging to realize with concentrated electrolytes, where mobility is compromised by changes to the mobile ion-solvation environment, including changes to the coordination number and speciation with respect to ion-pairing, clustering, and networking. Non-coordinating diluents can be useful in de-networking various ionic species into smaller clusters that exhibit higher mobility. This behavior is generally concurrent with substantial changes in viscosity due to the reduced prevalence of networking interactions. The degree to which a non-coordinating diluent triggers such changes in the electrolyte is therefore important.

These phenomena are evidenced in the magnitude of change in viscosity with increasing molar ratio relative to the SCE (FIG. 19B). At the highest dilution, the viscosity of LSCE 1 was 4.09 mPa·s, the lowest observed in this series. With decreasing TTE content in formulations 2-8, a corresponding increase in viscosity was observed. However, there was a sizeable rise beginning in formulations 8 and 9, along the trajectory to the SCE, which contains no TTE. These data for viscosity were compared to that for the DE, which has a viscosity of 4.15 mPa·s. Without wishing to be bound by any particular theory, electrolytes with diluent content of x=0.4-1.2 are believed to maximize ion mobility (evidenced in the viscosity data as proxy) through the de-networking of ions into clusters. while maintaining a high fraction of mobile ionic charge carriers (evidenced in the ionic conductivity data as proxy) reminiscent of the SCE.

The ionic conductivity, i.e., the product of ionic charge carrier concentration and mobility, was measured for LSCEs 1-9 and both controls (FIG. 1c). A monotonic increase in ionic conductivity with decreasing molar ratio of diluent was observed for LSCEs 1-8, up to 7.84 mS cm⁻¹. For electrolyte 9. however, a slight downturn to 7.25 mS cm⁻¹ was observed. As the ionic conductivity of the SCE was 7.16 mS cm⁻¹. LSCEs 7-9 are particularly competitive for providing fast-charge outcomes in Li|NMC622 cells and other electrochemical cells. Notably, the negative control DE had the highest ionic conductivity of any in the series tested (10.40 mS cm⁻¹).

### Example 10

### Fast-Charge Rate Performance of Electrolytes in Li|NMC622 Coin Cells

Following the initial characterization of bulk electrolyte properties described in Example 9, a screen for identifying promising electrolytes for fast-charge and ultrafast-charge applications was developed. Here, charging to 80% SOC in 15 min from a pre-determined SOC of Y % (Y=60, 50, 40, 30, 20, 10, 0) was attempted; the tests were repeated 5 times to discem variation between cycles, even if preliminary. The starting point for each of these tests was accessed at an EV-relevant discharge rate of C/3, corresponding to a current density of 0.5 mA cm⁻². In this way, the charge current density necessarily scales with the imposed target for change in SOC (ΔSOC). For the NMC622 cathode employed in the screen, an 80% ΔSOC in 15 min would require a current density of 4.8 mA cm⁻². To interpret the data, one then quantifies the degree to which Li|NMC622 cells assembled with certain electrolytes access the theoretical capacity before hitting the cutoff voltage, which in these screens was sct to 4.2 V vs. Li/Li⁺.

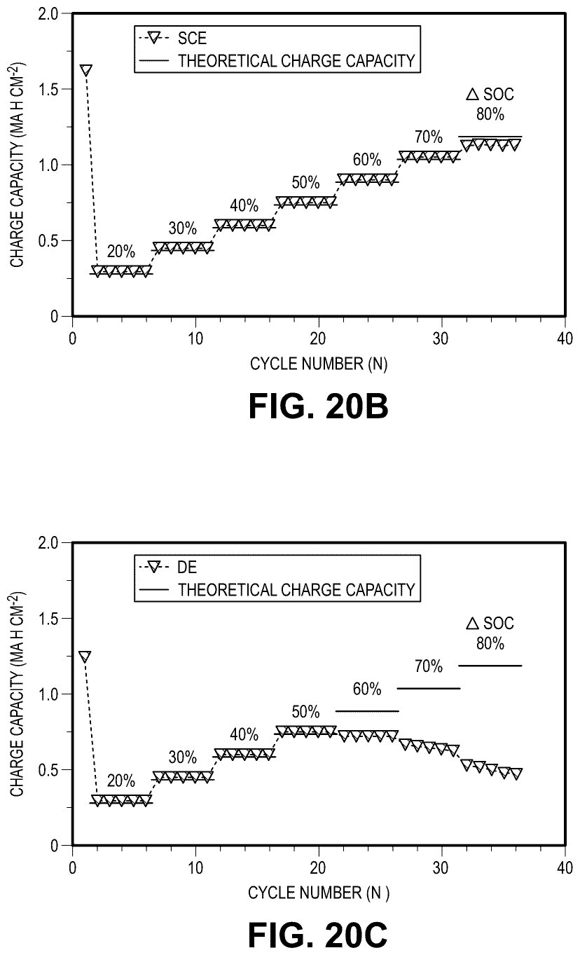

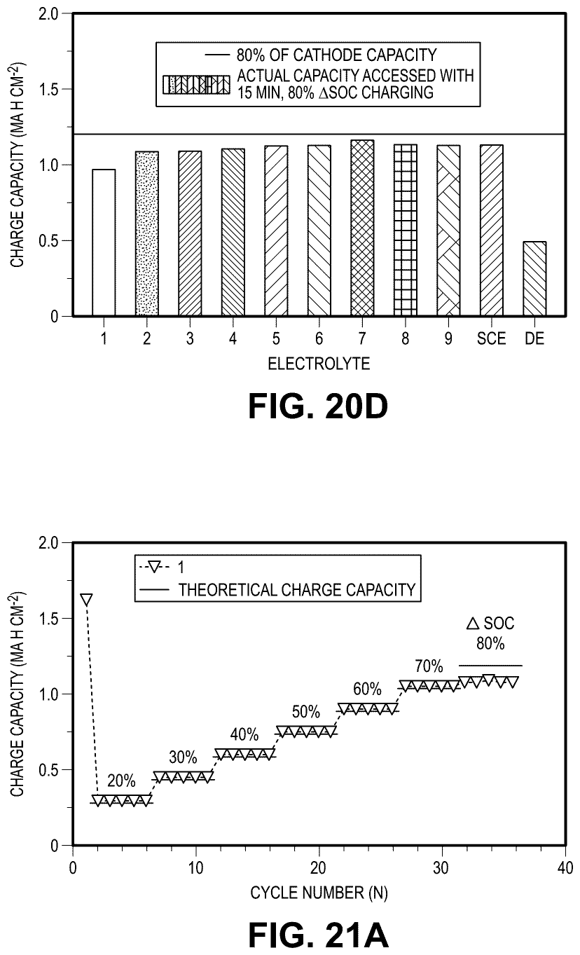

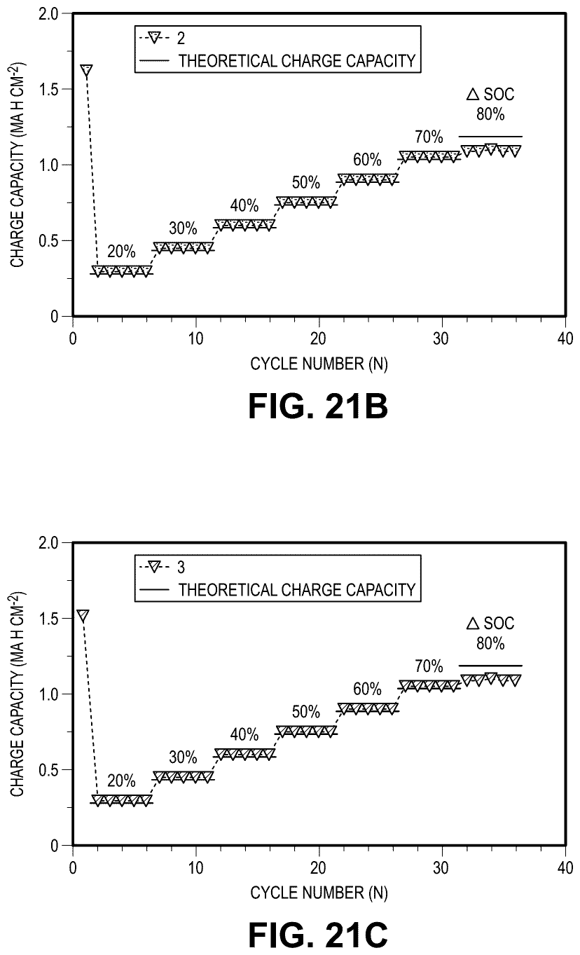

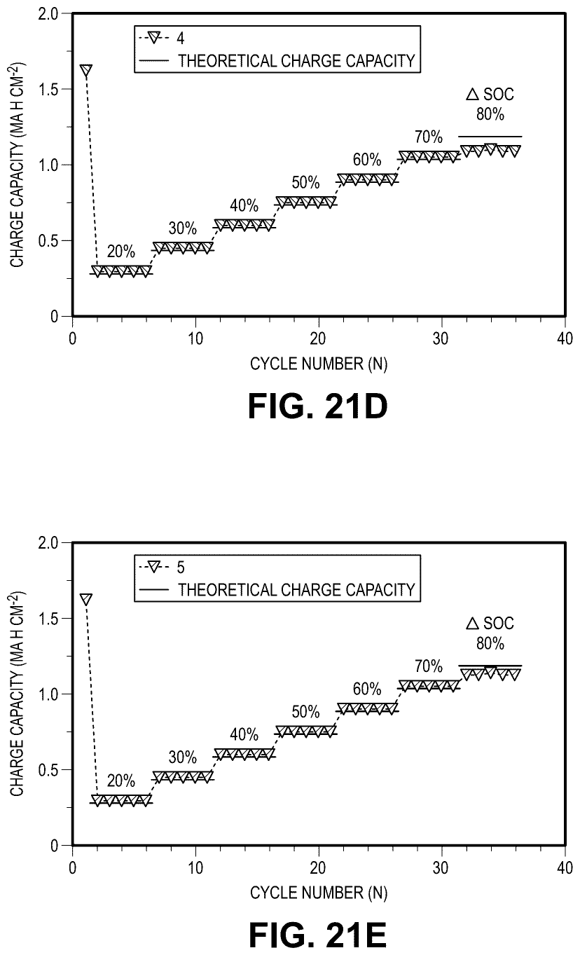

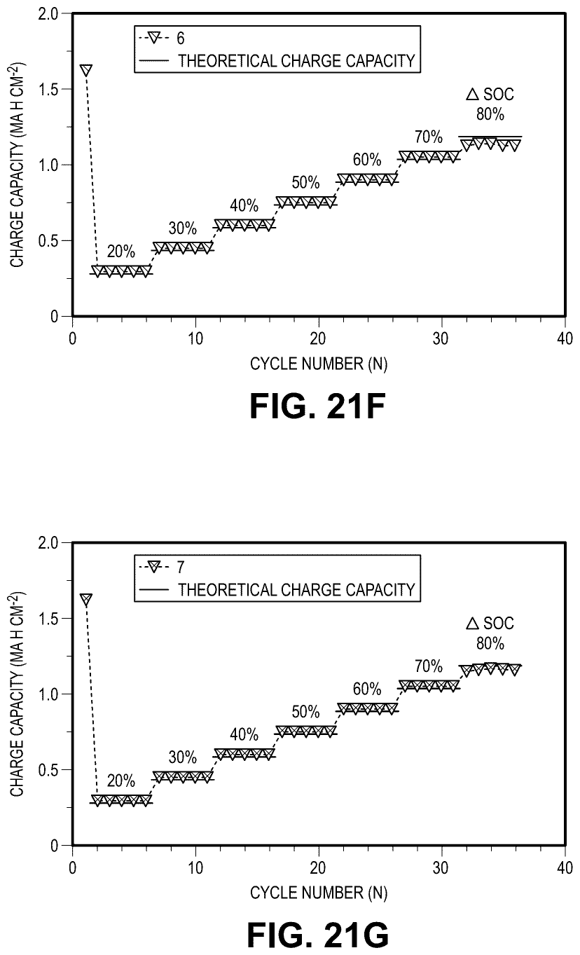

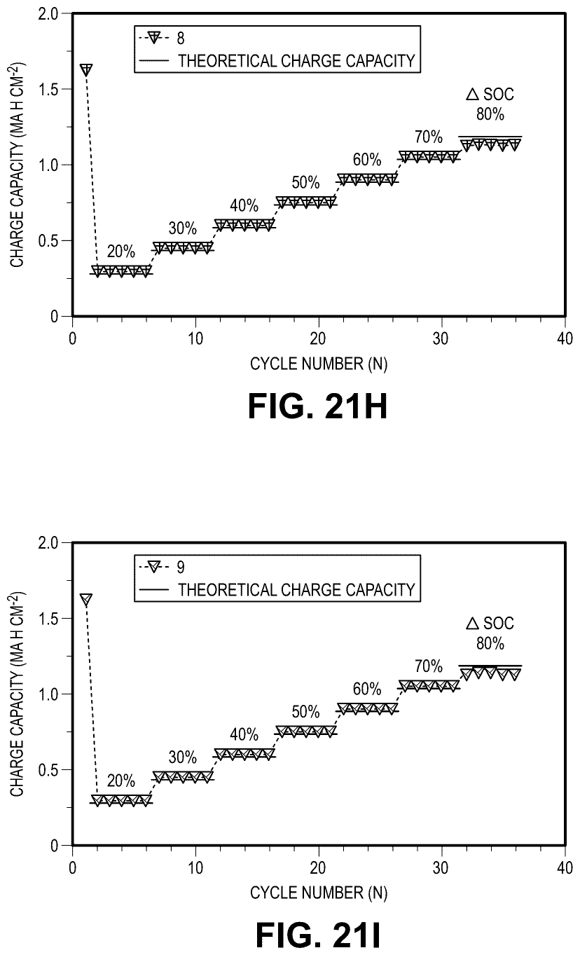

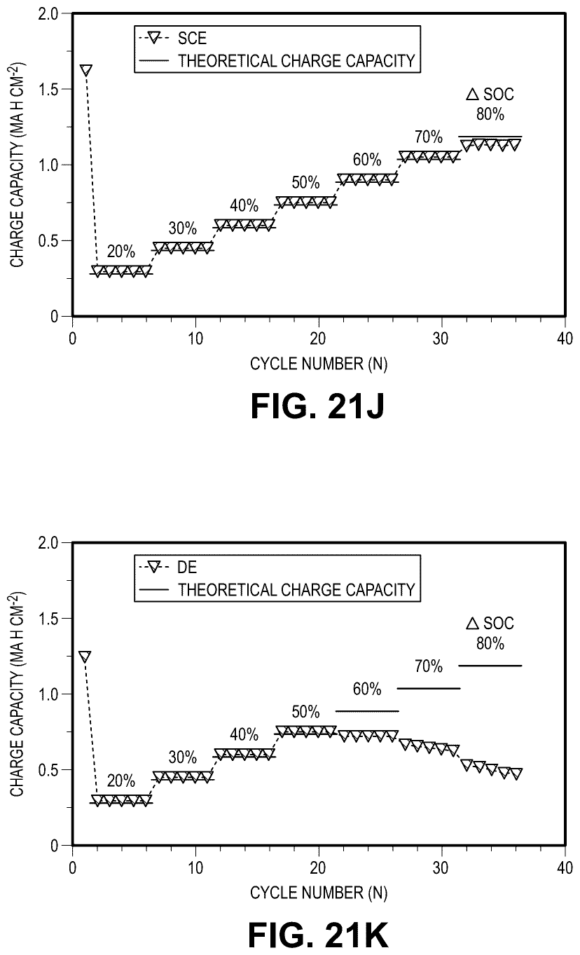

Li|NMC622 electrochemical cells were constructed using 1.5 mA h cm⁻² NMC622 and electrolytes LSCE 1, LSCE 2, LSCE 3, LSCE 4, LSCE 5, LSCE 6, LSCE 7, LSCE 8, LSCE 9, SCE, or DE from Example 9. The charge current density was selected to pass the theoretical charge capacity (brown line) in 15 min, while the discharge current density was held at 0.5 mA cm⁻² throughout the test (i.e., C/3). The theoretical charge capacities are also labeled with the expected percent change in state-of-charge (ΔSOC) after charging. FIG. 20 shows the charge capacity accessed in each cycle for electrolytes: (a) LSCE 7; (b) SCE; and (c) DE. Charge capacity accessed in the final step of the rate test for LSCE 1-9, SCE, and DE is shown in panel (d). FIG. 21 shows the charge capacity accessed in each cycle for electrolytes: (a) LSCE 1; (b) LSCE 2; (c) LSCE 3; (d) LSCE 4; (c) LSCE 5; (f) LSCE 6; (g) LSCE 7; (h) LSCE 8; (i) LSCE 9; (j) SCE; (k) DE.

LSCE 7 (FIG. 20A), which employs a [LiFSI]:[DME]: [TTE] ratio of 1:2:1.2, was the top-performing, passing 96.6% of the theoretical capacity through the cell over the imposed 15-min timeframe (FIG. 20D). For comparison, SCE (FIG. 20B) passed 93.7% of the theoretical capacity through the cell over when attempting a 15-min fast charge at the same current density. This result, in part, confirms that electrolytes with higher ionic conductivity can be beneficial for fast-charge; however, results recorded for the DE (FIG. 20C) represent a clear exception. Specifically, while DE has the highest ionic conductivity, it is the most limited in fast-charge performance. Based on this fast-charge screen. LSCE 7 was carried forward in full-cell and asymmetric-cell cycling, in addition to SCE and DE as positive and negative controls.

### Example 11

### Fast-Charge Cycling Performance of Electrolytes in Li|NMC622 Coin Cells

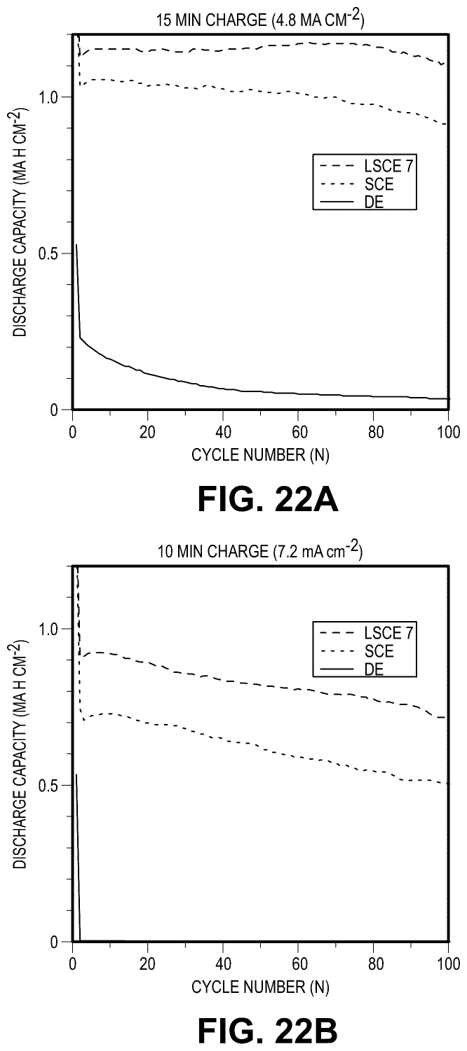

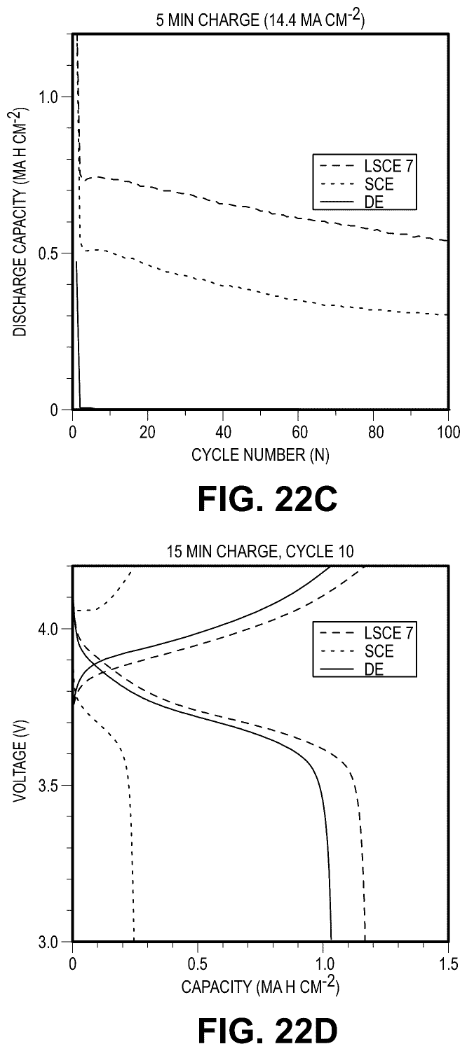

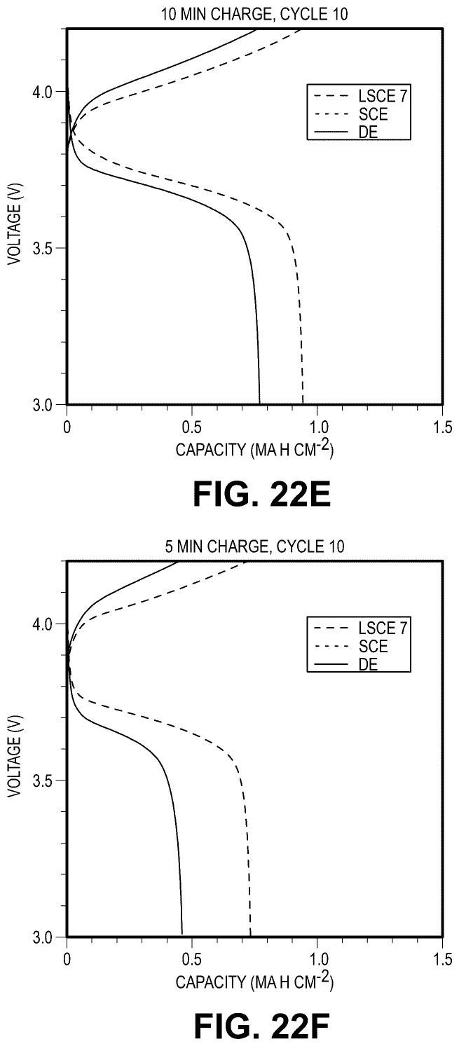

Li|NMC622 electrochemical cells were constructed using 1.5 mA h cm⁻² NMC622 and electrolytes LSCE 7, SCE, or DE from Example 9. Cells cycled with discharge current density of 0.5 mA cm⁻² and a charge current density matched to deliver 80% ΔSOC in the allotted time. Cutoff voltages of 4.2 V/3.0 V were employed. FIG. 22 shows discharge capacity vs cycle number plotted for (a) 15-min charge (4.8 mA cm⁻²). (b) 10-min charge (7.2 mA cm⁻²), and (c) 5-min charge (14.4 mA cm⁻²), where the dark line indicates the average of three replicates and the shaded region indicates the standard deviation of the replicates. Charge-discharge curves for the 10^{th} cycle are plotted for (d) 15-min charge, (d) 10-min charge, and (e) 5-min charge.

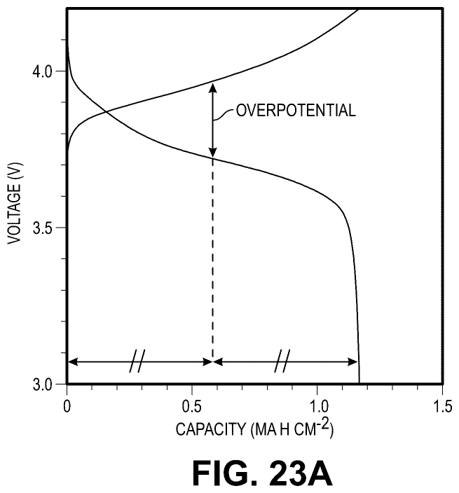

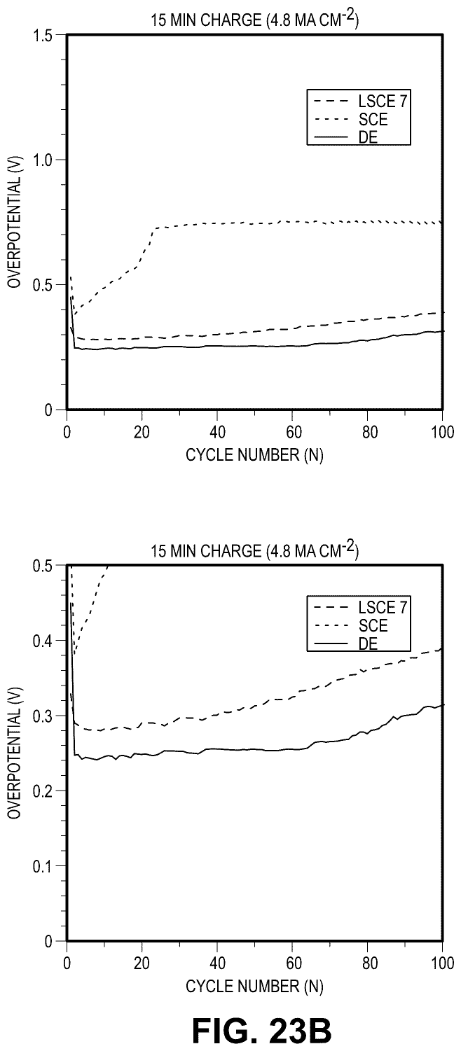

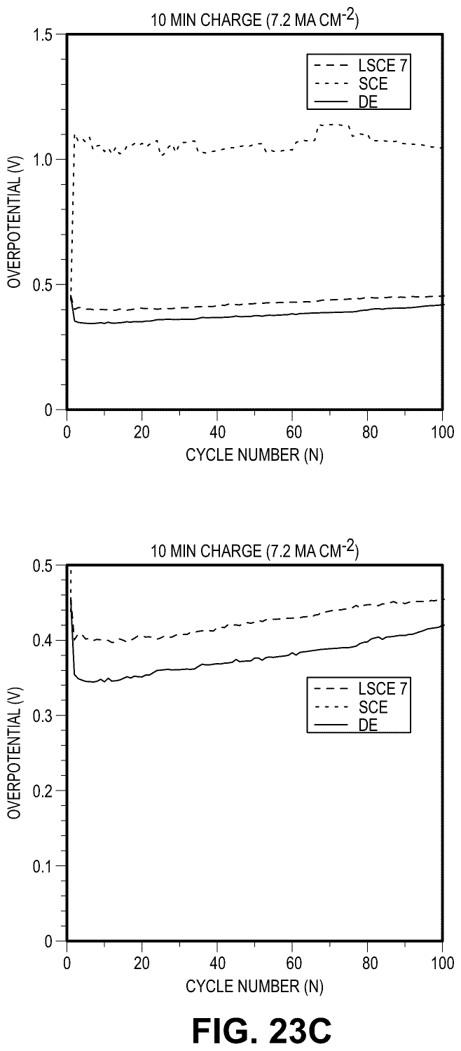

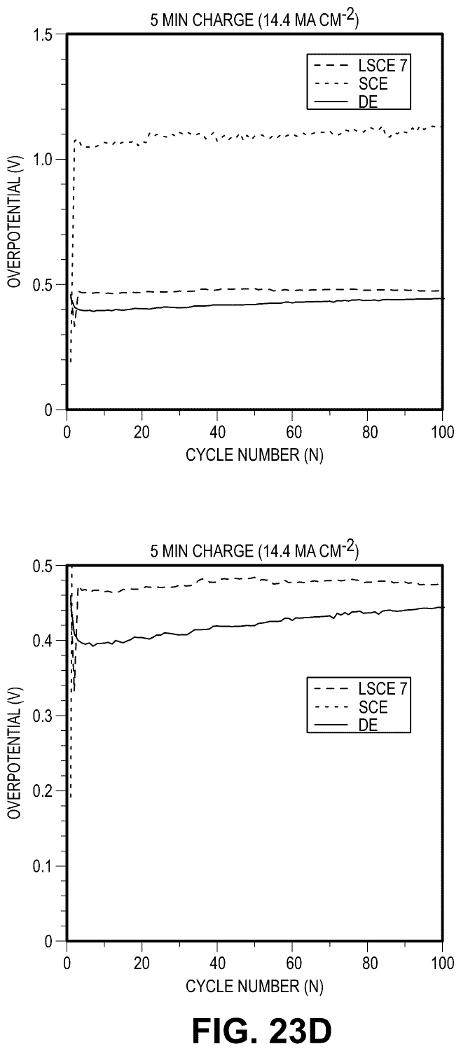

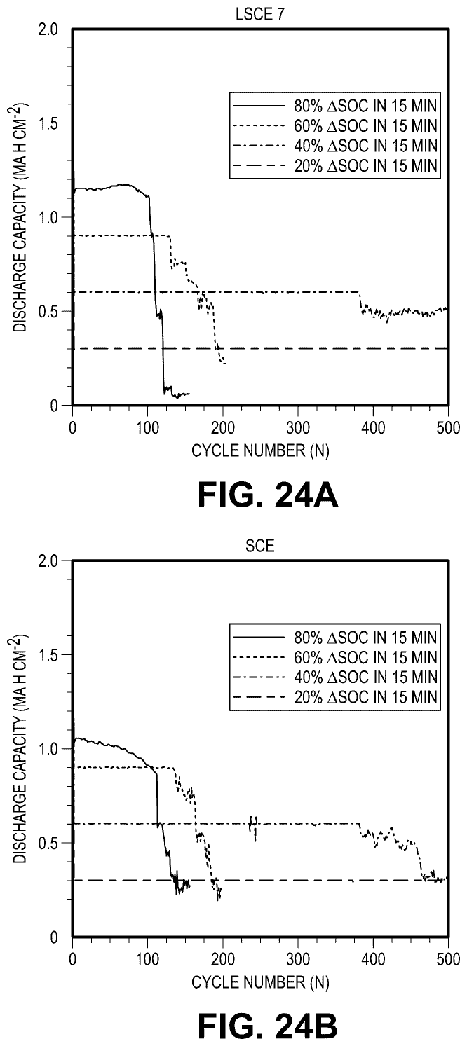

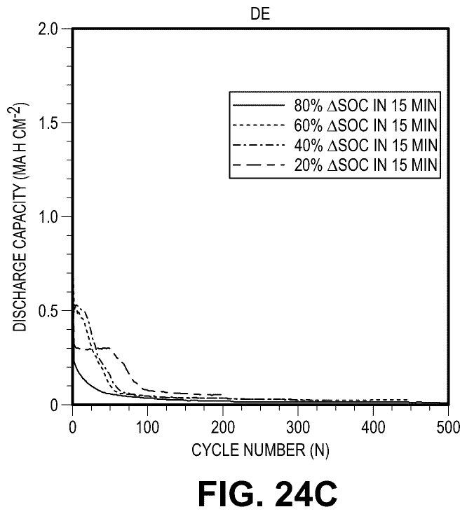

FIG. 23 shows the corresponding cycling overpotentials, depicting (a) scheme for calculating overpotentials from charge discharge curves. (b) 15-min charge (4.8 mA cm⁻²), (c) 10-min charge (7.2 mA cm⁻²), and (d) 5-min charge (14.4 mA cm⁻²), where the dark line indicates the average of three replicates and the shaded region indicates the standard deviation of the replicates. Alternatively, cells were cycled with a discharge current density of 0.5 mA cm⁻² and a charge current density matched to deliver X % ΔSOC (X=20, 40, 60, or 80) in 15 minutes. FIG. 24 shows discharge capacity vs cycle number plotted for (a) LSCE 7 (b) SCE and (c) DE, where the dark line indicates the average of three replicates and the shaded region indicates the standard deviation of the replicates.

Data shown in FIG. 22A-C shows discharge capacity plotted vs. cycle number, where the solid line indicates the average discharge capacity of three replicates and the shaded region surrounding the line represents the standard deviation of those replicates. When targeting 80% ΔSOC in 15 min (FIG. 22A), LSCE 7 reversibly accessed 8-13% more capacity than SCE, and 70-98% more capacity than DE at cycle 10, maintaining a similar trend over 100 cycles. This trend reflects the relative ordering of plating overpotentials; at cycle 10 the overpotentials were 244 mV for LSCE 7, 280 mV for SCE, and 488 mV for DE (FIG. 23B).

When targeting 80% ΔSOC in 10 min (FIG. 22B), less capacity was accessed across all electrolytes, owing to the 42-43% larger plating overpotential induced by the high current density (FIG. 23C). However, LSCE 7 continued to showcase its advantages, allowing 3-28% more capacity to be accessed than SCE; cells with DE were unable to complete a single cycle with super-fast-charging. Finally, when targeting 80% ΔSOC in 5 min (FIG. 22C), the downward trend in accessible capacity continued, concurrent with rapid rises in charging overpotential, which was 62-66% larger than the overpotentials observed with 15-minute charging times (FIG. 23D). Despite these challenges, LSCE 7 allowed for 12-26% more capacity to be accessed than SCE; as was observed for super-fast-charging, cells with DE were unable to recharge in the ultra-fast-charge regime. Thus, LSCE 7 reproducibly lowered the charge overpotential relative to SCE and DE. Remarkably, this effect was amplified at higher current density. with overpotential difference between LSCE 7 and SCE increasing from 36 mV with fast-charge, to 54 mV with super-fast-charge, or 69 mV with ultra-fast-charge. As a result, cells employing LSCE 7 reproducibly accessed 8-13% higher capacity than SCE with fast-charge, 3-28% higher capacity with super-fast-charge, and 12-26% higher capacity with ultra-fast-charge.

Having observed the effects of an LSCE on lowering the overpotential, which manifest in improved capacity retention during fast-charging and ultrafast-charging from deep discharge, the ability of the LSCE to extend cycle life when a smaller fraction of the cathode capacity is reversibly cycled with fast-charging was considered. Li|NMC622 coin cells were cycled, using a charge current density matched to charge to 80% SOC in 15 min from a pre-determined SOC of Z % (Y=60, 40, 20, 0), corresponding to 1.2, 2.4, 3.6 or 4.8 mA cm⁻², respectively, while discharging at 0.5 mA cm⁻². Data in FIG. 24A-C shows the discharge capacity is plotted vs. cycle number, where the solid line indicates the average discharge capacity of three replicates and the shaded region surrounding the line represents the standard deviation of the replicates. LSCE 7 and SCE repeatedly cycled 80% ΔSOC for ˜100 cycles before rapid capacity fade, while DE could not reversibly cycle. LSCE 7 and SCE repeatedly cycled 60% ΔSOC for 120-150 cycles before capacity fade, while DE again could not charge the theoretical capacity. LSCE 7 repeatedly cycled 40% ΔSOC>380 cycles before capacity loss (one replicate showed precipitous capacity drop at cycle 380, while the other two completed 500 cycles). SCE showed similar results for cycling 40% ΔSOC, while DE lasted ˜20 cycles before capacity decline. LSCE 7 and SCE repeatedly cycled 20% ΔSOC for 500 cycles without any indication of capacity loss, at which point the experiment was stopped, while DE repeatedly cycled 20% ΔSOC for 50-75 cycles before capacity declined. It was concluded that LSCE 7 and SCE demonstrate comparable cycle life for any ΔSOC that is cycled using a fast charge protocol, with the LSCE offering consistently higher capacity on charge regardless of the current density, but especially at the high current densities typified by ultra-fast-charge. On the other hand, the DE was incapable of cycling a 60 or 80% ΔSOC with fast-charge or ultrafast-charge, whereas less demanding protocols secking a 20 or 40% ΔSOC were marginally successful, typically with less than 100 cycles observed before failure.

### Example 12

### Lithium Consumption Rate (LCR) Determination for Electrolytes LSCE 7, SCE, and DE in Li|Cu Coin Cells

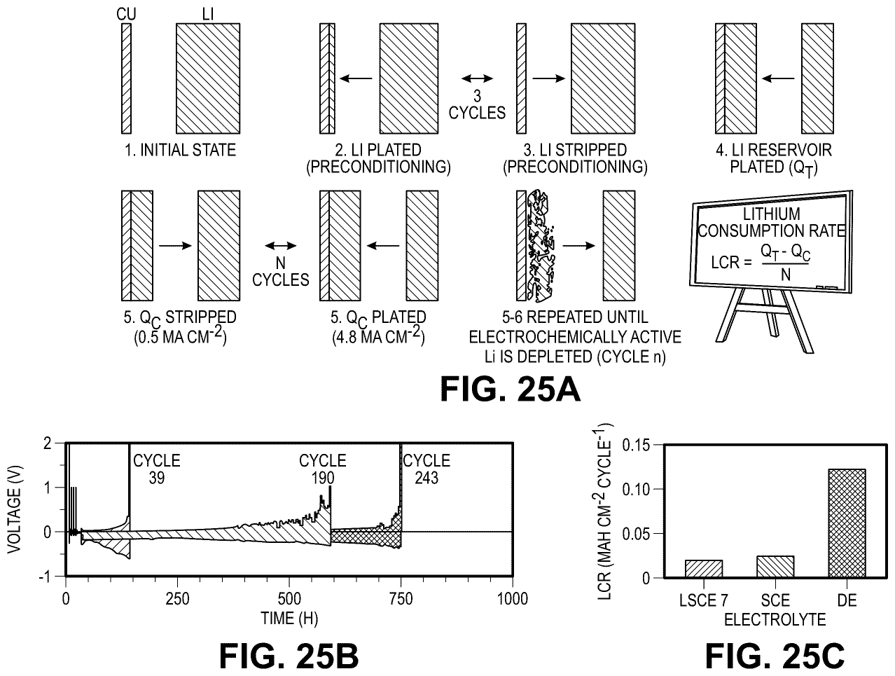

Li|Cu electrochemical cells were constructed using copper foil and electrolytes LSCE 7, SCE, or DE from Example 9. In FIG. 25, panel (a) is a schematic for the experiment, depicting Cu preconditioning, Li reservoir deposition, repeated plating/stripping with a protocol that mimics fast-charging in 15 minutes, and the equation used to calculate LCR. The voltage profile for LSCE 7, SCE, and DE is shown in (b), where the >1 V voltage spike is reached during the stripping step, indicating Li depletion, is noted. Panel (c) shows the calculated LCR for LSCE 7, SCE, and DE.

An investigation of potential mechanisms for capacity loss was conducted, focusing on capacity loss at the anode resulting from fast-charging. Without wishing to be bound by any particular theory, it is believed that fast Li plating could produce ramified deposits that can disconnect from the current collector at EV-relevant discharge rates or, alternatively, react with electrolyte. To investigate capacity fade originating from anode degradation, the Li consumption rate (LCR) was determined by repeatedly stripping and plating Li from a pre-defined reservoir. Inefficiencies in plating and stripping cause the reservoir to become depleted over time, which was evidenced by a voltage spike while stripping Li. This method accounted for Li consumption across a typical lifespan of a thin Li anode, which can reach hundreds of cycles and several hundred hours. Rates of Li loss could change at different stages of anode health, owing to changes in Li morphology upon repeated fast-charge cycling. This method contrasts more conventional determinations of Coulombic efficiency, which strip and plate Li from a reservoir 20 times or fewer before concluding the test. Such short term methods could generate artificially high efficiency values at early stages of cycle. Alternatively, longer measurements of Li consumption account for periods of accelerated rates of Li loss, so the average rate is reflective of the actual behavior and thereby a more reliable predictor of full cells cycled under same conditions.

To carry out these experiments, coin cells with a Li metal anode and bare Cu current collector were assembled. Li|Cu cells were first cycled 3 times, plating and stripping 1.2 mAh cm⁻² of Li onto Cu to precondition the Cu surface, before depositing a 6 mAh cm⁻² Li reservoir (FIG. 25A). Then cells repeatedly cycled 1.2 mAh cm⁻², stripping Li at 0.5 mA cm⁻² and plating at 4.8 mA cm⁻² to mimic the current densities used in 80% ΔSOC cycling with 15 min charge. As shown in FIG. 25B, LSCE 7, SCE, and DE lasted 243, 190, and 39 cycles, respectively, before a voltage spike to ≥1 V, indicating depletion of the Li reservoir. The LCR for each electrolyte was then calculated using LCR=Q_{T}−Q_{C}/n, where Q_{T} is the capacity of the Li reservoir, Q_{C} is the capacity of Li plated and stripped in each cycle, and n is the number of cycles completed before a voltage spike to 1 V is observed during the strip step. The calculated LCRs are plotted in FIG. 25C. Electrolytes LSCE 7 and SCE showed LCRs of 0.020 and 0.025 mAh cm⁻² cycle⁻¹, respectively. Electrolyte DE showed a substantially larger LCR of 0.123 mAh cm⁻² cycle⁻¹.

### Example 13

### Scanning Electron Microscopy Images of Li Anodes Before and After Electrodeposition

With a quantitative framework for gradual lithium consumption in symmetric cells in place, mechanisms of anode-driven capacity depletion were then considered so as to relate the calculated LCRs to Li|NMC full cell performance. Capacity drop in fast-charging lithium batteries can result from loss of anode material, loss of cathode material, resistance buildup on interphase(s), electrolyte depletion, or partial short-circuiting (“soft-shorts”), which can be considered loss of both anode and cathode material. While the LCR determination to quantitate anode material depletion under fast-charge conditions qualitatively agreed with the observed trend in Li|NMC full cell performance, back-calculations from the measured LCRs consistently overpredicted cycle life. suggesting that Li depletion is only partially responsible for battery failure. This could contribute to capacity fade through the proposed “dead Li” mechanism in which Li becomes disconnected from the current collector as a result of repeated of fast-charge cycling.

Briefly, Li plating at a high current density leads to the concentration of Li ions in solution (i.e., [Li⁺]) near the electrode to approach zero. Li electrodeposits grow fastest in regions with high [Lit], causing minor protrusions to seed ramified or mossy deposits. Upon subsequent stripping at low current density, Li protrusions have been shown to strip close to the protrusion site, leaving behind Li metal that is disconnected from the electrode. This Li is thought to be electrochemically inactive, or “dead”; although recent work has suggested it may be retrievable under certain circumstances (sec. e.g., Liu. et al. Nature 2021, 600, 659-663). Nevertheless, loss of the lithium inventory at the anode is likely to occur quickly when Li deposits as a mossy morphology. rather than dense or globular and will impact the capacity retention of the cell as more of it is lost.

While the dead Li mechanism for capacity loss is likely operative in the fast-charge and ultrafast-charge conditions tested, it may occur in tandem with resistance buildup in full cells. In particular. the Li|NMC full cell results with fast-, super-fast-, and ultra-fast-charge (FIG. 22) revealed that plating overpotentials inversely correlated with accessible capacity, owing to cells reaching the cutoff voltage prematurely. The differences in plating overpotentials is partially explained by bulk ion transport properties, such as concentration, viscosity, and ion-clustering effects, but it is noted that the overpotential rose over the cycle life of the cell, which is not accounted for by bulk transport or the dead Li mechanism.

Instead, it is hypothesized here that electrolyte reactivity at Li could be responsible for generation of resistive interphases or depletion of electrolyte components, both of which could contribute to the total cell resistance and increase the fast charge overpotential. If this were the case. electrodeposits from LSCE 7 would have a low surface area and be globular, deposits from SCE would be similar in morphology with slightly higher surface area, and Li deposits from DE would be substantially higher in surface area.

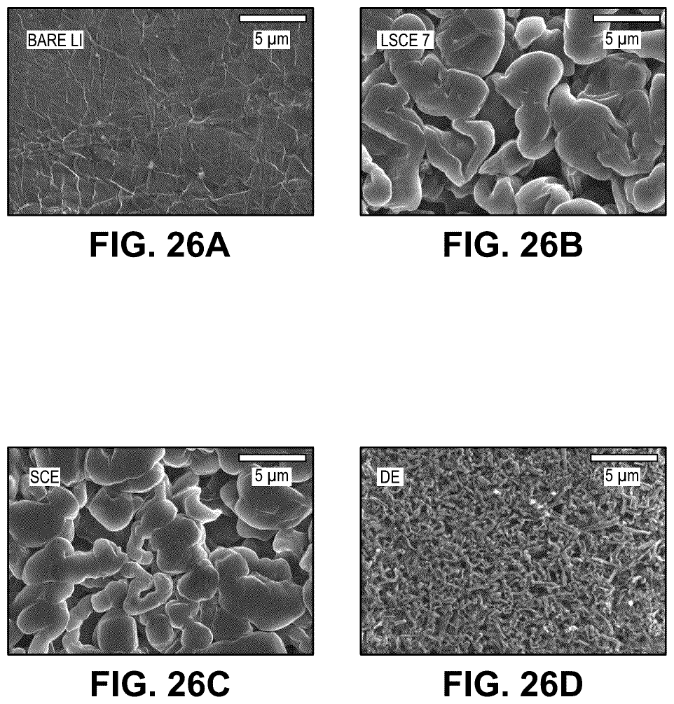

Li|Li electrochemical cells were constructed using electrolytes LSCE 7, SCE, or DE from Example 9. FIG. 26 shows (a) bare Li, and Li deposited from electrolyte (a) LSCE 7, (b) SCE, and (c) DE. Electrodes were obtained from Li|Li coin cells after 10 fast-charge relevant asymmetric strip-plate cycles: 0.5 mA cm⁻² strip, 4.8 mA cm⁻² plate.

To understand differences in the plating morphology of Li metal, scanning electron microscopy (SEM) was employed (FIG. 26A-D). Prior to analysis, Li|Li symmetric cells were cycled 10 times, stripping 1.2 mA h cm⁻² at 0.5 mA cm⁻² and replating at 4.8 mA cm⁻². The resulting Li morphology with LSCE 7 was dense and globular, with a low surface area of exposed Li. The electrodeposit size decreased slightly for SCE, but was likewise relatively dense. For DE, on the other hand, the Li electrodeposits were mossy and the surface area was high. Without wishing to be bound by any particularly theory it is noted that exposed Li surface area and LCR follow the trend of LSCE 7<SCE<DE, suggesting that loss of active Li is a consequence of morphology. Furthermore, this trend aligns with the observed full cell performance, consistent with overpotential rise as a consequence of Li surface area, through a mechanism that simultaneously generates interphases at the anode and depletes electrolyte components. This may occur in tandem with the conventional dead Li mechanism to slowly reduce the working capacity of the cell.

### Example 14

### Preparation and Cycling of Electrochemical Cells Employing Locally Concentrated Electrolytes Optionally Containing Two Lithium Salts

Li|NMC811 electrochemical cells were constructed using locally concentrated electrolytes with one or two lithium salts, the components of which are summarized in the follow table.

| | LiFSI | Lithium Salt | DME | TTE |
|---|---|---|---|---|
| F100 | 1.0 | — | 2.0 | 1.2 |
| FD91 | 0.9 | lithium difluoro(oxalate)borate | 2.0 | 1.2 |
| | | 0.1 | | |
| FC91 | 0.9 | lithium perchlorate | 2.0 | 1.2 |
| | | 0.1 | | |
| FB91 | 0.9 | lithium tetrafluoroborate | 2.0 | 1.2 |
| | | 0.1 | | |
| FO91 | 0.9 | lithium trifluoromethanesulfonate | 2.0 | 1.2 |
| | | 0.1 | | |
| FP91 | 0.9 | lithium hexafluorophosphate | 2.0 | 1.2 |
| | | 0.1 | | |
| FT91 | 0.9 | lithium | 2.0 | 1.2 |
| | | bis(trifluoromethanesulfonyl)imide | | |
| | | 0.1 | | |

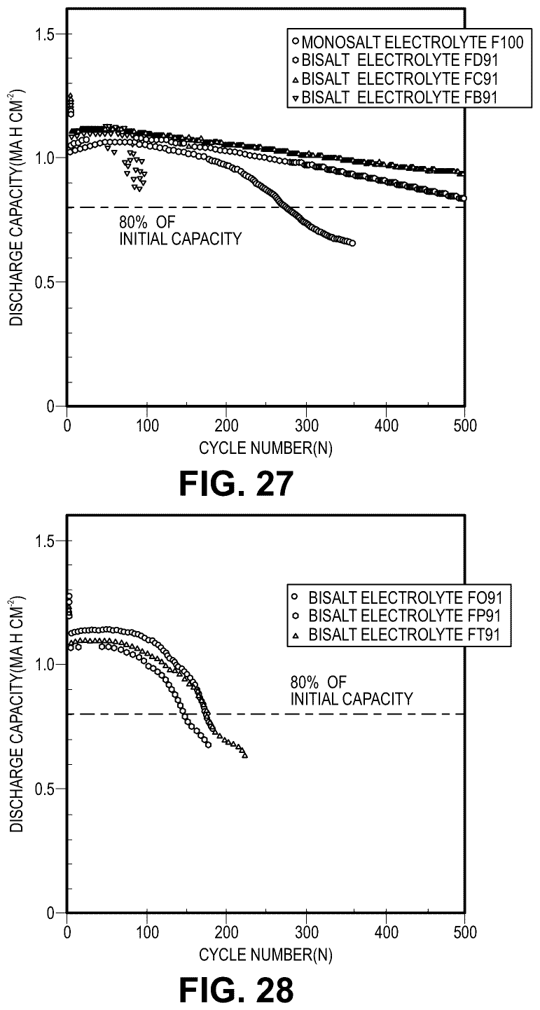

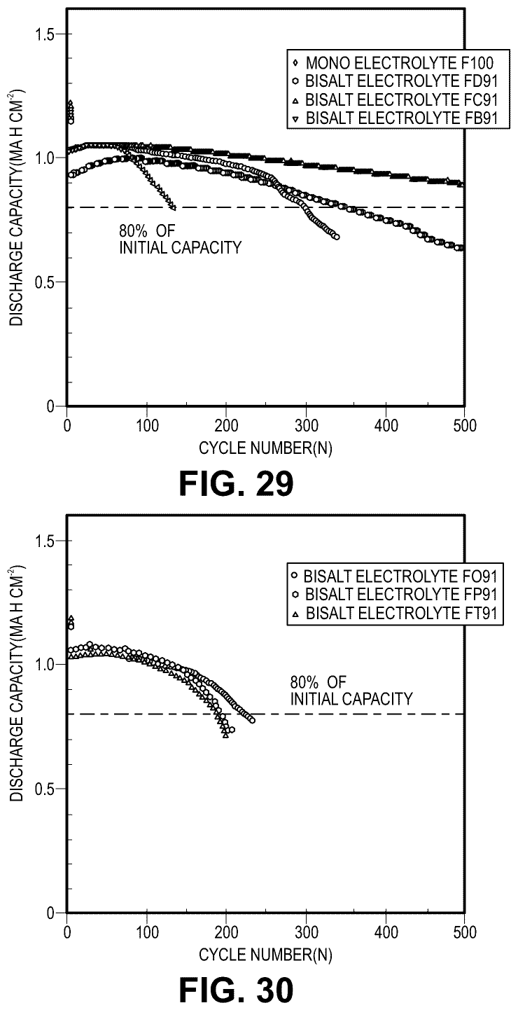

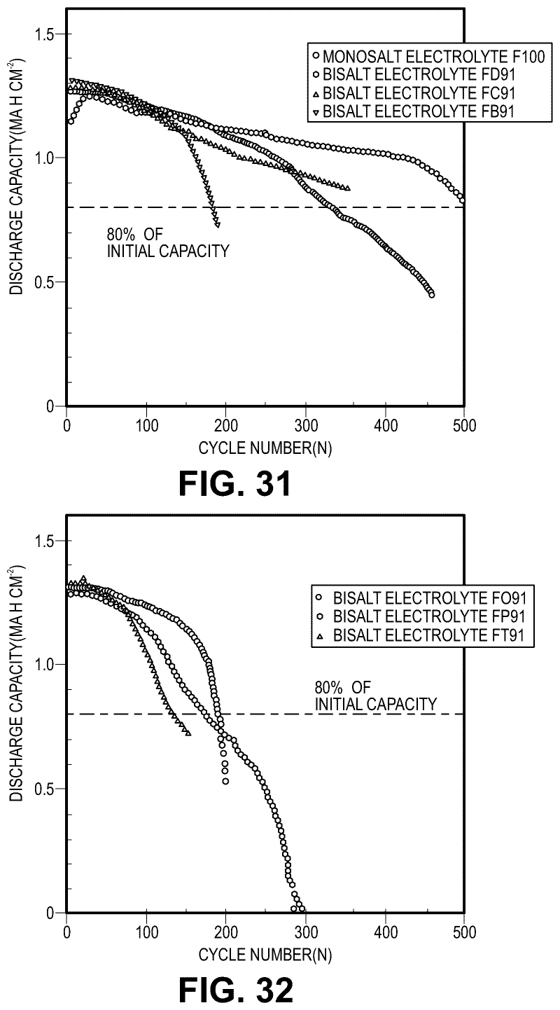

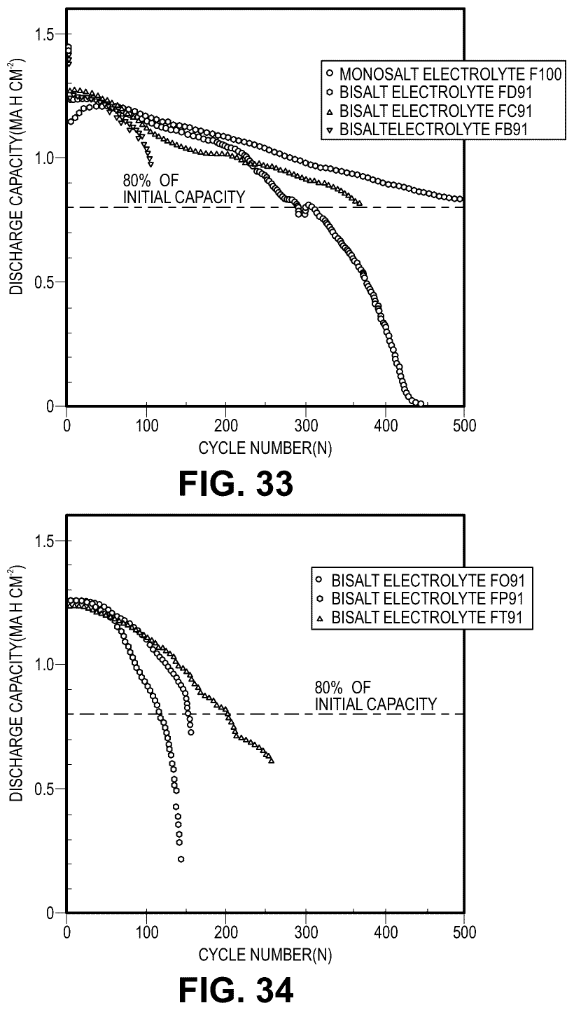

Cells were cycled using a 1.0 mA cm⁻²/3.0 mA cm⁻² charge/discharge protocol with a 4.2 V upper cutoff voltage and 3 V lower cutoff voltage (FIGS. 27-28). Altematively, cells were cycled using a 1.0 mA cm⁻²/6.0 mA cm⁻² charge/discharge protocol with a 4.2 V upper cutoff voltage and 3 V lower cutoff voltage (FIGS. 29-30). Alternatively, cells were cycled using a 1.0 mA cm⁻²/3.0 mA cm⁻² charge/discharge protocol with a 4.35 V upper cutoff voltage and 3 V lower cutoff voltage (FIGS. 31-32). Alternatively, cells were cycled using a 1.0 mA cm⁻²/6.0 mA cm⁻² charge/discharge protocol with a 4.35 V upper cutoff voltage and 3 V lower cutoff voltage (FIGS. 33-34). In all cases, the cells cycled an areal capacity greater than 1.0 mA h cm⁻² through 50 cycles. The cycle life (defined as the number of cycles before the discharge capacity drops below 80% of the initial) of these cells exceeded 50 cycles. Notably, the discharge capacity for the dual salt electrolytes remained higher over a greater number of cycles than the monosalt electrolytes over a range of cycling conditions (compare, for example FD91 and F100 in FIG. 27). Without being bound by any particular theory, it is believed that the improvements afforded by the dual salt system are tied primarily to the ability of the salt pair to stabilize both anode and cathode during operation, whereas when only one is present, the benefits are localized to ether anode or cathode, but rarely both, particularly when charging at high voltage and when using an anodeless cell configuration.

### VII. EXEMPLARY EMBODIMENTS

Exemplary embodiments provided in accordance with the presently disclosed subject matter include, but are not limited to, the claims and the following embodiments:
1. An electrochemical cell comprising (i) an anode, (ii) a first electrolyte, (iii) a polymer membrane separator comprising a microporous polymer, (iv) a second electrolyte, and (v) a cathode, wherein:
the polymer membrane separator is positioned between the anode and the cathode;
the first electrolyte is in contact with the anode and a first face of the polymer membrane separator;
the second electrolyte is in contact with the cathode and a second face of polymer membrane the separator; and
at least one electrolyte comprises a locally concentrated electrolyte comprising one or more alkali metal salts, a solvent, and a diluent.
2. An electrochemical cell comprising (i) a current collector, (ii) a first electrolyte, (iii) a polymer membrane separator, (iv) a second electrolyte, and (v) a cathode, wherein:
the polymer membrane separator is positioned between the current collector and the cathode;
the first electrolyte is in contact with the current collector and a first face of the polymer membrane separator;
the second electrolyte is in contact with the cathode and a second face of polymer membrane the separator; and
at least one electrolyte comprises a locally concentrated electrolyte comprising one or more alkali metal salts, a solvent, and a diluent.
3. The electrochemical cell of embodiment 1 or embodiment 2, wherein:
the molar ratio of the alkali metal salts to the solvent ranges from about 1:1.75 to about 1:2.5; and
the molar ratio of the alkali metal salts ranges to the diluent from about 1:0.25 to about 1:1.5.
4. An electrochemical cell comprising (i) a current collector, (ii) a first electrolyte, (iii) a polymer membrane separator comprising a microporous polymer, (iv) a second electrolyte, and (v) a cathode, wherein:
the polymer membrane separator is positioned between the anode or the current collector and the cathode;
the first electrolyte is in contact with the current collector and a first face of the polymer membrane separator; and
the second electrolyte is in contact with the cathode and a second face of polymer membrane the separator.
5. The electrochemical cell of embodiment 4, wherein at least one electrolyte comprises a locally concentrated electrolyte comprising one or more alkali metal salts, a solvent, and a diluent.
6. The electrochemical cell of embodiment 5, wherein:
the molar ratio of the alkali metal salts to the solvent ranges from about 1:1.75 to about 1:2.5; and
the molar ratio of the alkali metal salts to the diluent ranges from about 1:0.25 to about 1:1.5.
7. An electrochemical cell comprising (i) an anode, (ii) a first electrolyte, (iii) a polymer membrane separator, (iv) a second electrolyte, and (v) a cathode, wherein:
the polymer membrane separator is positioned between the anode and the cathode;
the first electrolyte is in contact with the anode and a first face of the polymer membrane separator;
the second electrolyte is in contact with the cathode and a second face of polymer membrane the separator;
at least one of the electrolytes comprises a locally concentrated electrolyte comprising one or more alkali metal salts, a solvent, and a diluent;
the molar ratio of the alkali metal salts to the solvent ranges from about 1:1.75 to about 1:2.5; and
the molar ratio of the alkali metal salts to the diluent ranges from about 1:0.25 to about 1:1.5.
8. The electrochemical cell of any one of embodiments 1-3 and 5-6, wherein each solvent is independently selected from the group consisting of 1,2-dimethoxyethane (DME), 1,3-dioxolane, 1,4-dioxane, tetrahydrofuran, allyl ether, diethylene glycol dimethyl ether, triethylene glycol dimethyl ether, tetraethylene glycol dimethyl ether, butyl diglyme, dimethyl ether, diethyl ether, polyethylene glycol, acctonitrile, dimethyl sulfoxide, sulfolane, trimethyl phosphate (TMPa), triethyl phosphate (TEPa), dimethyl methylphosphonate (DMMP), hexamethyldisiloxane, hexamethylcyclotrisiloxane, silanes, and combinations thereof.
9. The electrochemical cell of any one of embodiments 1-3 and 5-8, wherein each diluent is independently selected from the group consisting of 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), methoxynonafluorobutane (MOFB), ethoxynonafluorobutane (EOFB), methyl 2,2,2-trifluoroethyl carbonate (MTFEC), di(2,2,2-trifluoroethyl) carbonate (DTFEC), tris(2,2,2-trifluorethyl)orthoformate, tris(hexafluoro-isopropyl)orthoformate, tris(2,2,2-difluoroethyl)orthoformate, bis(2,2,2-trifluoroethyl)methyl orthoformate, tris(2,2,3,3,3-pentafluoropropyl)orthoformate, tris(2,2,3,3-tetrafluoropropyl)orthoformate, and combinations thereof.
10. The electrochemical cell of any one of embodiments 1-3 and 5-9, wherein each alkali metal salt comprises an anion independently selected from the group consisting of a bis(fluorosulfonyl)imide anion, a chlorate anion, a perchlorate anion, a nitrate anion, a phosphate anion, a hexafluorophosphate anion, a borate anion, a tetrafluoroborate anion, a difluoro(oxalate)borate anion, a bis(oxalate)borate anion, a bis(trifluoromethane)sulfonimide anion, a closo-dodecaborate anion, a halogenated closo-dodecaborate anion, a closo-carborane anion, and a balogenated closo-carborane anion.
11. The electrochemical cell of any one of embodiments 1-10, wherein the alkali metal salts are lithium salts.
12. The electrochemical cell of any one of embodiments 1-3 and 5-11, wherein:
the molar ratio of the alkali metal salts to the solvent is about 1:2 and the molar ratio of the alkali metal salts to the diluent ranges from about 1:0.3 to about 1:1.3.
13. The electrochemical cell of embodiment 12, wherein the molar ratio of the alkali metal salts to the diluent is about 1:1.2.
14. The electrochemical cell of any one of embodiments 1-3 and 5-13, wherein the solvent is 1,2-dimethoxyethane (DME), the diluent is tetrafluorocthyl-2,2,2,3-tetrafluoropropyl ether (TTE), and the electrolyte comprises a first alkali metal salt and one more additional alkali metal salts.
15. The electrochemical cell of any one of embodiments 1-3 and 5-14, wherein the electrolyte comprises a first alkali metal salt and a second alkali metal salt.
16. The electrochemical cell of any one of embodiments 1-3 and 5-14, wherein the electrolyte comprises a first alkali metal salt and a second alkali metal salt in a molar ratio ranging from about 75:25 to about 99:1.
17. The electrochemical cell of embodiment 15 or embodiment 16, wherein the molar ratio of the first alkali metal salt to the second alkali metal salt is about 90:10.
18. The electrochemical cell of any one of embodiments 15-17, wherein the first alkali metal salt is lithium bis(fluorosulfonyl)imide, and wherein the second alkali metal salt is selected from the group consisting of lithium difluoro(oxalate)borate, lithium perchlorate, lithium tetrafluoroborate, lithium trifluoromethanesulfonate, lithium hexafluorophosphate, and lithium bis(trifluoromethanesulfonyl)imide.
19. The electrochemical cell of any one of embodiments 1-18, wherein the ionic conductivity of the electrolyte is greater than or equal to 3 mS cm⁻¹.
20. The electrochemical cell of any one of embodiments 1-19, wherein the viscosity of the electrolyte is less than or equal to 20 Pa*s.
21. The electrochemical cell of any one of embodiments 1, 3, and 7-20, wherein the anode comprises lithium metal, sodium metal, or potassium metal.
22. The electrochemical cell of any one of embodiments 1, 3, and 7-20, wherein the anode comprises graphite.
23. The electrochemical cell of any one of embodiments 1, 3, and 7-20, wherein the anode comprises one or more of magnesium, calcium, aluminum, and/or zinc metal.
24. The electrochemical cell of any one of embodiments 1, 3, and 7-20, wherein the anode comprises one or more of boron, silicon, germanium, arsenic, antimony, tellurium, and/or polonium semimetal.
25. The electrochemical cell of any one of embodiments 1, 3, and 7-20, wherein the anode comprises a composite of metals, semimetals, and/or alloys thereof with a binder and/or one or more conductive additives such as C₆₀, carbon black, acetylene black, SuperP, KetjenBlack, graphene, multi-layer graphene, single-wall carbon nanotubes, multi-wall carbon nanotubes, carbon nanofibers, carbon fiber, MXenes, metal oxides, and/or black phosphorous.
26. The electrochemical cell of any one of embodiments 2-6 and 8-20, wherein the current collector comprises copper metal.
27. The electrochemical cell of any one of embodiments 2-6 and 8-20, wherein the current collector comprises a lithium alloy, a sodium alloy, or a potassium alloy.
28. The electrochemical cell of embodiment 27, wherein the lithium alloy is selected from the group consisting of Li—Zn, Li—Al, Li—B, Li—Cd, Li—Ag, Li—Si, Li—Pb, Li—Sn, and Li—Mg.
29. The electrochemical cell of any one of embodiments 1-28, wherein the cathode comprises a metal oxide, a polyanion oxide, a cation-disordered rocksalt, a metal sulfide, a metal fluoride, CFx, sulfur, oxygen, or combinations thereof.
30. The electrochemical cell of embodiment 29, wherein the metal oxide is LiNiₓMn_{y}Co_{z}O₂.
31. The electrochemical cell of any one of embodiments 1, 3-6, and 8-30, wherein the microporous polymer is a polymer according to the formula:

-[A-AB-B]ₙ-,
wherein:
n is an integer ranging from 10 to 10,000;
each monomer segment A-A is independently a monomer segment according to Formula A, B, C, D, E, F, G, H, I or J:

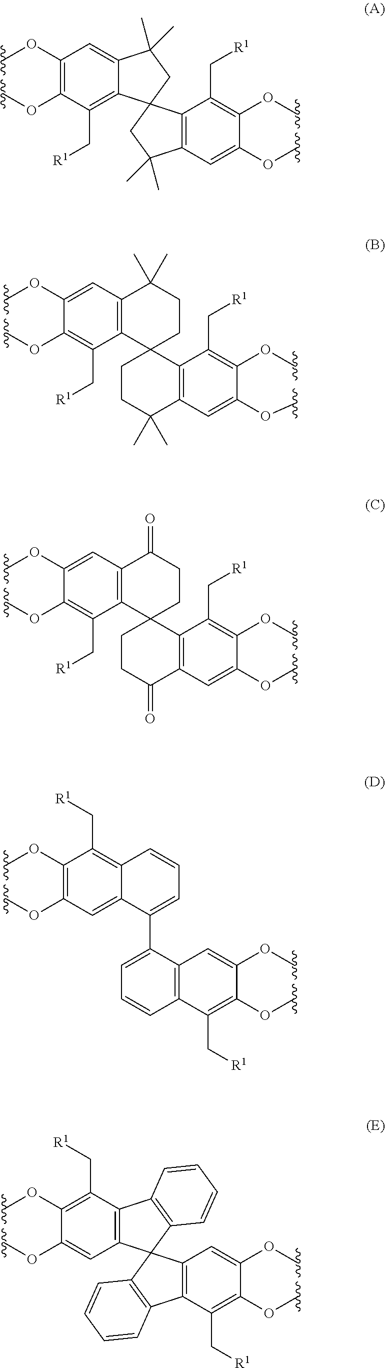

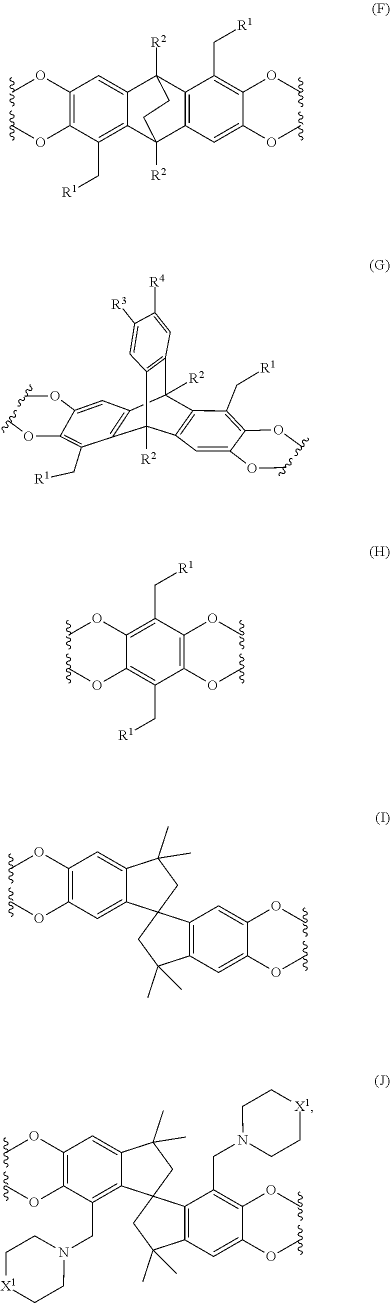

provided that at least one monomer segment A-A is independently a monomer segment according to Formula A, B, C, D, E, F, G, or H;
each monomer segment B-B is independently a monomer segment according to Formula a, b, or c:

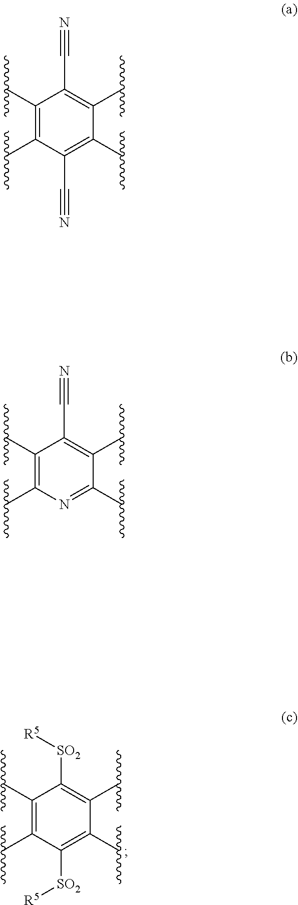

R¹ is selected from the group consisting of:

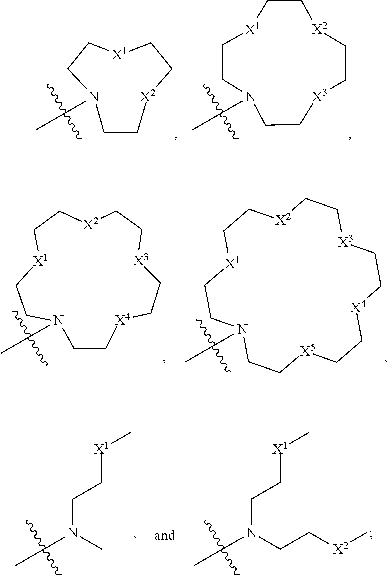

X¹, X², X³, X⁴, and X⁵ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈s)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl.
32. The electrochemical cell according to embodiment 31, wherein R¹ is:

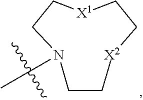

and
X¹ and X² are oxygen.
33. The electrochemical cell of embodiment 31 or embodiment 32, wherein the microporous polymer has the structure:

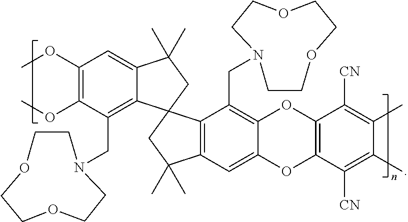

34. The electrochemical cell of 1, 3-6, and 8-30, wherein the microporous polymer is a polymer according to the formula:

-[A-AB-B]ₙ-,
or a salt thereof,
wherein:
n is an integer ranging from 10 to 10,000;
each monomer segment A-A is independently a monomer segment according to Formula K, L, M, N, O, P, Q or R:

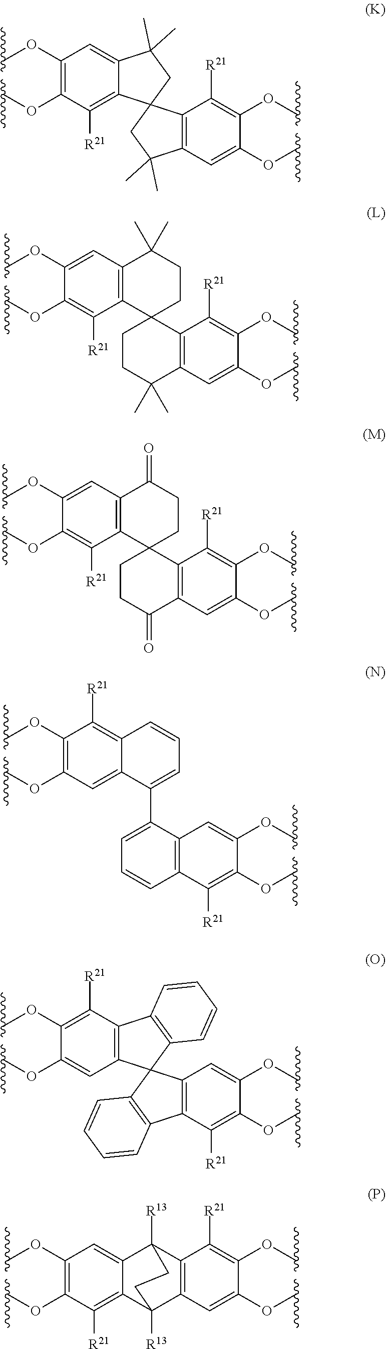

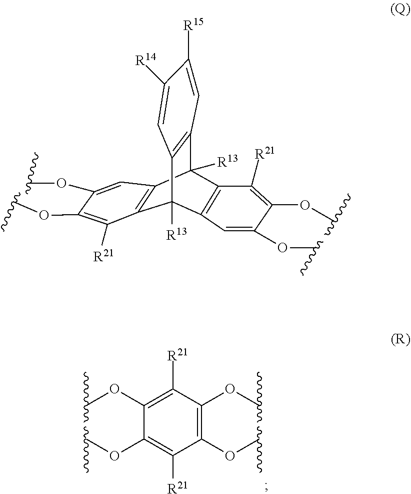

each monomer segment B-B is independently a monomer segment according to Formula k, l, m, n, o, or p:

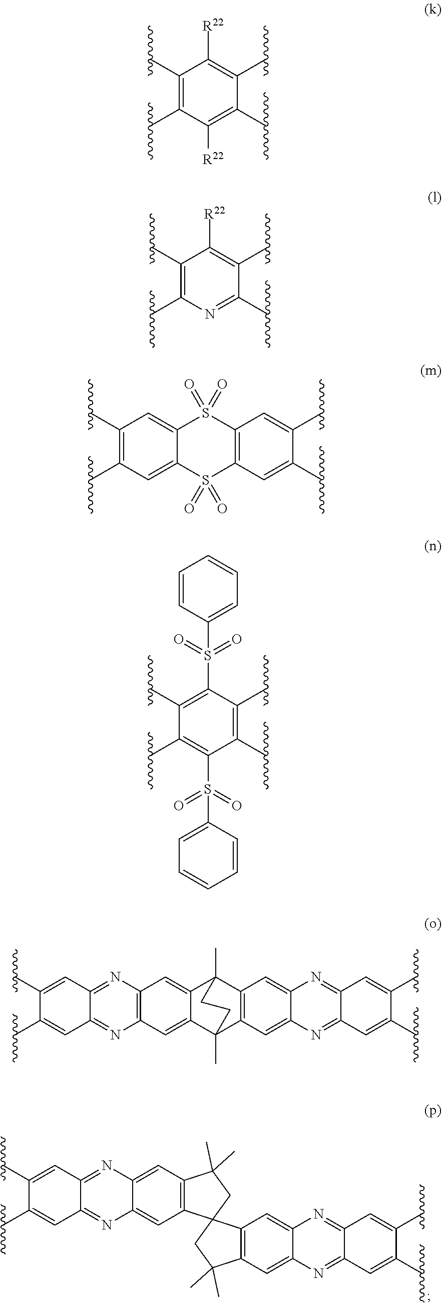

each R²¹ is independently selected from the group consisting of —CH₂NR¹¹R¹² and H;
each R²² is independently selected from the group consisting of —C(NOR²³)N(R²⁴)₂ and —CN;
at least one R²¹ in at least one monomer segment A-A is —CH₂NR¹¹R¹², or at least one R²² in at least one monomer segment B-B is —C(NOR²³)N(R²⁴)₂;
each R¹¹ and R¹² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁-20)alkyl, 5- to 8-membered heteroaryl, heteroaryl(C₁₋₂₀)alkyl,
wherein each R¹¹ and R¹² is optionally and independently substituted with one or more Z¹¹,
wherein each alkyl, alkenyl, and alkynyl in R¹¹ and R¹² optionally and independently comprises one or more heteroatoms independently selected from silicon, a chalcogenide, and a pnictide, and
wherein one or more atoms in R¹¹ and R¹² are optionally and independently present in oxidized form as C═O, C═S, N═O, N═S, S═O or S(O)₂; or
alternatively, cach R¹¹ is optionally and independently taken together with R¹², and the nitrogen atom to which both are attached, to form 3- to 8-membered heterocyclyl or 5- to 8-membered heteroaryl, each of which is optionally substituted with one or more Z¹²;
each Z¹¹ and Z¹² is independently selected from the group consisting of halogen, —OH, —NO₂, —CN, (C₁₋₂₀)alkyl, (C₂₋₂₀)alkenyl, (C₂₋₂₀)alkynyl, (C₆₋₁₀)aryl, (C₃₋₈) cycloalkyl, (C₆₋₁₀)aryl(C₁₋₂₀)alkyl, hetero(C₁₋₂₀)alkyl, 3- to 8-membered heterocyclyl, 5- to 8-membered heteroaryl, (C₃₋₈)cycloalkyl-(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl. halo(C₁₋₂₀)alkyloxy, —OR¹⁶, —SR¹⁶, —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶;
each R¹³, R¹⁴, R¹⁵, R¹⁶, R¹⁷, and R¹⁸ is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, 5- to 8-membered heteroaryl-(C₁₋₂₀)alkyl; or
alternatively, R¹⁴ and R¹⁵ are taken together to form (C₄₋₈)cycloalkyl, (C₆₋₁₀)aryl, 4- to 8-membered heterocyclyl, or 5- to 8-membered heteroaryl; or
alternatively, R¹⁶ and R¹⁷ are taken together to form 4- to 8-membered heterocyclyl or 5- to 8-membered heteroaryl; or
alternatively, R¹⁷ and R¹⁸ are taken together to form 4- to 8-membered heterocyclyl or 5- to 8-membered heteroaryl;
each R²³ is selected from the group consisting of H, (C₁₋₂₀)alkyl, and (C₃₋₈)cycloalkyl, wherein alkyl and cycloalkyl are optionally and independently substituted with one or more Z³,
provided that R²³ is (C₁₋₂₀)alkyl or (C₃₋₈)cycloalkyl, each of which is optionally and independently substituted with one or more Z¹³, when all R²¹ groups in monomer segments according to formula (A) are H;
each R²⁴ is independently selected from the group consisting of H, (C₁₋₂₀)alkyl, and (C₃₋₈)cycloalkyl: and
each Z¹³ is independently selected from the group consisting of halogen, —NO₂, —CN, —OH, —SO₃H, —NH₂, (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, hetero(C₁₋₂₀)alkyl, 3- to 8-membered heterocyclyl, 5- to 8-membered heteroaryl, (C₃₋₈)cycloalkyl-(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl, halo(C₁₋₂₀)alkyloxy, —OR¹⁶, —SR¹⁶, —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶.
35. The electrochemical cell of any one of embodiments 1-34, wherein the microporous polymer has a surface area ranging from about 50 m² g⁻¹ to about 2000 m² g⁻¹.
36. The electrochemical cell of any one of embodiments 1-35, wherein the microporous polymer has pore sizes ranging from about 0.4 nm to about 2 nm.
37. The electrochemical cell of any one of embodiments 1-36, wherein the microporous polymer has a porosity ranging from about 5% to about 40%.
38. The electrochemical cell of any one of embodiments 1-37, wherein the area-specific impedance of the polymer membrane separator is less than or equal to 20 Ohm*cm².
39. The electrochemical cell of any one of embodiments 1-38, wherein the voltage stability of the electrochemical cell is at least 3.7 V vs. Li/Li⁺.
40. The electrochemical cell of any one of embodiments 1-39, wherein the electrochemical cell has an area capacity of greater than or equal to 1 mAh cm⁻² and less than or equal to 15 mAh cm⁻².
41. The electrochemical cell of any one of embodiments 1-40, wherein the electrochemical cell has a cycle life of greater than or equal to 50 cycles.
42. The electrochemical cell of any one of embodiments 1-41, wherein the cycle life is greater than or equal to 20 larger than the cycle life of an otherwise equivalent electrochemical cell with a conventional polyolefin separator and conventional liquid carbonate electrolyte.
43. The electrochemical cell of any one of embodiments 1-42, wherein the electrochemical cell has a power rating of greater than or equal to 500 W kg⁻¹.
44. A compound according to Formula I, II, III, IV, V, VI, VII, or VIII:

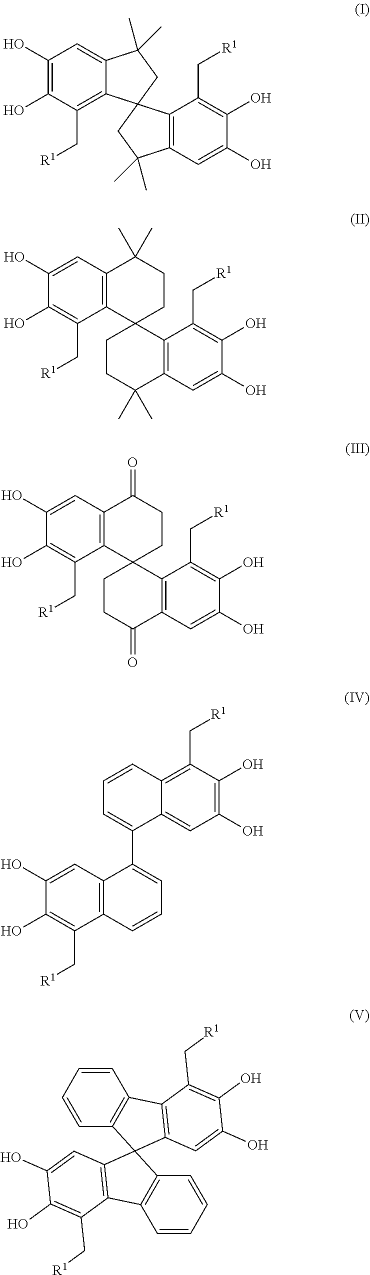

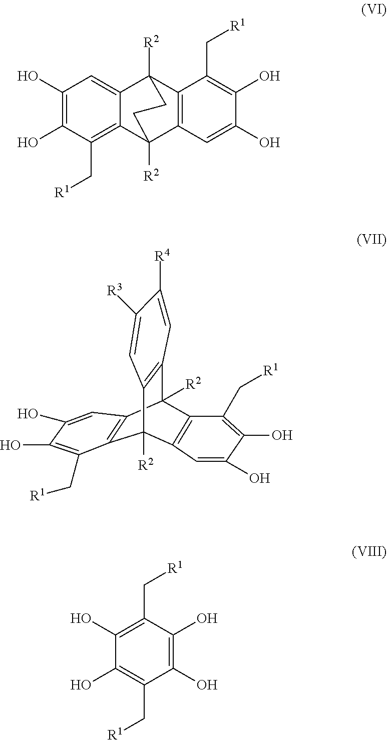

wherein:
R¹ is selected from the group consisting of:

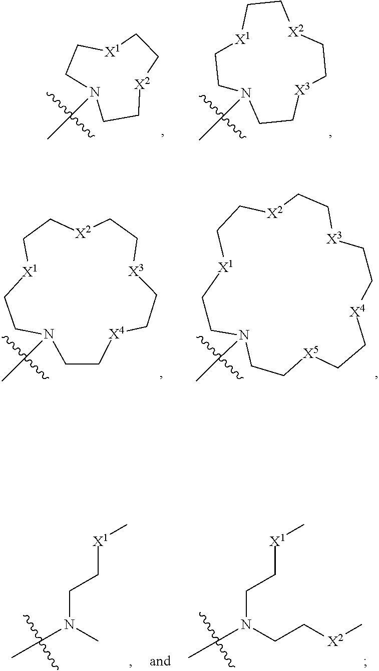

X¹, X², X³, X⁴, and X⁵ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; and
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R⁴ and R⁵ are taken together to form (C₄₋₈)cycloalkyl, (C₆₋₁₀)aryl, 4- to 8-membered heterocyclyl, or 5- to 8-membered heteroaryl.
45. A microporous polymer according to the formula:

[A-AB-B]ₙ-,
wherein:
n is an integer ranging from 10 to 10,000;
each monomer segment A-A is independently a monomer segment according to Formula A, B, C, D, E, F, G, H, I or J:

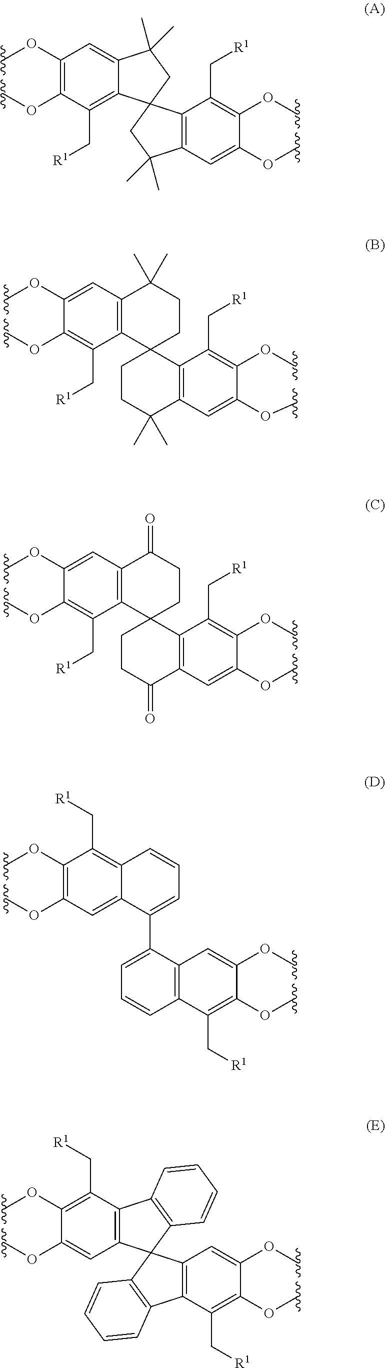

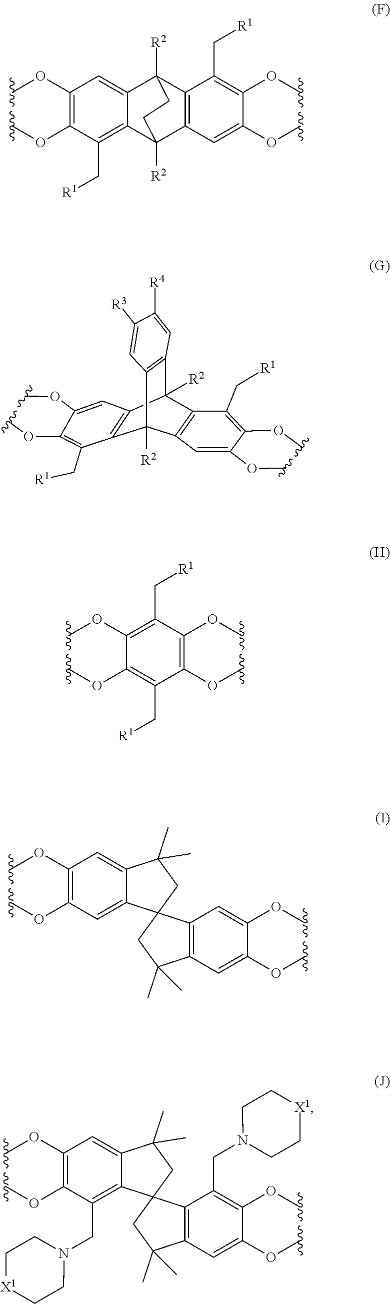

provided that at least one monomer segment A-A is independently a monomer segment according to Formula A, B, C, D, E, F, G, or H;
each monomer segment B-B is independently a monomer segment according to Formula a, b, or c:

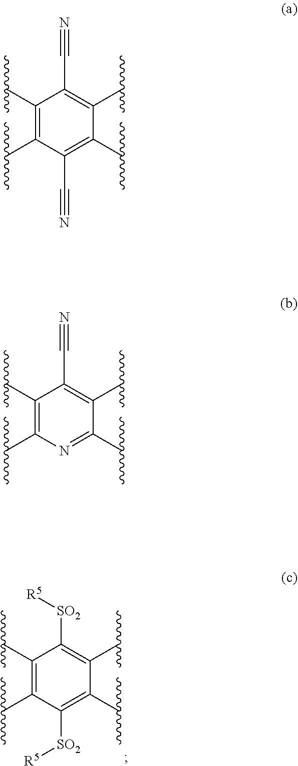

R¹ is selected from the group consisting of:

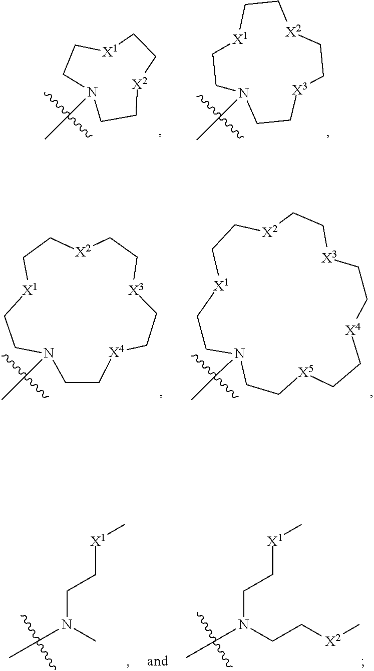

X¹, X², X³, X⁴, and X³ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₁₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl.
46. The microporous polymer of embodiment 45, wherein the microporous polymer has a surface area ranging from about 50 m² g⁻¹ to about 2000 m² g⁻¹.
47. The microporous polymer of embodiment 45, wherein the microporous polymer has pore sizes ranging from about 0.4 nm to about 2 nm.
48. The microporous polymer of embodiment 45, wherein the microporous polymer has a porosity ranging from about 5% to about 40%.
49. The microporous polymer of any one of embodiments 45-48, wherein each monomer segment A-A is independently a monomer segment according to Formula A, B, C, D, E, F, G, or H.
50. A membrane comprising one or more microporous polymers according to any one of embodiments 45-49, wherein said membrane has a thickness ranging from 0.1 micrometer to 1000 micrometers.
51. The membrane of embodiment 50, wherein the membrane is in contact with a support comprising a poly(arylether), a poly(arylether) copolymer, a poly(arylether sulfone) copolymer, a poly(arylether ketone), a poly(arylether ketone) copolymer, polyethylene, a polyethylene copolymer, polypropylene, a polypropylene copolymer, a polycycloolefin, a cycloolefin copolymer, polyacrylonitrile, a polyacrylonitrile copolymer, poly(vinylidene fluoride), a poly(vinylidene fluoride) copolymer, poly(tetrafluoroethylene), a poly(tetrafluoroethylene) copolymer, poly(hexafluoropropylene), a poly(hexafluoropropylene) copolymer, poly(vinyl chloride), a poly(vinyl chloride) copolymer, a polyamide, a polyamide copolymer, polyaramide, a polyaramide copolymer, polyurethane, a polyurethane copolymer, a polyurea, a polyurea copolymer, a porous metal, a porous alloved metal, a porous metal oxide, a porous metal sulfide, or a combination thercof.
52. An electrochemical cell comprising a membrane according to embodiment 50 or embodiment 51 positioned between (a) an anode or a current collector and (b) a cathode.
53. The electrochemical cell of embodiment 52, further comprising a locally concentrated electrolyte comprising one or more alkali metal salts, a solvent, and a diluent.

Although the foregoing has been described in some detail by way of illustration and example for purposes of clarity and understanding, one of skill in the art will appreciate that certain changes and modifications can be practiced within the scope of the appended claims. In addition, each reference provided herein is incorporated by reference in its entirety to the same extent as if cach reference was individually incorporated by reference.

1-53. (canceled)

54. An electrochemical cell comprising (i) an anode or a current collector, (ii) a first electrolyte, (iii) a polymer membrane separator comprising a microporous polymer, (iv) a second electrolyte, and (v) a cathode, wherein:
the polymer membrane separator is positioned between the anode or current collector and the cathode;
the first electrolyte is in contact with the anode or current collector and a first face of the polymer membrane separator;
the second electrolyte is in contact with the cathode and a second face of polymer membrane the separator; and
at least one electrolyte comprises a locally concentrated electrolyte comprising one or more alkali metal salts, a solvent, and a diluent.

55. The electrochemical cell of claim 54, wherein:
the molar ratio of the alkali metal salts to the solvent ranges from about 1:1.75 to about 1:2.5; and
the molar ratio of the alkali metal salts ranges to the diluent from about 1:0.25 to about 1:1.5.

56. The electrochemical cell of claim 54, wherein:
(i) each solvent is independently selected from the group consisting of 1,2-dimethoxyethane (DME), 1,3-dioxolane, 1,4-dioxane, tetrahydrofuran, allyl ether, diethylene glycol dimethyl ether, triethylene glycol dimethyl ether, tetraethylene glycol dimethyl ether, butyl diglyme, dimethyl ether, diethyl ether, polyethylene glycol, acetonitrile, dimethyl sulfoxide, sulfolane, trimethyl phosphate (TMPa), triethyl phosphate (TEPa), dimethyl methylphosphonate (DMMP), hexamethyldisiloxane, hexamethylcyclotrisiloxane, silanes, and combinations thereof;
(ii) each diluent is independently selected from the group consisting of 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), methoxynonafluorobutane (MOFB), ethoxynonafluorobutane (EOFB), methyl 2,2,2-trifluoroethyl carbonate (MTFEC), di(2,2,2-trifluoroethyl) carbonate (DTFEC), tris(2,2,2-trifluorethyl)orthoformate, tris(hexafluoro-isopropyl)orthoformate, tris(2,2,2-difluoroethyl)orthoformate, bis(2,2,2-trifluoroethyl) methyl orthoformate, tris(2,2,3,3,3-pentafluoropropyl)orthoformate, tris(2,2,3,3-tetrafluoropropyl)orthoformate, and combinations thereof;
(iii) each alkali metal salt comprises an anion independently selected from the group consisting of a bis(fluorosulfonyl)imide anion, a chlorate anion, a perchlorate anion, a nitrate anion, a phosphate anion, a hexafluorophosphate anion, a borate anion, a tetrafluoroborate anion, a difluoro(oxalate)borate anion, a bis(oxalate)borate anion, a bis(trifluoromethane)sulfonimide anion, a closo-dodecaborate anion, a halogenated closo-dodecaborate anion, a closo-carborane anion, and a halogenated closo-carborane anion;
(iv) the alkali metal salts are lithium salts;
(v) the molar ratio of the alkali metal salts to the solvent is about 1:2 and
the molar ratio of the alkali metal salts to the diluent ranges from about 1:0.3 to about 1:1.3;
(vi) the molar ratio of the alkali metal salts to the diluent is about 1:1.2; or
(vii) the solvent is 1,2-dimethoxyethane (DME), the diluent is tetrafluoroethyl-2,2,2,3-tetrafluoropropyl ether (TTE), and the electrolyte comprises a first alkali metal salt and one more additional alkali metal salts.

57. The electrochemical cell of claim 54, wherein the electrolyte comprises a first alkali metal salt and a second alkali metal salt.

58. The electrochemical cell of claim 57, wherein the first alkali metal salt is lithium bis(fluorosulfonyl)imide, and wherein the second alkali metal salt is selected from the group consisting of lithium difluoro(oxalate)borate, lithium perchlorate, lithium tetrafluoroborate, lithium trifluoromethanesulfonate, lithium hexafluorophosphate, and lithium bis(trifluoromethanesulfonyl)imide.

59. The electrochemical cell of claim 54, wherein:
(i) the ionic conductivity of the electrolyte is greater than or equal to 3 mS cm⁻¹; or
(ii) the viscosity of the electrolyte is less than or equal to 20 Pa*s.

60. The electrochemical cell of claim 54, wherein the anode comprises lithium metal, sodium metal, potassium metal, graphite, magnesium metal, calcium metal, aluminum metal, zinc metal, boron semimetal, silicon semimetal, germanium semimetal, arsenic semimetal, antimony semimetal, tellurium semimetal, polonium semimetal, a composite of metals, semimetals, and/or alloys thereof with a binder and/or one or more conductive additives such as C₆₀, carbon black, acetylene black, SuperP, KetjenBlack, graphene, multi-layer graphene, single-wall carbon nanotubes, multi-wall carbon nanotubes, carbon nanofibers, carbon fiber, MXenes, metal oxides, and/or black phosphorous.

61. The electrochemical cell of claim 54, wherein the current collector comprises copper metal, a lithium alloy, a sodium alloy, or a potassium alloy.

62. The electrochemical cell of claim 54, wherein the cathode comprises a metal oxide, a polyanion oxide, a cation-disordered rocksalt, a metal sulfide, a metal fluoride, CFx, sulfur, oxygen, or combinations thereof.

63. The electrochemical cell of claim 54, wherein the microporous polymer is a polymer according to the formula:
-[A-AB-B]ₙ-,
wherein:
n is an integer ranging from 10 to 10,000;
each monomer segment A-A is independently a monomer segment according to Formula A, B, C, D, E, F, G, H, I or J: 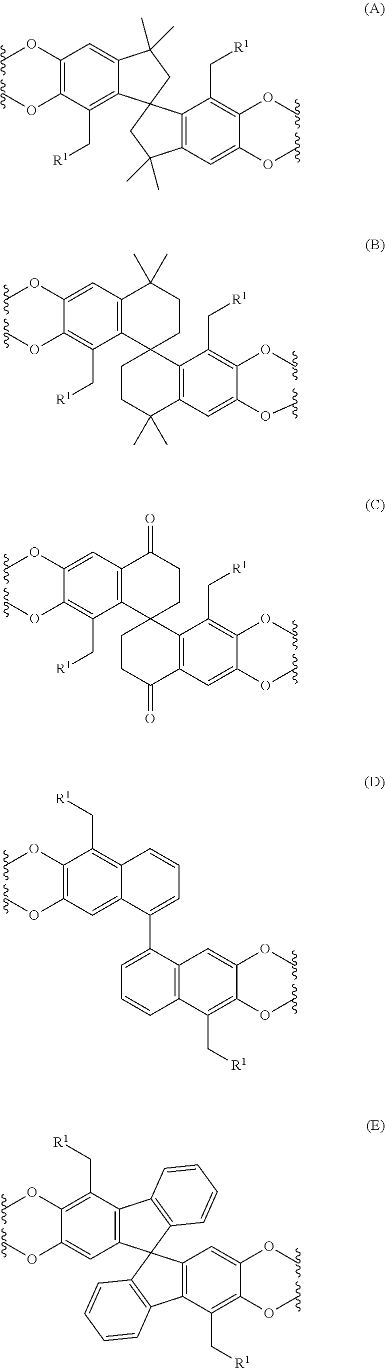 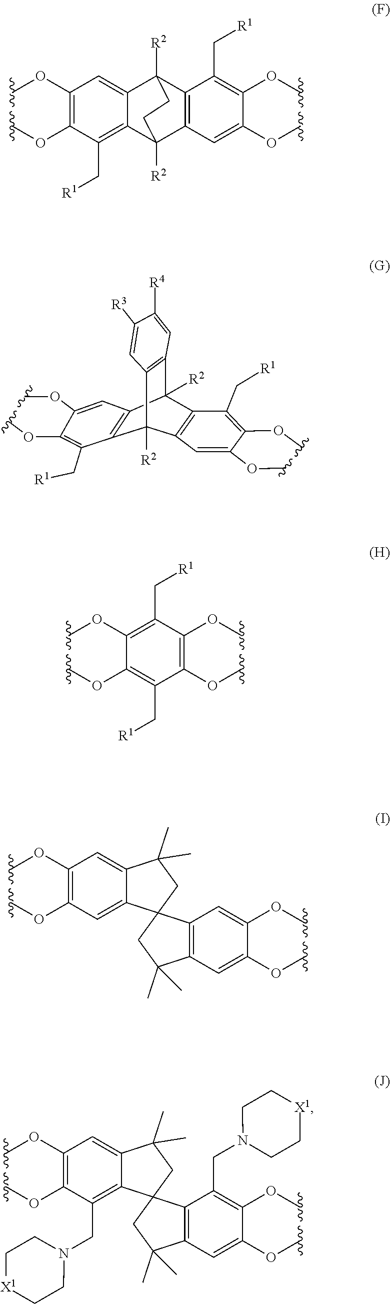
provided that at least one monomer segment A-A is independently a monomer segment according to Formula A, B, C, D, E, F, G, or H;
each monomer segment B-B is independently a monomer segment according to Formula a, b, or c: 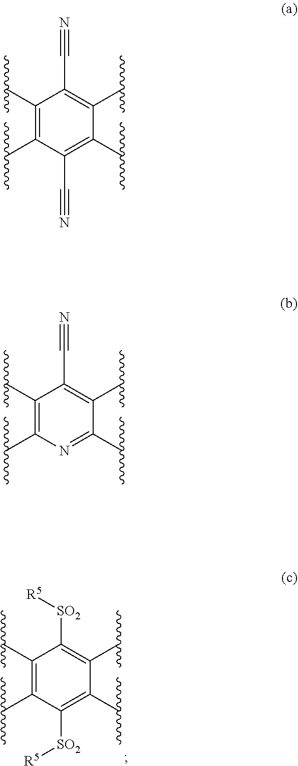
R¹ is selected from the group consisting of: 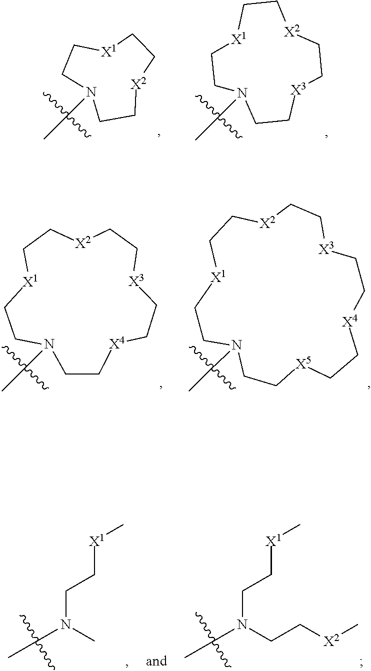
X¹, X², X³, X⁴, and X⁵ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl;
optionally wherein R¹ is: 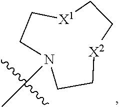
and p1 X¹ and X² are oxygen;
optionally wherein the microporous polymer has the structure:

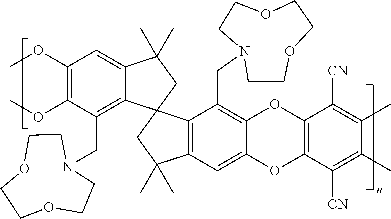

64. The electrochemical cell of claim 54, wherein the microporous polymer is a polymer according to the formula:
-[A-AB-B]ₙ-,
or a salt thereof,
wherein:
n is an integer ranging from 10 to 10,000;
each monomer segment A-A is independently a monomer segment according to Formula K, L, M, N, O, P, Q or R: 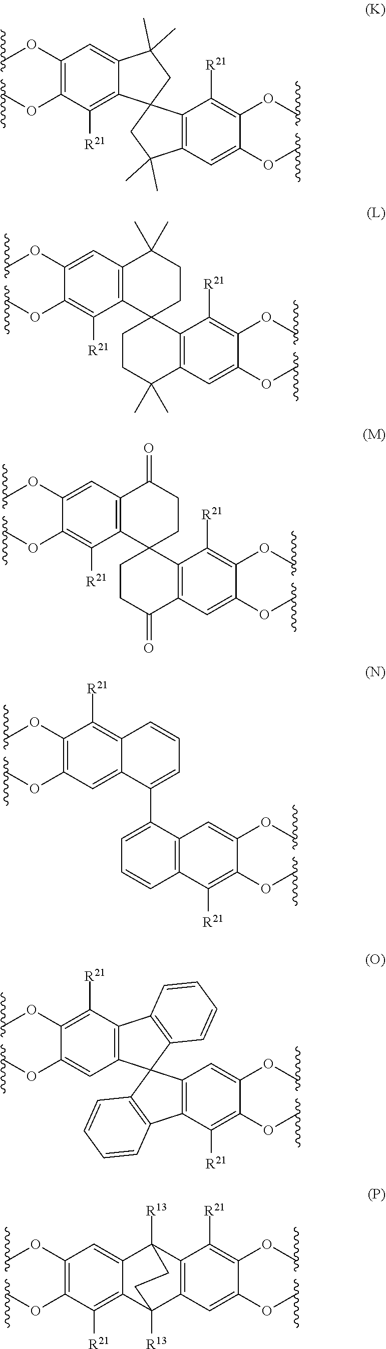 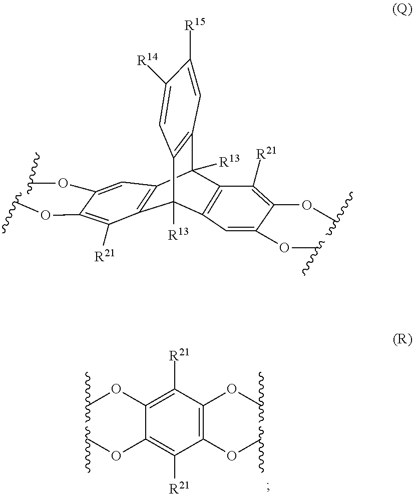
each monomer segment B-B is independently a monomer segment according to Formula k, l, m, n, o, or p: 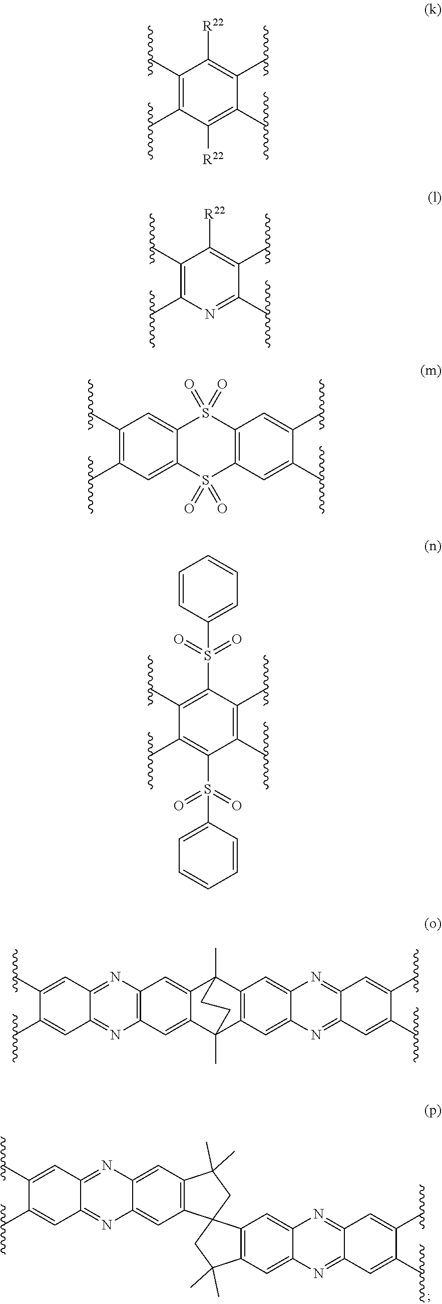
each R²¹ is independently selected from the group consisting of —CH₂NR¹¹R¹² and H;
each R²² is independently selected from the group consisting of —C(NOR²³)N(R²⁴)₂ and —CN;
at least one R²¹ in at least one monomer segment A-A is —CH₂NR¹¹R¹², or at least one R²² in at least one monomer segment B-B is —C(NOR²³)N(R²⁴)₂;
each R¹¹ and R¹² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, heteroaryl(C₁₋₂₀)alkyl,
wherein each R¹¹ and R¹² is optionally and independently substituted with one or more Z¹¹,
wherein each alkyl, alkenyl, and alkynyl in R¹¹ and R¹² optionally and independently comprises one or more heteroatoms independently selected from silicon, a chalcogenide, and a pnictide, and
wherein one or more atoms in R¹¹ and R¹² are optionally and independently present in oxidized form as C50 O, C═S, NO, N═S, S═O or S(O)₂; or
alternatively, each R¹¹ is optionally and independently taken together with R¹², and the nitrogen atom to which both are attached, to form 3- to 8-membered heterocyclyl or 5- to 8-membered heteroaryl, each of which is optionally substituted with one or more Z¹²;
each Z¹¹ and Z¹² is independently selected from the group consisting of halogen, —OH, —NO₂, —CN, (C₁₋₂₀)alkyl, (C₂₋₂₀)alkenyl, (C₂₋₂₀)alkynyl, (C₆₋₁₀)aryl, (C₃₋₈) cycloalkyl, (C₆₋₁₀)aryl(C₁₋₂₀)alkyl, hetero(C₁₋₂₀)alkyl, 3- to 8-membered heterocyclyl, 5- to 8-membered heteroaryl, (C₃₋₈)cycloalkyl(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl, halo(C₁₋₂₀)alkyloxy, —OR¹⁶, —SR¹⁶, —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶;
each R¹³, R¹⁴, R¹⁵, R¹⁶, R¹⁷, and R¹⁸ is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, 5- to 8-membered heteroaryl-(C₁₋₂₀)alkyl; or
alternatively, R¹⁴ and R¹⁵ are taken together to form (C₄₋₈)cycloalkyl, (C₆₋₁₀)aryl, 4- to 8-membered heterocyclyl, or 5- to 8-membered heteroaryl; or
alternatively, R¹⁶ and R¹⁷ are taken together to form 4- to 8-membered heterocyclyl or 5- to 8-membered heteroaryl; or
alternatively, R¹⁷ and R¹⁸ are taken together to form 4- to 8-membered heterocyclyl or 5- to 8-membered heteroaryl;
each R²³ is selected from the group consisting of H, (C₁₋₂₀)alkyl, and (C₃₋₈)cycloalkyl, wherein alkyl and cycloalkyl are optionally and independently substituted with one or more Z³, provided that R²³ is (C₁₋₂₀)alkyl or (C₃₋₈)cycloalkyl, each of which is optionally and independently substituted with one or more Z¹³, when all R²¹ groups in monomer segments according to formula (A) are H;
each R²⁴ is independently selected from the group consisting of H, (C₁₋₂₀)alkyl, and (C₃₋₈)cycloalkyl; and
each Z¹³ is independently selected from the group consisting of halogen, —NO₂, —CN, —OH, —SO₃H, —NH₂, (C₁₋₂₀)alkyl, (C₂₋₂₀)alkenyl, (C₂₋₂₀)alkynyl, (C₆₋₁₀)aryl, (C₃₋₈) cycloalkyl, (C₆₋₁₀)aryl(C₁₋₂₀)alkyl, hetero(C₁₋₂₀)alkyl, 3- to 8-membered heterocyclyl, 5- to 8-membered heteroaryl, (C₃₋₈)cycloalkyl-(C₁₋₂₀)alkyl, 3- to 8-membered heterocyclyl-(C₁₋₂₀)alkyl, 5- to 8-membered heteroaryl-(C₁₋₂₀)alkyl, halo(C₁₋₂₀)alkyl, halo(C₁₋₂₀)alkyloxy, —OR¹⁶, —SR¹⁶, —S(O)R¹⁶, —S(O)₂R¹⁶, —SO₂NR¹⁶R¹⁷, —NR¹⁶C(O)R¹⁷, —NR¹⁶S(O)₂R¹⁷, —NR¹⁶C(O)NR¹⁷R¹⁸, —NR¹⁶R¹⁷, —CO₂R¹⁶, —C(O)NR¹⁶R¹⁷, and —C(O)R¹⁶.

65. The electrochemical cell of claim 54, wherein:
(i) the microporous polymer has a surface area ranging from about 50 m² g⁻¹ to about 2000 m² g⁻¹;
(ii) the microporous polymer has pore sizes ranging from about 0.4 nm to about 2 nm;
(iii) the microporous polymer has a porosity ranging from about 5% to about 40%;
(iv) the area-specific impedance of the polymer membrane separator is less than or equal to 20 Ohm*cm²;
(v) the voltage stability of the electrochemical cell is at least 3.7 V vs. Li/Li⁺;
(vi) the electrochemical cell has an area capacity of greater than or equal to 1 mAh cm⁻² and less than or equal to 15 mAh cm⁻²;
(vii) the electrochemical cell has a cycle life of greater than or equal to 50 cycles;
(viii) the cycle life is greater than or equal to 20 larger than the cycle life of an otherwise equivalent electrochemical cell with a conventional polyolefin separator and conventional liquid carbonate electrolyte; or
(ix) the electrochemical cell has a power rating of greater than or equal to 500 W kg⁻¹.

66. A compound according to Formula I, II, III, IV, V, VI, VII, or VIII: 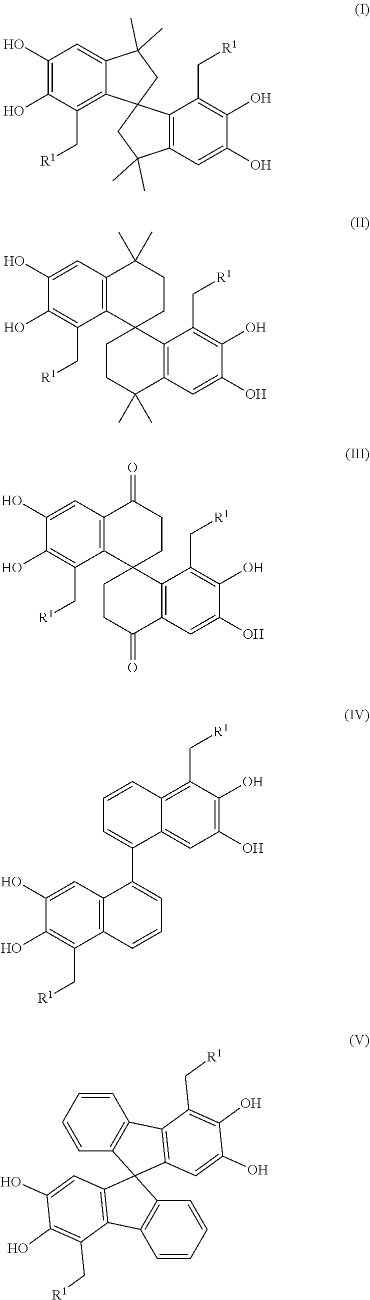 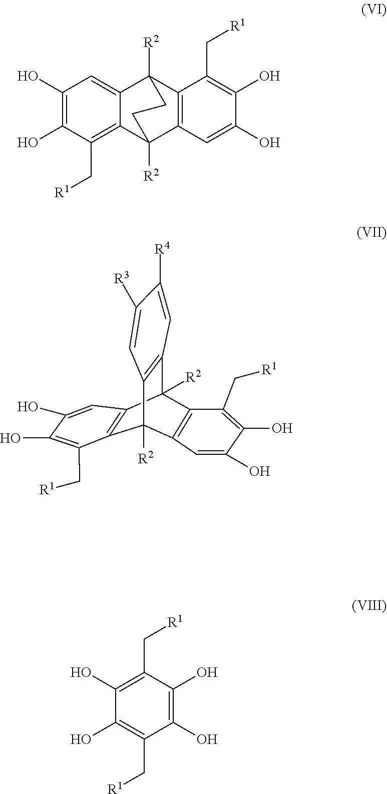
wherein:
R¹ is selected from the group consisting of: 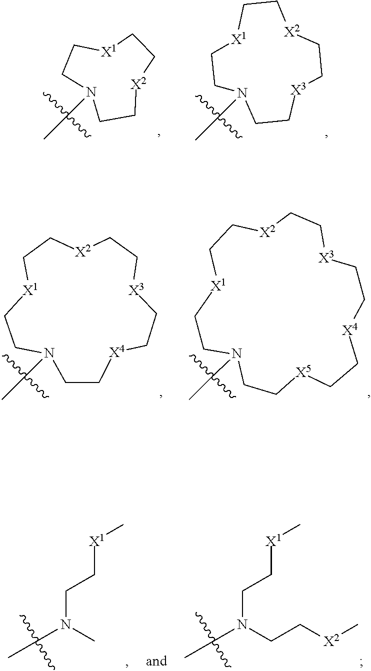
X¹, X², X³, X⁴, and X³ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; and
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁-20)alkyl, hetero(C₁-₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R⁴ and R⁵ are taken together to form (C₄₋₈)cycloalkyl, (C₆₋₁₀)aryl, 4- to 8-membered heterocyclyl, or 5- to 8-membered heteroaryl.

67. A microporous polymer according to the formula:
-[A-AB-B]ₙ-,
wherein:
n is an integer ranging from 10 to 10,000;
each monomer segment A-A is independently a monomer segment according to Formula A, B, C, D, E, F, G, H, I or J: 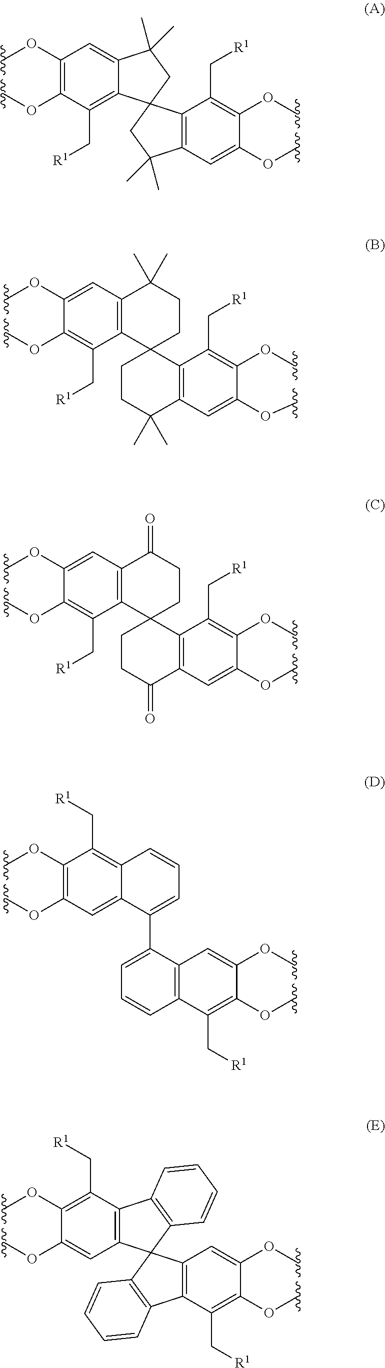 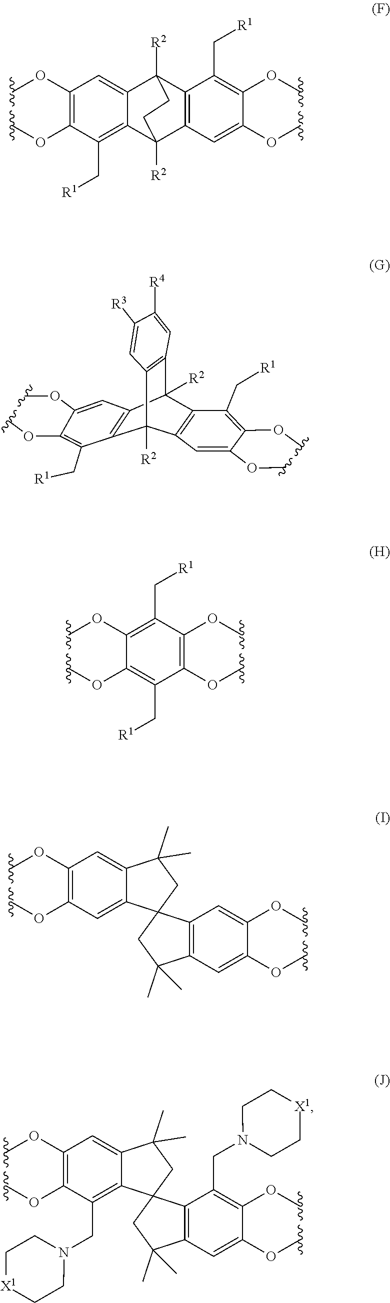
provided that at least one monomer segment A-A is independently a monomer segment according to Formula A, B, C, D, E, F, G, or H;
each monomer segment B-B is independently a monomer segment according to Formula a, b, or c: 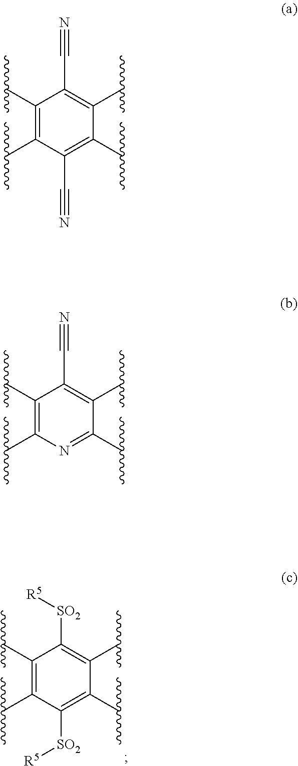
R¹ is selected from the group consisting of: 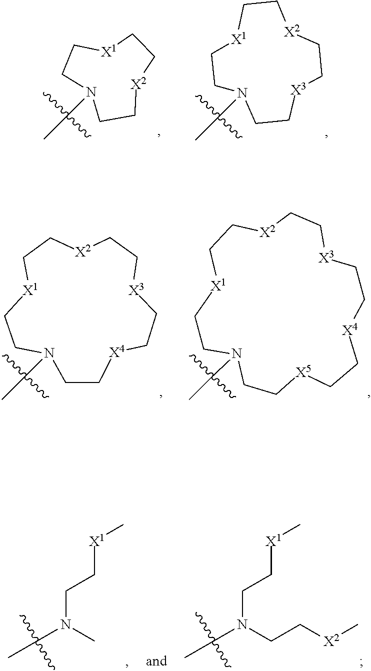
X¹, X², X³, X⁴, and X⁵ are independently selected from a chalcogenide, an oxidized chalcogenide, a pnictide bonded to (C₁₋₂₀)alkyl or (C₆₋₁₀)aryl, and an oxidized pnictide bonded to (C₁₋₂₀)alkyl or (C₆₋₁₀)aryl;
each R² is independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl;
R³ and R⁴ are independently selected from the group consisting of (C₁₋₂₀)alkyl, (C₂₋₂₀)alkenyl, (C₂₋₂₀)alkynyl, (C₆₋₁₀)aryl, (C₃₋₈)cycloalkyl, (C₆₋₁₀)aryl(C₁₋₂₀)alkyl, (C₃₋₈)cycloalkyl(C₁₋₂₀)alkyl, hetero(C₁₋₂₀)alkyl, 3- to 8-membered heterocyclyl, 3- to 8-membered heterocyclyl-(C₁₋₂₀)alkyl, 5- to 8-membered heteroaryl, and 5- to 8-membered heteroaryl-(C₁₋₂₀)alkyl; or
alternatively, R³ and R⁴ are taken together to form (C₄₋₈)cycloalkyl, (C₆₋₁₀)aryl, 4- to 8-membered heterocyclyl, or 5- to 8-membered heteroaryl; and
R⁵ is selected from the group consisting of (C₁₋₂₀)alkyl and (C₆₋₁₀)aryl;
optionally wherein the microporous polymer has:
(i) a surface area ranging from about 50 m² g⁻1 to about 2000 m² g⁻¹;
(ii) pore sizes ranging from about 0.4 nm to about 2 nm; or
(iii) a porosity ranging from about 5% to about 40%.

68. A membrane comprising one or more microporous polymers according to claim 67, wherein said membrane has a thickness ranging from 0.1 micrometer to 1000 micrometers, optionally
wherein the membrane is in contact with a support comprising a poly(arylether), a poly(arylether) copolymer, a poly(arylether sulfone) copolymer, a poly(arylether ketone), a poly(arylether ketone) copolymer, polyethylene, a polyethylene copolymer, polypropylene, a polypropylene copolymer, a polycycloolefin, a cycloolefin copolymer, polyacrylonitrile, a polyacrylonitrile copolymer, poly(vinylidene fluoride), a poly(vinylidene fluoride) copolymer, poly(tetrafluoroethylene), a poly(tetrafluoroethylene) copolymer, poly(hexafluoropropylene), a poly(hexafluoropropylene) copolymer, poly(vinyl chloride), a poly(vinyl chloride) copolymer, a polyamide, a polyamide copolymer, polyaramide, a polyaramide copolymer, polyurethane, a polyurethane copolymer, a polyurea, a polyurea copolymer, a porous metal, a porous alloyed metal, a porous metal oxide, a porous metal sulfide, or a combination thereof.
